(19) United States
(12) Patent Application Publication
(10) Pub. No.: US 2023/0312819 A1
(43) Pub. Date: Oct. 5, 2023

(54) WATER-DISPERSIBLE SULFOPOLYESTERS WITH LOW DISPERSION VISCOSITIES

(71) Applicant: Eastman Chemical Company, Kingsport, TN (US)

(72) Inventors: Scott Ellery George, Kingsport, TN (US); Joshua Seth Cannon, Greeneville, TN (US); Kevin Leonard Urman, Church Hill, TN (US); Chaoxiong Ma, Kingsport, TN (US)

(73) Assignee: Eastman Chemical Company, Kingsport, TN (US)

(21) Appl. No.: 18/040,900

(22) PCT Filed: Aug. 5, 2021
(86) PCT No.: PCT/US2021/044642

§ 371 Date: Feb. 7, 2023

Related U.S. Application Data
(60) Provisional application No. 62/706,260, filed on Aug. 7, 2020.

(51) Int. Cl. C08G 63/688; C08G 63/183; C08G 63/672; D01F 6/84; D03D 15/283; D04H 1/435

(52) U.S. Cl. CPC C08G 63/6886; C08G 63/183; C08G 63/672; D01F 6/84; D03D 15/283; D04H 1/435

(57) ABSTRACT

A water dispersible sulfopolyester is provided wherein the sulfopolyester comprises: (a) residues of one or more dicarboxylic acids; (b) at least 4 mole percent and less than 8.5 mole percent of residues of at least one sulfomonomer; and (c) residues of one or more diols, wherein the sulfopolyester comprises a carboxylate ends to acid ends ratio of at least 0.6, wherein the sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent. Processes for producing the sulfopolyester are also provided as well as articles comprising the sulfopolyester.

### FIELD OF THE INVENTION

The present invention pertains to low dispersion viscosity sulfopolyesters having a particular amount of sulfomonomer residues and carboxylate ends to acid ends ratio. In another embodiment, low dispersion viscosity sulfopolyesters are provided having a certain amount of sulfomonomer residues and a carboxylate ends content. Processes for making the sulfopolyester, fibers and fibrous articles comprising the sulfopolyester, and processes for making such fibers and fibrous articles are also provided. The invention further pertains to multicomponent fibers comprising the sulfopolyester and the microdenier fibers and fibrous articles prepared therefrom.

### BACKGROUND OF THE INVENTION

Sulfopolyesters are water-dispersible and characteristically show a low dispersion viscosity that rapidly increases around 30 wt% in demineralized water as illustrated in the plot below where the viscosity of Eastman AQ sulfopolyesters are compared. This attribute is preferable for many end-uses as it facilitates handling, storage, and application into thin films. For any composition, it is preferred to have a low (easily pourable) dispersion viscosity at the highest practical level of solids content in water alone.

The inherent water-dispersibility is due to an adequate level of 5-sodiosulfoisophthalic acid (5-SSIPA) as shown by the structure:

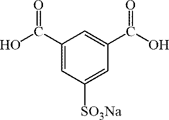

It is known that increasing the level of 5-SSIPA will facilitate the water-dispersibility for a wide range of sulfopolyester compositions. For a specific sulfopolyester composition it may also be possible to lower the dispersion viscosity by increasing the level of sulfomonomer. However, increasing the level of sulfomonomer tends to increase the melt viscosity, add cost, and limit the attainable ultimate molecular weight. Addition of polyethylene glycols, particularly diethylene glycol is a known secondary method to increase the hydrophilicity and possibly lower the dispersion viscosity. These glycols have only small effect on dispersibility and tend to lower the glass transition, which limits utility in some applications. Yet another approach is to add some amount of organic co-solvent to facilitate dispersibility, which may be acceptable for some applications, but is less preferred as increasing environmental regulations are facilitated by no VOC systems. Finally, the most universal approach is to lower the solids content for a less dispersible polymer or until an acceptable dispersion viscosity is obtained. Lower solids are less preferred as they increase the demands on shipping and storage efficiencies as well as limiting formulation latitude.

The present invention relates preferably to compositions with lower sulfomonomer contents that facilitate improved water-dispersibility as well as lower viscosity aqueous dispersions by appropriate control and specification of end groups. Sulfopolyesters with higher sulfomonomer content are within scope as they also benefit from the practice of this invention.

Fibers, melt blown webs and other melt spun fibrous articles have been made from thermoplastic polymers, such as poly(propylene), polyamides, and polyesters. One common application of these fibers and fibrous articles are nonwoven fabrics and, in particular, in personal care products such as wipes, feminine hygiene products, baby diapers, adult incontinence briefs, hospital/surgical and other medical disposables, protective fabrics and layers, geotextiles, industrial wipes, and filter media. Unfortunately, the personal care products made from conventional thermoplastic polymers are difficult to dispose of and are usually placed in landfills. One promising alternative method of disposal is to make these products or their components “flushable”, i.e., compatible with public sewerage systems. The use of water-dispersible or water-soluble materials also improves recyclability and reclamation of personal care products. The various thermoplastic polymers now used in personal care products are not inherently water-dispersible or soluble and, hence, do not produce articles that readily disintegrate and can be disposed of in a sewerage system or recycled easily.

The desirability of flushable personal care products has resulted in a need for fibers, nonwovens, and other fibrous articles with various degrees of water-responsivity. Various approaches to addressing these needs have been described, for example, in U.S. Pat. No.’s 6,548,592; 6,552,162; 5,281,306; 5,292,581; 5,935,880; and 5,509,913; U.S. Pat. Application Serial No.’s 09/775,312; and 09/752,017; and PCT International Publication No. WO 01/66666 A2. These approaches, however, suffer from a number of disadvantages and do not provide a fibrous article, such as a fiber or nonwoven fabric, that possesses a satisfactory balance of performance properties, such as tensile strength, absorptivity, flexibility, and fabric integrity under both wet or dry conditions.

For example, typical nonwoven technology is based on the multidirectional deposition of fibers that are treated with a resin binding adhesive to form a web having strong integrity and other desirable properties. The resulting assemblies, however, generally have poor water-responsivity and are not suitable for flushable applications. The presence of binder also may result in undesirable properties in the final product, such as reduced sheet wettability, increased stiffness, stickiness, and higher production costs. It is also difficult to produce a binder that will exhibit adequate wet strength during use and yet disperse quickly upon disposal. Thus, nonwoven assemblies using these binders may either disintegrate slowly under ambient conditions or have less than adequate wet strength properties in the presence of body fluids. To address this problem, pH and ion-sensitive water-dispersible binders, such as lattices containing acrylic or methacrylic acid with or without added salts, are known and described, for example, in U.S. Pat. No. 6,548,592 B1. Ion concentrations and pH levels in public sewerage and residential septic systems, however, can vary widely among geographical locations and may not be sufficient for the binder to become soluble and disperse. In this case, the fibrous articles will not disintegrate after disposal and can clog drains or sewer laterals.

Multicomponent fibers containing a water-dispersible component and a thermoplastic water non-dispersible component have been described, for example, in U.S. Pat. No.’s 5,916,678; 5,405,698; 4,966,808; 5,525282; 5,366,804; 5,486,418. For example, these multicomponent fibers may be a bicomponent fiber having a shaped or engineered transverse cross section such as, for example, an islands-in-the-sea, sheath core, side-by-side, or segmented pie configuration. The multicomponent fiber can be subjected to water or a dilute alkaline solution where the water-dispersible component is dissolved away to leave the water non-dispersible component behind as separate, independent fibers of extremely small fineness. Polymers which have good water dispersibility, however, often impart tackiness to the resulting multicomponent fibers, which causes the fiber to stick together, block, or fuse during winding or storage after several days, especially under hot, humid conditions. To prevent fusing, often a fatty acid or oil-based finish is applied to the surface of the fiber. In addition, large proportions of pigments or fillers are sometimes added to water dispersible polymers to prevent fusing of the fibers as described, for example, in U.S. Pat. No. 6,171,685. Such oil finishes, pigments, and fillers require additional processing steps and can impart undesirable properties to the final fiber. Many water-dispersible polymers also require alkaline solutions for their removal which can cause degradation of the other polymer components of the fiber such as, for example, reduction of inherent viscosity, tenacity, and melt strength. Further, some water-dispersible polymers can not withstand exposure to water during hydroentanglement and, thus, are not suitable for the manufacture of nonwoven webs and fabrics.

Alternatively, the water-dispersible component may serve as a bonding agent for the thermoplastic fibers in nonwoven webs. Upon exposure to water, the fiber to fiber bonds come apart such that the nonwoven web loses its integrity and breaks down into individual fibers. The thermoplastic fiber components of these nonwoven webs, however, are not water-dispersible and remain present in the aqueous medium and, thus, must eventually be removed from municipal wastewater treatment plants. Hydroentanglement may be used to produce disintegratable nonwoven fabrics without or with very low levels (< 5 weight %) of added binder to hold the fibers together. Although these fabrics may disintegrate upon disposal, they often utilize fibers that are not water soluble or water-dispersible and may result in entanglement and plugging within sewer systems. Any added water-dispersible binders also must be minimally affected by hydroentangling and not form gelatinous buildup or cross-link, and thereby contribute to fabric handling or sewer related problems.

A few water-soluble or water-dispersible polymers are available, but are generally not applicable to melt blown fiber forming operations or melt spinning in general. Polymers, such as polyvinyl alcohol, polyvinyl pyrrolidone, and polyacrylic acid are not melt processable as a result of thermal decomposition that occurs at temperatures below the point where a suitable melt viscosity is attained. High molecular weight polyethylene oxide may have suitable thermal stability, but would provide a high viscosity solution at the polymer interface resulting in a slow rate of disintegration. Water-dispersible sulfopolyesters have been described, for example, in U.S. Pat. No.’s 6,171,685; 5,543,488; 5,853,701; 4,304,901; 6,211,309; 5,570,605; 6,428,900; and 3,779,993. Typical sulfopolyesters, however, are low molecular weight thermoplastics that are brittle and lack the flexibility to withstand a winding operation to yield a roll of material that does not fracture or crumble. Sulfopolyesters also can exhibit blocking or fusing during processing into film or fibers, which may require the use of oil finishes or large amounts of pigments or fillers to avoid. Low molecular weight polyethylene oxide (more commonly known as polyethylene glycol) is a weak/brittle polymer that also does not have the required physical properties for fiber applications. Forming fibers from known water-soluble polymers via solution techniques is an alternative, but the added complexity of removing solvent, especially water, increases manufacturing costs.

Accordingly, there is a need for a water-dispersible sulfopolyester fiber and fibrous articles prepared therefrom that exhibit adequate tensile strength, absorptivity, flexibility, and fabric integrity in the presence of moisture, especially upon exposure to human bodily fluids. In addition, a fibrous article is needed that does not require a binder and completely disperses or dissolves in residential or municipal sewerage systems. Potential uses include, but are not limited to, melt blown webs, spunbond fabrics, hydroentangled fabrics, wet-laid nonwovens, dry-laid non-wovens, bicomponent fiber components, adhesive promoting layers, binders for cellulosics, flushable nonwovens and films, dissolvable binder fibers, protective layers, and carriers for active ingredients to be released or dissolved in water. There is also a need for multicomponent fiber having a water-dispersible component that does not exhibit excessive blocking or fusing of filaments during spinning operations, is easily removed by hot water at neutral or slightly acidic pH, is suitable for hydroentangling processes to manufacture nonwoven fabrics, and also to produce yarns, woven and knitted fabrics, synthetic suedes and leathers, and various other fibrous articles. These multicomponent fibers can be utilized to produce microfibers that can be used to produce various articles. Other extrudable and melt spun fibrous materials are also possible.

### SUMMARY OF THE INVENTION

We have unexpectedly discovered a sulfopolyester with lower sulfomonomer content that facilitates improved water-dispersibility as well as lower aqueous dispersion viscosity by appropriate control and specification of end groups. Lower dispersion viscosity is needed for many end-uses as it facilitiates handling, storage, and application into thin films. In addition, the sulfopolyester has optimum water dispersibility compared to other sulfopolyesters.

In one embodiment of the invention, a water dispersible sulfopolyester is provided comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

In another embodiment, a water dispersible sulfopolyester is provided comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

In another embodiment, a water dispersible sulfopolyester is provided comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

In another embodiment of the invention, a process is provided to produce the sulfopolyester. The process comprises: (a) providing one or more dicarboxylic acids, one or more diols, at least one sulfomonomer, and at least one base to thereby form an esterification mixture; and (b) esterifying said esterification mixture to thereby form said sulfopolyester, wherein said sulfopolyester comprises: (i) residues of said dicarboxylic acids, (ii) at least 4 mole percent and less than 8.5 mole percent of residues of said sulfomonomer, and (iii) residues of said diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

In another embodiment of the invention, a process is provided to produce the sulfopolyester. The process comprises: (a) providing one or more dicarboxylic acids, one or more diols, at least one sulfomonomer, and at least one base to thereby form an esterification mixture; and (b) esterifying said esterification mixture to thereby form said sulfopolyester, wherein said sulfopolyester comprises: (i) residues of said dicarboxylic acids, (ii) greater than 8.5 mole percent of residues of said sulfomonomer, and (iii) residues of said diols, wherein said sulfopolyester comprises a carboxylate ends to acid ends ratio of at least 0.35, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

In another embodiment of the invention, a process is provided to produce the sulfopolyester. The process comprises: (a) providing one or more dicarboxylic acids, one or more diols, at least one sulfomonomer, and at least one base to thereby form an esterification mixture; and (b) esterifying said esterification mixture to thereby form said sulfopolyester, wherein said sulfopolyester comprises: (i) residues of said dicarboxylic acids, (ii) greater than 8.5 mole percent of residues of said sulfomonomer, and (iii) residues of said diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

The sulfopolyesters of this invention can be used to produce unicomponent or multicomponent fibers that rapidly disperse or dissolve in water and may be produced by melt-blowing or melt-spinning. The fibers may be prepared from a single sulfopolyester or a blend of the sulfopolyester with a water-dispersible or water non-dispersible polymer. Thus, the fiber of the present invention, optionally, may include a water-dispersible polymer blended with the sulfopolyester. In addition, the fiber may optionally include a water non-dispersible polymer blended with the sulfopolyester, provided that the blend is an immiscible blend. Our invention also includes fibrous articles comprising our water-dispersible sulfopolyester fibers. Thus, the fibers of our invention may be used to prepare various fibrous articles, such as yarns, melt-blown webs, spunbonded webs, nonwoven fabrics that are, in turn, water-dispersible or flushable, and woven fabrics and articles.

The present invention also provides a multicomponent fiber comprising a water-dispersible sulfopolyester and one or more water non-dispersible polymers. The fiber has an engineered geometry such that the water non-dispersible polymers are present as segments substantially isolated from each other by the intervening sulfopolyester, which acts as a binder or encapsulating matrix for the water non-dispersible segments.

Thus, in one embodiment of the invention, a multicomponent fiber having a shaped cross section is provided, the multicomponent fiber comprising: (a) a water dispersible sulfopolyester comprising - (i) residues of one or more dicarboxylic acids, (ii) at least 4 mole percent and less than 8.5 mole percent of residues of at least one sulfomonomer, and (iii) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (b) one or more domains comprising one or more water non-dispersible polymers immiscible with said sulfopolyester.

In another embodiment of the invention, a multicomponent fiber having a shaped cross section is provided, the multicomponent fiber comprising: (a) a water dispersible sulfopolyester comprising: (i) residues of one or more dicarboxylic acids, (ii) greater than 8.5 mole percent of residues of at least one sulfomonomer, and (iii) residues of one or more diols, wherein said sulfopolyester comprises a carboxylate ends to acid ends ratio of at least 0.35, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (b) one or more domains comprising one or more water non-dispersible polymers immiscible with said amorphous sulfopolyester.

In another embodiment of the invention, a multicomponent fiber having a shaped cross section is provided, the multicomponent fiber comprising: (a) a water dispersible sulfopolyester comprising - (i) residues of one or more dicarboxylic acids, (ii) greater than 8.5 mole percent of residues of at least one sulfomonomer, and (iii) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (b) one or more domains comprising one or more water non-dispersible polymers immiscible with said sulfopolyester.

In another embodiment of the invention, a process is provided for producing at least one multicomponent fiber having a shaped cross section comprising spinning at least one water dispersible sulfopolyester and at least one water-nondispersable polymer immiscible with the sulfopolyester into the multicomponent fiber, the sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein the sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

In another embodiment of the invention, a process is provided for producing at least one multicomponent fiber having a shaped cross section comprising spinning at least one water dispersible sulfopolyester and at least one water-nondispersable polymer immiscible with the sulfopolyester into the multicomponent fiber, said sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

In another embodiment of the invention, a process is provided to produce at least one multicomponent fiber having a shaped cross section comprising spinning at least one water dispersible amorphous sulfopolyester and at least one water-nondispersable polymer immiscible with said amorphous sulfopolyester into said multicomponent fiber, said amorphous sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

The water dispersible sulfopolyester may be removed by contacting the multicomponent fiber with water to leave behind the water non-dispersible segments as microdenier fibers. Our invention, therefore, also provides a process for producing microdenier fibers comprising: (A) spinning a water dispersible sulfopolyester and one or more water non-dispersible polymers immiscible with the sulfopolyester into multicomponent fibers, wherein the sulfopolyester is at least one selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent. (B) contacting the multicomponent fibers with water to remove the sulfopolyester thereby forming microdenier fibers.

Our invention also provides a process for making a water-dispersible, nonwoven fabric comprising: (A) heating a water-dispersible polymer composition to a temperature above its flow point, wherein the polymer composition comprises at least one water dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; wherein the fibers have a plurality of segments comprising the water non-dispersible polymers wherein the segments are substantially isolated from each other by the sulfopolyester intervening between the segments; and (B) melt spinning filaments; and (C) overlapping and collecting the filaments of Step B to form a nonwoven web.

In another embodiment of this invention, a process for producing cut water non-dispersible polymer microfibers is provided, the process comprising: (A) cutting a multicomponent fiber into cut multicomponent fibers; wherein the multicomponent fiber comprises at least one water dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) contacting a fiber-containing feedstock with water to produce a fiber mix slurry; wherein the fiber-containing feedstock comprises cut multicomponent fibers; (C) heating the fiber mix slurry to produce a heated fiber mix slurry; (D) optionally, mixing the fiber mix slurry in a shearing zone; (E) removing at least a portion of the sulfopolyester from the cut multicomponent fiber to produce a slurry mixture comprising a sulfopolyester dispersion and the cut water non-dispersible polymer microfibers; and (F) separating the cut water non-dispersible polymer microfibers from the slurry mixture.

In another embodiment of the invention, a process for producing a microfiber product stream is provided. The process comprises: (A) contacting short cut multicomponent fibers having a length of less than 25 millimeters with a heated aqueous stream in a fiber opening zone to remove a portion of the water dispersible sulfopolyester to produce an opened microfiber slurry; wherein the short cut multicomponent fibers comprise at least one water dispersible sulfopolyester and at least one water non-dispersible synthetic polymer immiscible with the water dispersible sulfopolyester; wherein the water dispersible sulfopolyester is selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; wherein the heated aqueous stream is at a temperature of at least 40° C.; wherein the opened microfiber slurry comprises water, microfiber, and water dispersible sulfopolyester; and (B) routing the opened microfiber slurry to a primary solid liquid separation zone to produce the microfiber product stream and a first mother liquor stream; wherein the first mother liquor stream comprises water and the water dispersible sulfopolyester.

In another embodiment of the invention, another process for producing a microfiber product stream is provided. The process comprises: (A) contacting short cut multicomponent fibers having a length of less than 25 millimeters with a treated aqueous stream in a fiber slurry zone to produce a short cut multicomponent fiber slurry; wherein the short cut multicomponent fibers comprise at least one water dispersible sulfopolyester and at least one water non-dispersible synthetic polymer immiscible with the water dispersible sulfopolyester; and wherein the treated aqueous stream is at a temperature of less than 40° C.; wherein the water dispersible sulfopolyester is at least one selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) contacting the short cut multicomponent fiber slurry and a heated aqueous stream in a fiber opening zone to remove a portion of the water dispersible sulfopolyester to produce an opened microfiber slurry; wherein the opened microfiber slurry comprises water non-dispersible polymer microfiber, water dispersible sulfopolyester, and water; and (C) routing the opened microfiber slurry to a primary solid liquid separation zone to produce the microfiber product stream and a first mother liquor stream; wherein the first mother liquor stream comprises water and the water dispersible sulfopolyester.

In another embodiment of the invention, another process for producing a microfiber product stream is provided. The process comprises: (A) contacting short cut multicomponent fibers having a length of less than 25 millimeters with a heated aqueous stream in a mix zone to produce a short cut multicomponent fiber slurry; wherein the short cut multicomponent fibers comprise at least one water dispersible sulfopolyester and at least one water non-dispersible polymer immiscible with the water dispersible sulfopolyester; wherein the water dispersible sulfopolyester is at least one selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; wherein the heated aqueous stream is at a temperature of 40° C. or greater; (B) routing the short cut multicomponent fiber slurry and optionally, a heated aqueous stream, to a fiber opening zone to remove a portion of the water dispersible sulfopolyester to produce an opened microfiber slurry; wherein the opened microfiber slurry comprises water non-dispersible polymer microfiber, water dispersible sulfopolyester, and water; and (C) routing the opened microfiber slurry to a primary solid liquid separation zone to produce the microfiber product stream and a first mother liquor stream; wherein the first mother liquor stream comprises water and the water dispersible sulfopolyester.

In another embodiment of the invention, another process for producing a microfiber product stream is provided. The process comprises: (A) contacting short cut multicomponent fibers having a length of less than 25 millimeters with a treated aqueous stream in a fiber slurry zone to produce a short cut multicomponent fiber slurry; wherein the short cut multicomponent fibers comprise at least one water dispersible sulfopolyester and at least one water non-dispersible synthetic polymer immiscible with the water dispersible sulfopolyester; and wherein the treated aqueous stream is at a temperature of less than 40° C.; wherein the water dispersible sulfopolyester is at least one selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) contacting the short cut multicomponent fiber slurry with a heated aqueous stream in a mix zone to produce a heated multicomponent fiber slurry; (C) routing the heated multicomponent fiber slurry to a fiber opening zone to remove a portion of the water dispersible sulfopolyester to produce an opened microfiber slurry; and (D) routing the opened microfiber slurry to a primary solid liquid separation zone to produce the microfiber product stream and a first mother liquor stream; wherein the first mother liquor stream comprises water and the water dispersible sulfopolyester.

In another embodiment of the invention, a process for separating a first mother liquor stream is provided. The process comprises routing a first mother liquor stream to a second solid liquid separation zone to produce a secondary wet cake stream and a second mother liquor stream; wherein the second mother liquor stream comprises water and water dispersible sulfopolyester; wherein the secondary wet cake stream comprises water non-dispersible polymer microfiber.

In yet another embodiment of the invention, a process for recovering sulfopolyester is provided. The process comprises:
(A) routing a second mother liquor to a primary concentration zone to produce a primary polymer concentrate stream and a primary recovered water stream; and
(B) optionally, routing the primary recovered water stream to a fiber opening zone.

### BRIEF DESCRIPTION OF THE FIGURES

FIGS. 1a, 1b, and 1c are cross-sectional views of three differently configured fibers, particularly illustrating how various measurements relating to the size and shape of the fibers are determined.

FIG. 2 illustrates an embodiment of the invention wherein the microfiber product stream is produced in a one step opening zone.

FIGS. 3a and 3b illustrate an embodiment of the invention wherein the microfiber product stream is produced in a two step opening zone.

FIG. 4 illustrates an embodiment of the invention wherein the microfiber product stream is produced in a three step opening zone.

FIG. 5 illustrates an embodiment of the process for cutting multicomponent fibers to produce short cut multicomponent fibers.

FIG. 6a illustrates an embodiment of the opening zone wherein the opening zone comprises a pipe.

FIG. 6b illustrates an embodiment of the opening zone wherein the opening zone comprises a continuous stirred tank.

FIG. 6c illustrates an embodiment of the opening zone wherein the opening zone comprises more than one continuous stirred tanks.

FIGS. 7a and 7b illustrate an embodiment of the primary solid liquid separation zone.

### DETAILED DESCRIPTION

### Inventive Sulfopolyesters

The present invention provides novel water dispersible sulfopolyesters with lower sulfomonomer content that facilitates improved water-dispersibility as well as lower aqueous dispersion viscosity by appropriate control and specification of end groups. These novel sulfopolyesters are particularly useful for the production of multicomponent fibers where excellent removability is combined with blocking resistance.

In one embodiment, a water dispersible sulfopolyester is provided comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

In another embodiment, an amorphous water dispersible sulfopolyester is provided comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

In one embodiment, a water dispersible sulfopolyester is provided comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

The sulfopolyesters of this invention comprise dicarboxylic acid monomer residues, sulfomonomer residues, diol monomer residues, and repeating units. The sulfomonomer may be a dicarboxylic acid, a diol, or hydroxycarboxylic acid. Thus, the term “monomer residue”, as used herein, means a residue of a dicarboxylic acid, a diol, or a hydroxycarboxylic acid. A “repeating unit”, as used herein, means an organic structure having 2 monomer residues bonded through a carbonyloxy group. The sulfopolyesters of the present invention contain substantially equal molar proportions of acid residues (100 mole %) and diol residues (100 mole %) which react in substantially equal proportions such that the total moles of repeating units is equal to 100 mole %. The mole percentages provided in the present disclosure, therefore, may be based on the total moles of acid residues, the total moles of diol residues, or the total moles of repeating units. For example, a sulfopolyester containing 30 mole % of a sulfomonomer, which may be a dicarboxylic acid, a diol, or hydroxycarboxylic acid, based on the total repeating units, means that the sulfopolyester contains 30 mole % sulfomonomer out of a total of 100 mole % repeating units. Thus, there are 30 moles of sulfomonomer residues among every 100 moles of repeating units. Similarly, a sulfopolyester containing 30 mole % of a dicarboxylic acid sulfomonomer, based on the total acid residues, means the sulfopolyester contains 30 mole % sulfomonomer out of a total of 100 mole % acid residues. Thus, in this latter case, there are 30 moles of sulfomonomer residues among every 100 moles of acid residues.

The sulfopolyesters described herein have an inherent viscosity, abbreviated hereinafter as “Ih.V.”, of at least about 0.1, 0.15, 0.2, 0.25, or 0.3 and/or less than 0.8, 0.7, 0.6, 0.5, or 0.45 dL/g, measured in a 60/40 parts by weight solution of phenol/tetrachloroethane solvent at 25° C. and at a concentration of about 0.5 g of sulfopolyester in 100 mL of solvent.

Molecular weight is conveniently described by ‘inherent viscosity’ that is abbreviated as IhV as measured in a 60/40 w/w solution of phenol/tetrachloroethane at 25° C. and a concentration of 0.5 grams of sulfopolyeser in 100 mL of solvent. Below an IhV of 0.1, compositional heterogeneity and generally low molecular weight may lead to problems, such as poor film formation, non-dispersible fractions, decreased fitness-for-use, and poorer shelf stability. Inherent viscosity (IhV) for these polyesters is a useful specification for molecular weight as determined according to the ASTM D2857-70 procedure, in a Wagner Viscometer of Lab Glass, Inc., having a ½ mL capillary bulb, using a polymer concentration about 0.5% by weight in 60/40 by weight of phenol/tetrachloroethane. The procedure is carried out by heating the polymer/solvent system at 120° C. for 15 minutes, cooling the solution to 25° C. and measuring the time of flow at 25° C. The IV is calculated from the equation:

$${η}_{i n h} = \frac{l n \frac{{t}_{s}}{{t}_{0}}}{C}$$

Where:
η: inherent viscosity at 25° C. at a polymer concentration of 0.5 g/100 mL of solvent;
ts: sample flow time;
t₀: solvent-blank flow time;
C: concentration of polymer in grams per 100 mL of solvent (0.5)
The units of the inherent viscosity throughout this application are in the deciliters/gram.

In the following examples, a viscosity was measured in tetrachloroethane/phenol (60/40, weight ratio) at 25° C. and calculated in accordance with the following equation:

$${η}_{i n h} = \frac{ln \left({η}_{s p}\right)}{C}$$

wherein ηₛₚ is a specific viscosity and C is a concentration. The units of IhV are deciliters/g.

The molecular weight of the sulfopolyester is related to the melt viscosity of the sulfopolyester which is important to melt spinning fibers.

The term “polyester”, as used herein, encompasses both “homopolyesters” and “copolyesters” and means a synthetic polymer prepared by the polycondensation of difunctional carboxylic acids with difunctional hydroxyl compound. As used herein, the term “sulfopolyester” means any polyester comprising a sulfomonomer. Typically, the difunctional carboxylic acid is a dicarboxylic acid and the difunctional hydroxyl compound is a dihydric alcohol such as, for example glycols and diols The term “residue”, as used herein, means any organic structure incorporated into the polymer through a polycondensation reaction involving the corresponding monomer.

The sulfopolyester of the present invention includes one or more dicarboxylic acid residues. Depending on the type and concentration of the sulfomonomer, the dicarboxylic acid residue may comprise from about 60 to about 100 mole % of the acid residues. Other examples of concentration ranges of dicarboxylic acid residues are from about 60 mole % to about 96 mole %, and about 70 mole % to about 96 mole %. Examples of dicarboxylic acids that may be used include aliphatic dicarboxylic acids, alicyclic dicarboxylic acids, aromatic dicarboxylic acids, or mixtures of two or more of these acids. Thus, suitable dicarboxylic acids include, but are not limited to, succinic; glutaric; adipic; azelaic; sebacic; fumaric; maleic; itaconic; C36 dimer; 2,5-norbornane dicarboxylic acid; 1,3-cyclohexanedicarboxylic; 1,4-cyclohexanedicarboxylic; diglycolic; 2,5-norbornanedicarboxylic; phthalic; terephthalic; 1,4-naphthalenedicarboxylic; 2,5-naphthalenedicarboxylic; diphenic; 4,4′-oxydibenzoic; 4,4′-sulfonyidibenzoic; 4,4′-biphenyl dicarboxylic acid, and isophthalic. The preferred dicarboxylic acid residues are isophthalic, terephthalic, and 1,4-cyclohexanedicarboxylic acids, with the residues of isophthalic and terephthalic acid being especially preferred. The free acid form is required as the esters, such as dimethyl isophthalate or dimethyl terephthalate, do not provide the carboxylic acid end groups that lead to base neutralized carboxylate ends. Small amounts of dimethyl or even higher order esters may be tolerable if less than 10 mole% of the total amount of dicarboxylic acid.

The sulfopolyester can comprise at least 20, 25, 30, 35, 40, 45, 50, 55, or 60 mole percent and/or not more than 99, 95, 90, 85, or 80 mole percent of residues of terephthalic acid. In another embodiment, the sulfopolyester can comprise at least 5, 10, 15, 20, 25, 30, 35, or 40 mole percent and/or not more than 99, 95, 90, 85, or 80 mole percent of residues of isophthalic acid. In yet another embodiment, the sulfopolyester does not contain residues of isophthalic acid.

The sulfopolyester includes about 4 to about 40 mole %, based on the total repeating units, of residues of at least one sulfomonomer having 2 functional groups and one or more sulfonate groups attached to an aromatic or cycloaliphatic ring wherein the functional groups are hydroxyl, carboxyl, or a combination thereof. Additional examples of concentration ranges for the sulfomonomer residues are about 4 to about 35 mole %, about 8 to about 30 mole %, and about 8 to about 25 mole %, based on the total repeating units. In another embodiment, the amount of sulfomonomer ranges from at least 4, 5, 6, 7, 8, 8.5, 9, 9.5, or 10 mole percent and/or less than 25, 20, 19, 18, 17, 16, 15, 14, or 13 mole percent of said sulfomonomer based on the total repeating units. In another embodiment, the amount of sulfomonomer is at least 10, 11, 12, 13, or 14 mole percent and/or less than 40, 35, 30, 25, or 20 mole percent based on the total repeating units.

The sulfomonomer may be a dicarboxylic acid thereof containing a sulfonate group, a diol containing a sulfonate group, or a hydroxy acid containing a sulfonate group. The term “sulfonate” refers to a salt of a sulfonic acid having the structure “—SO₃M” wherein M is the cation of the sulfonate salt. The cation of the sulfonate salt may be a metal ion such as Li⁺, Na⁺, and K⁺. Alternatively, the cation of the sulfonate salt may be non-metallic such as a nitrogenous base as described, for example, in U.S. Pat. No. 4,304,901. Nitrogen-based cations are derived from nitrogen-containing bases, which may be aliphatic, cycloaliphatic, or aromatic compounds. Examples of such nitrogen containing bases include ammonia, dimethylethanolamine, diethanolamine, triethanolamine, pyridine, morpholine, and piperidine. Because monomers containing the nitrogen-based sulfonate salts typically are not thermally stable at conditions required to make the polymers in the melt, the method of this invention for preparing sulfopolyesters containing nitrogen-based sulfonate salt groups is to disperse, dissipate, or dissolve the polymer containing the required amount of sulfonate group in the form of its alkali metal salt in water and then exchange the alkali metal cation for a nitrogen-based cation.

In one embodiment, 5-sulfoisophthalic acid may be used as the free carboxylic acid as dimethyl ester and higher order esters do not provide the acid ends that are needed for this invention. It is required for the 5-sulfoisophthalic acid monomer to be present in the form of a metallic sulfonate salt due to the thermal instability of the free acid. Preferred cations are Li⁺, Na^{+,} and K⁺. Other cations may be present in small amounts, such as Ca⁺⁺, Mg⁺⁺, Al⁺⁺⁺, and Fe⁺⁺, they are known to make the resulting polymer less dispersible or non-dispersible and are not useful for this invention. Non-metallic cations derived from nitrogen-containing bases are acceptable although not preferred since they cannot be obtained directly in a melt phase process.

In one embodiment, acid end groups are obtained by using dicarboxylic acid monomers although other methods may be contemplated, such as controlled degradation or end-capping hydroxyl ends with anhydrides of diacids.

When a monovalent alkali metal ion is used as the cation of the sulfonate salt, the resulting sulfopolyester is completely dispersible in water with the rate of dispersion dependent on the content of sulfomonomer in the polymer, temperature of the water, surface area/thickness of the sulfopolyester, and so forth. Utilization of more than one counterion within a single polymer composition is possible and may offer a means to tailor or fine-tune the water-responsivity of the resulting article of manufacture. Examples of sulfomonomers residues include monomer residues where the sulfonate salt group is attached to an aromatic acid nucleus, such as, for example, benzene; naphthalene; diphenyl; oxydiphenyl; sulfonyldiphenyl; and methylenediphenyl or cycloaliphatic rings, such as, for example, cyclohexyl; cyclopentyl; cyclobutyl; cycloheptyl; and cyclooctyl. Other examples of sulfomonomer residues which may be used in the present invention are the metal sulfonate salt of sulfophthalic acid, sulfoterephthalic acid, sulfoisophthalic acid, or combinations thereof. Other examples of sulfomonomers which may be used are 5-sodiosulfoisophthalic acid and esters thereof. If the sulfomonomer residue is from 5-sodiosulfoisophthalic acid, typical sulfomonomer concentration ranges are about 4 to about 35 mole %, about 8 to about 30 mole %, and about 8 to 25 mole %, based on the total moles of acid residues.

The level of sulfomonomer (e.g., 5-SSIPA) is important as the impact of carboxylate ends or the lack thereof may be mitigated by increasing the incorporated amount of sulfomonomer to facilitate dispersion and/or lower dispersion viscosity. Particular utility of this invention is achieved at lower levels of sulfomonomer due to economics and othe benefits, such as having a water-dispersible polyester that is closer to PET to facilitate fiber co-spinning. Higher levels of sulfomonomer tend to impact the melt viscosity behavior by making the polymer more shear thinning and thus a greater mismatch with PET. Although the practice of this invention is not limited to lower levels of sulfomonomer, it is particularly effective at levels of sulfomonomer in the range from 7 - 12 mole%. Higher levels of sulfomonomer up to 20 mole% are included, but the benefit of the carboxylate end groups tends to be increasingly minimized as the level of sulfomonomer is increased. The lower end of the sulfomonomer range is most facilitated by the presence of carboxylate end groups as a secondary means of hydrophilicity.

The sulfomonomers used in the preparation of the sulfopolyesters are known compounds and may be prepared using methods well known in the art. For example, sulfomonomers in which the sulfonate group is attached to an aromatic ring may be prepared by sulfonating the aromatic compound with oleum to obtain the corresponding sulfonic acid and followed by reaction with a metal oxide or base, for example, sodium acetate, to prepare the sulfonate salt. Procedures for preparation of various sulfomonomers are described, for example, in U.S. Pat. No.’s 3,779,993; 3,018,272; and 3,528,947.

It is also possible to prepare the sulfopolyester using, for example, a sodium sulfonate salt, and ion-exchange methods to replace the sodium with a different ion, such as lithium, when the polymer is in the dispersed form.

The inventive sulfopolyesters comprise residues of at least one diol. The sulfopolyester can include one or more diol residues which may include aliphatic, cycloaliphatic, and aralkyl glycols. The cycloaliphatic diols, for example, 1,3- and 1,4-cyclohexanedimethanol, may be present as their pure cis or trans isomers or as a mixture of cis and trans isomers. As used herein, the term “diol” is synonymous with the term “glycol” and means any dihydric alcohol. Examples of diols include, but are not limited to, ethylene glycol; diethylene glycol; triethylene glycol; polyethylene glycols; 1,3-propanediol; 2,4-dimethyl-2-ethylhexane-1,3-diol; 2,2-dimethyl-1,3-propanediol; 2-ethyl-2-butyl-1,3-propanediol; 2-ethyl-2-isobutyl-1,3-propanediol; 1,3-butanediol; 1,4-butanediol; 1,5-pentanediol; 1,6-hexanediol; 2,2,4-trimethyl-1,6-hexanediol; thiodiethanol; 1,2-cyclohexanedimethanol; 1,3-cyclohexanedimethanol; 1,4-cyclohexanedimethanol; 2,2,4,4-tetramethyl-1,3-cyclobutanediol; p-xylylenediol, or combinations of one or more of these glycols. In one embodiment, the residues of one or more diols are derived from ethylene glycol, 1,4-cyclohexanedimethanol, diethylene glycol, or combinations thereof.

The diol residues may include from about 25 mole % to about 100 mole %, based on the total diol residues, of residues of a poly(ethylene glycol) having a structure

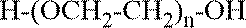

wherein n is an integer in the range of 3 to about 500. Non-limiting examples of lower molecular weight polyethylene glycols, e.g., wherein n is from 3 to 6, are triethylene glycol, and tetraethylene glycol. Higher molecular weight polyethylene glycols (abbreviated herein as “PEG”), wherein n is from 7 to about 500, include the commercially available products known under the designation CARBOWAX®, a product of Dow Chemical Company (formerly Union Carbide). Typically, PEGs are used in combination with other diols such as, for example, diethylene glycol or ethylene glycol. Based on the values of n, which range from greater than 6 to 500, the molecular weight may range fromgreater than 300 to about 22,000 g/mol. The molecular weight and the mole % are inversely proportional to each other; specifically, as the molecular weight is increased, the mole % will be decreased in order to achieve a designated degree of hydrophilicity. For example, it is illustrative of this concept to consider that a PEG having a molecular weight of 1000 may constitute up to 10 mole % of the total diol, while a PEG having a molecular weight of 10,000 would typically be incorporated at a level of less than 1 mole % of the total diol.

Certain dimer, trimer, and tetramer diols may be formed in situ due to side reactions that may be controlled by varying the process conditions. For example, varying amounts of diethylene, triethylene, and tetraethylene glycols may be formed from ethylene glycol from an acid-catalyzed dehydration reaction which occurs readily when the polycondensation reaction is carried out under acidic conditions. The presence of buffer solutions, well-known to those skilled in the art, may be added to the reaction mixture to retard these side reactions. Additional compositional latitude is possible, however, if the buffer is omitted and the dimerization, trimerization, and tetramerization reactions are allowed to proceed.

The sulfopolyester of the present invention may include from 0 to about 25 mole %, based on the total repeating units, of residues of a branching monomer having 3 or more functional groups wherein the functional groups are hydroxyl, carboxyl, or a combination thereof. Non-limiting examples of branching monomers are 1,1,1-trimethylol propane, 1,1,1-trimethylolethane, glycerin, pentaerythritol, erythritol, threitol, dipentaerythritol, sorbitol, trimellitic anhydride, pyromellitic dianhydride, dimethylol propionic acid, or combinations thereof. Further examples of branching monomer concentration ranges are from 0 to about 20 mole % and from 0 to about 10 mole %. The presence of a branching monomer may result in a number of possible benefits to the sulfopolyester of the present invention, including but not limited to, the ability to tailor rheological, solubility, and tensile properties. For example, at a constant molecular weight, a branched sulfopolyester, compared to a linear analog, will also have a greater concentration of end groups that may facilitate post-polymerization crosslinking reactions. At high concentrations of branching agent, however, the sulfopolyester may be prone to gelation.

The inventive sulfopolyesters of the present invention can have a glass transition temperature, abbreviated herein as “Tg”, of at least 57° C. as measured on the dry polymer using standard techniques, such as differential scanning calorimetry (“DSC”), well known to persons skilled in the art. The Tg measurements of the sulfopolyesters of the present invention are conducted using a “dry polymer”, that is, a polymer sample in which adventitious or absorbed water is driven off by heating to polymer to a temperature of about 200° C. and allowing the sample to return to room temperature. Typically, the sulfopolyester is dried in the DSC apparatus by conducting a first thermal scan in which the sample is heated to a temperature above the water vaporization temperature, holding the sample at that temperature until the vaporization of the water absorbed in the polymer is complete (as indicated by an a large, broad endotherm), cooling the sample to room temperature, and then conducting a second thermal scan to obtain the Tg measurement. In another embodiment of the invention, the sulfopolyester exhibits a glass transition temperature of at least 58° C., 59° C., 60° C., 61° C., 62° C., 63° C., 64° C., 65° C., 66° C., 67° C., 68° C., 69° C., 70° C. and/or less than 120° C., 115° C., 110° C., 105° C., 100° C., 95° C., or 90° C.

In another embodiment of the invention, the sulfopolyester is amorphous and does not exhibit a differential scanning calorimetry (DSC) melting point.

The inventive sulfopolyesters can form an aqueous dispersion comprising at least 20, 25, 30, 35, 40, 45, or 50 weight percent of said sulfopolyester and exhibits a dispersion viscosity of at least 10, 15, 20, 25, 30, 35, 40, 45, 50, 55, 60, 65, 70, 75, 80, 85, 90, or 95 cP and less than 1,000, 900, 800, 700, 600, 500, 400, 300, 200, or 100 cP at 22° C. Dispersion viscosity is measured at 400 rpm on a cone and plate rheometer using a #1 spindle at 30° C.

The ratio of acid ends to carboxylate ends is a convenient method to describe the sulfopolyesters of this invention thus providing for a low dispersion viscosity. Carboxylate ends of the sulfopolyester is defined as carboxylic acids ends that have been neutralized with a sodium or potassium salt. An acid end of the sulfopolyester is defined as a free carboxylic acid that has not been neutralized. Neutralization occurs with the addition of a base in a sufficient amount to provide for the carboxylate end to acid end ratio as provided in this disclosure. Bases that can be utilized are those that have a pH greater than 7 in an aqueous solution. In this invention, both weak and strong bases can be utilized. Examples of bases for use in this invention include, but are not limited to, sodium acetate, potassium acetate, sodium bicarbonate, trisodium phosphate, potassium hydroxide, and sodium hydroxide. High acid ends alone is not adequate as they do not alone provide adequate increased hydrophilicity as compared to carboxylate ends.

In one embodiment, the inventive sulfopolyesters comprise a carboxylate ends to acid ends ratio of at least 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, or 3.6 and/or less than 10, 9, 8, 7, or 6.

In another embodiment, the sulfopolyesters comprises a carboxylate ends content of at least 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 and/or less than 200, 175, 150, 125, or 105 µeq/g.

In another embodiment, the sulfopolyester comprises an acid ends content of at least 1, 2, 3, 4, 5, 6, 7, 8, 9, 10, 11, 12, 13, 14, or 15 and/or less than 50, 45, 40, 35, 30, 25, or 20 µeq/g.

### Processes to Produce Sulfopolyesters

The sulfopolyesters of the instant invention are readily prepared from the appropriate dicarboxylic acids, esters, anhydrides, or salts, sulfomonomer, and the appropriate diol or diol mixtures using typical polycondensation reaction conditions. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The term “continuous” as used herein means a process wherein reactants are introduced and products withdrawn simultaneously in an uninterrupted manner. By “continuous” it is meant that the process is substantially or completely continuous in operation and is to be contrasted with a “batch” process. “Continuous” is not meant in any way to prohibit normal interruptions in the continuity of the process due to, for example, start-up, reactor maintenance, or scheduled shut down periods. The term “batch” process as used herein means a process wherein all the reactants are added to the reactor and then processed according to a predetermined course of reaction during which no material is fed or removed into the reactor. The term “semicontinuous” means a process where some of the reactants are charged at the beginning of the process and the remaining reactants are fed continuously as the reaction progresses. Alternatively, a semicontinuous process may also include a process similar to a batch process in which all the reactants are added at the beginning of the process except that one or more of the products are removed continuously as the reaction progresses. The process is operated advantageously as a continuous process for economic reasons and to produce superior coloration of the polymer as the sulfopolyester may deteriorate in appearance if allowed to reside in a reactor at an elevated temperature for too long a duration.

The sulfopolyesters of the present invention are prepared by procedures known to persons skilled in the art. The sulfomonomer is most often added directly to the reaction mixture from which the polymer is made, although other processes are known and may also be employed, for example, as described in U. S. Pat. Numbers 3,018,272, 3,075,952, and 3,033,822. The reaction of the sulfomonomer, diol component and the dicarboxylic acid component may be carried out using conventional polyester polymerization conditions. For example, when preparing the sulfopolyesters by means of an ester interchange reaction, i.e., from the ester form of the dicarboxylic acid components, the reaction process may comprise two steps. In the first step, the diol component and the dicarboxylic acid component, such as, for example, dimethyl isophthalate, are reacted at elevated temperatures, typically, about 150° C. to about 250° C. for about 0.5 to about 8 hours at pressures ranging from about 0.0 kPa gauge to about 414 kPa gauge (60 pounds per square inch, “psig”). Preferably, the temperature for the ester interchange reaction ranges from about 180° C. to about 230° C. for about 1 to about 4 hours while the preferred pressure ranges from about 103 kPa gauge (15 psig) to about 276 kPa gauge (40 psig). Thereafter, the reaction product is heated under higher temperatures and under reduced pressure to form sulfopolyester with the elimination of diol, which is readily volatilized under these conditions and removed from the system. This second step, or polycondensation step, is continued under higher vacuum and a temperature which generally ranges from about 230° C. to about 350° C., preferably about 250° C. to about 310° C. and most preferably about 260° C. to about 290° C. for about 0.1 to about 6 hours, or preferably, for about 0.2 to about 2 hours, until a polymer having the desired degree of polymerization, as determined by inherent viscosity, is obtained. The polycondensation step may be conducted under reduced pressure which ranges from about 53 kPa (400 torr) to about 0.013 kPa (0.1 torr). Stirring or appropriate conditions are used in both stages to ensure adequate heat transfer and surface renewal of the reaction mixture. The reactions of both stages are facilitated by appropriate catalysts such as, for example, alkoxy titanium compounds, alkali metal hydroxides and alcoholates, salts of organic carboxylic acids, alkyl tin compounds, metal oxides, and the like. A three-stage manufacturing procedure, similar to that described in U.S. Pat. No. 5,290,631, may also be used, particularly when a mixed monomer feed of acids and esters is employed.

To ensure that the reaction of the diol component and dicarboxylic acid component by an ester interchange reaction mechanism is driven to completion, it is preferred to employ about 1.05 to about 2.5 moles of diol component to one mole dicarboxylic acid component. Persons of skill in the art will understand, however, that the ratio of diol component to dicarboxylic acid component is generally determined by the design of the reactor in which the reaction process occurs.

In the preparation of sulfopolyester by direct esterification, i.e., from the acid form of the dicarboxylic acid component, sulfopolyesters are produced by reacting the dicarboxylic acid or a mixture of dicarboxylic acids with the diol component or a mixture of diol components. The reaction is conducted at a pressure of from about 7 kPa gauge (1 psig) to about 1379 kPa gauge (200 psig), preferably less than 689 kPa (100 psig) to produce a low molecular weight, linear or branched sulfopolyester product having an average degree of polymerization of from about 1.4 to about 10. The temperatures employed during the direct esterification reaction typically range from about 180° C. to about 280° C., more preferably ranging from about 220° C. to about 270° C. This low molecular weight polymer may then be polymerized by a polycondensation reaction.

### End Use Applications for Sulfopolyesters

The inventive water-dispersible sulfopolyesters can be used in any end use applications known in the art. For example, water dispersible sulfopolyesters can be used in paints and coatings, inks, adhesives, plastics, films, and personal care products. Personal care products include, but are not limited to, cosmetics, hair products, lotions, and sunscreen. In one embodiment of the invention, the inventive sulfopolyesters are utilized as a primer for biaxially oriented PET used in flexible packaging or as a coating on aluminum foil. The sulfopolyester provides good adhesion and can be water and alcohol resistance. The inventive sulfopolyesters are also low in odor. Often times, the inventive water-dispersible sulfopolyesters are utilized in the form of a dispersion for various end use applications. The amount of the sulfopolyester in the dispersions range from about 15 to about 35, from about 20 to about 30, and from about 24 to about 27 % by weight.

### Fibers Comprising Inventive Sulfopolyesters

The inventive sulfopolyesters of this invention can be spun into water-dispersible fibers and fibrous articles that show tensile strength, absorptivity, flexibility, and fabric integrity in the presence of moisture, especially upon exposure to human bodily fluids. The fibers and fibrous articles of our invention do not require the presence of oil, wax, or fatty acid finishes or the use of large amounts (typically 10 weight % or greater) of pigments or fillers to prevent blocking or fusing of the fibers during processing. In addition, the fibrous articles prepared from our novel fibers do not require a binder and readily disperse or dissolve in home or public sewerage systems.

The fiber may optionally include a water-dispersible polymer blended with the sulfopolyester and, optionally, a water non-dispersible polymer blended with the sulfopolyester with the proviso that the blend is an immiscible blend. The fiber can contain less than 10 weight % of a pigment or filler, based on the total weight of the fiber. The present invention also includes fibrous articles comprising these fibers and may have one or more absorbent layers of fibers.

The sulfopolyesters of our invention may be used to produce unicomponent fibers, bicomponent or multicomponent fibers. For the purposes of this invention, the term “fiber” refers to a polymeric body of high aspect ratio capable of being formed into two or three dimensional articles such as woven, knitted, or nonwoven fabrics. In the context of the present invention, the term “fiber” is synonymous with “fibers” and intended to mean one or more fibers. The fibers of our invention may be unicomponent fibers, bicomponent, or multicomponent fibers. The term “unicomponent fiber”, as used herein, is intended to mean a fiber prepared by melt spinning a single sulfopolyester, blends of one or more sulfopolyesters, or blends of one or more sulfopolyesters with one or more additional polymers and includes staple, monofilament, and multifilament fibers. “Unicomponent” is intended to be synonymous with the term “monocomponent” and includes “biconstituent” or “multiconstituent” fibers, and refers to fibers which have been formed from at least two polymers extruded from the same extruder as a blend. Unicomponent or biconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Thus, the term “unicomponent” is not intended to exclude fibers formed from a polymer or blends of one or more polymers to which small amounts of additives may be added for coloration, anti-static properties, lubrication, hydrophilicity, etc.

By contrast, the term “multicomponent fiber”, as used herein, intended to mean a fiber prepared by melting the two or more fiber forming polymers in separate extruders and by directing the resulting multiple polymer flows into one spinneret with a plurality of distribution flow paths but spun together to form one fiber. Multicomponent fibers are also sometimes referred to as conjugate or bicomponent fibers. The polymers are arranged in substantially constantly positioned distinct segments or zones across the cross-section of the conjugate fibers and extend continuously along the length of the conjugate fibers. The configuration of such a multicomponent fiber may be, for example, a sheath/core arrangement wherein one polymer is surrounded by another or may be a side by side arrangement, a ribbon or stripped arrangement, a pie arrangement or an “islands-in-the-sea” arrangement. For example, a multicomponent fiber may be prepared by extruding the sulfopolyester and one or more water non-dispersible polymers separately through a spinneret having a shaped or engineered transverse geometry such as, for example, an “islands-in-the-sea” or segmented pie configuration. Multicomponent fibers, typically, are staple, monofilament or multifilament fibers that have a shaped or round cross-section. Most fiber forms are heatset. The fiber may include the various antioxidants, pigments, and additives as described herein.

For example, the fibers of the present invention may be prepared by melt spinning a single sulfopolyester or sulfopolyester blend and include staple, monofilament, and multifilament fibers with a shaped cross-section. In addition, our invention provides multicomponent fibers, such as described, for example, in U.S. Pat. No. 5,916,678, which may be prepared by extruding the sulfopolyester and one or more water non-dispersible polymers, which are immiscible with the sulfopolyester, separately through a spinneret having a shaped or engineered transverse geometry such as, for example, an “islands-in-the-sea”, sheath-core, side-by-side, ribbon (stripped), or segmented pie configuration. The sulfopolyester may be later removed by dissolving the interfacial layers or pie segments and leaving the smaller filaments or microdenier fibers of the water non-dispersible polymer(s). These fibers of the water non-dispersible polymer have fiber size much smaller than the multicomponent fiber before removing the sulfopolyester. For example, the sulfopolyester and water non-dispersible polymers may be fed to a polymer distribution system where the polymers are introduced into a segmented spinneret plate. The polymers follow separate paths to the fiber spinneret and are combined at the spinneret hole which comprises either two concentric circular holes thus providing a sheath-core type fiber, or a circular spinneret hole divided along a diameter into multiple parts to provide a fiber having a side-by-side type. Alternatively, the immiscible water dispersible sulfopolyester and water non-dispersible polymers may be introduced separately into a spinneret having a plurality of radial channels to produce a multicomponent fiber having a segmented pie cross section. Typically, the sulfopolyester will form the “sheath” component of a sheath core configuration. In fiber cross sections having a plurality of segments, the water non-dispersible segments, typically, are substantially isolated from each other by the sulfopolyester. Alternatively, multicomponent fibers may be formed by melting the sulfopolyester and water non-dispersible polymers in separate extruders and directing the polymer flows into one spinneret with a plurality of distribution flow paths in form of small thin tubes or segments to provide a fiber having an islands-in-the-sea shaped cross section. An example of such a spinneret is described in U.S. Pat. No. 5,366,804. In the present invention, typically, the sulfopolyester will form the “sea” component and the water non-dispersible polymer will form the “islands” component.

The unicomponent fibers, fibrous articles produced from the unicomponent fibers, and the sulfopolyester portion of the multicomponent fibers or articles comprising the multicomponent fibers are water-dispersible and, typically, completely disperse at room temperature. Higher water temperatures can be used to accelerate their dispersibility or rate of removal from the nonwoven or multicomponent fiber. The term “water-dispersible”, as used herein with respect to unicomponent fibers and fibrous articles prepared from unicomponent fibers, is intended to be synonymous with the terms “water-dissipatable”, “water-disintegratable”, “water-dissolvable”, “water-dispellable”, “water soluble”, water-removable”, “hydrosoluble”, and “hydrodispersible” and is intended to mean that the fiber or fibrous article is therein or therethrough dispersed or dissolved by the action of water. The terms “dispersed”, “dispersible”,“dissipate”, or “dissipatable” mean that, using a sufficient amount of deionized water (e.g., 100:1 water:fiber by weight) to form a loose suspension or slurry of the fibers or fibrous article, at a temperature of about 60° C., and within a time period of up to 5 days, the fiber or fibrous article dissolves, disintegrates, or separates into a plurality of incoherent pieces or particles distributed more or less throughout the medium such that no recognizable filaments are recoverable from the medium upon removal of the water, for example, by filtration or evaporation. Thus, “water-dispersible”, as used herein, is not intended to include the simple disintegration of an assembly of entangled or bound, but otherwise water insoluble or nondispersible, fibers wherein the fiber assembly simply breaks apart in water to produce a slurry of fibers in water which could be recovered by removal of the water. In the context of this invention, all of these terms refer to the activity of water or a mixture of water and a water-miscible cosolvent on the sulfopolyesters described herein. Examples of such water-miscible cosolvents includes alcohols, ketones, glycol ethers, esters and the like. It is intended for this terminology to include conditions where the sulfopolyester is dissolved to form a true solution as well as those where the sulfopolyester is dispersed within the aqueous medium. Often, due to the statistical nature of sulfopolyester compositions, it is possible to have a soluble fraction and a dispersed fraction when a single sulfopolyester sample is placed in an aqueous medium.

Similarly, the term “water-dispersible”, as used herein in reference to the sulfopolyester as one component of a multicomponent fiber or fibrous article, also is intended to be synonymous with the terms “water-dissipatable”, “water-disintegratable”, “water-dissolvable”, “water-dispellable”, “water soluble”, “water-removable”, “hydrosoluble”, and “hydrodispersible” and is intended to mean that the sulfopolyester component is sufficiently removed from the multicomponent fiber and is dispersed or dissolved by the action of water to enable the release and separation of the water non-dispersible fibers contained therein. The terms “dispersed”, “dispersible”, “dissipate”, or “dissipatable” mean that, using a sufficient amount of deionized water (e.g., 100:1 water:fiber by weight) to form a loose suspension or slurry of the fibers or fibrous article, at a temperature of about 60° C., and within a time period of up to 5 days, sulfopolyester component dissolves, disintegrates, or separates from the multicomponent fiber, leaving behind a plurality of microdenier fibers from the water non-dispersible segments.

The term “segment” or “domain” or “zone” when used to describe the shaped cross section of a multicomponent fiber refers to the area within the cross section comprising the water non-dispersible polymers where these domains or segments are substantially isolated from each other by the water-dispersible sulfopolyester intervening between the segments or domains. The term “substantially isolated”, as used herein, is intended to mean that the segments or domains are set apart from each other to permit the segments domains to form individual fibers upon removal of the sulfopolyester. Segments or domains or zones can be of similar size and shape or varying size and shape. Again, segments or domains or zones can be arranged in any configuration. These segments or domains or zones are “substantially continuous” along the length of the multicomponent extrudate or fiber. The term “substantially continuous” means continuous along at least 10 cm length of the multicomponent fiber. These segments, domains, or zones of the multicomponent fiber produce water non-dispersible polymer microfibers when the water dispersible sulfopolyester is removed.

As stated within this disclosure, the shaped cross section of a multicomponent fiber can, for example, be in the form of a sheath core, islands-in-the sea, segmented pie, hollow segmented pie; off-centered segmented pie, side-by-side, ribbon (stripped) etc.

In another embodiment, however, the sulfopolyesters of this invention may be a single polyester or may be blended with one or more supplemental polymers to modify the properties of the resulting fiber. The supplemental polymer may or may not be water-dispersible depending on the application and may be miscible or immiscible with the sulfopolyester. If the supplemental polymer is water non-dispersible, it is preferred that the blend with the sulfopolyester is immiscible. The term “miscible”, as used herein, is intended to mean that the blend has a single, homogeneous amorphous phase as indicated by a single composition-dependent Tg. For example, a first polymer that is miscible with second polymer may be used to “plasticize” the second polymer as illustrated, for example, in U.S. Pat. No. 6,211,309. By contrast, the term “immiscible”, as used herein, denotes a blend that shows at least 2, randomly mixed, phases and exhibits more than one Tg. Some polymers may be immiscible and yet compatible with the sulfopolyester. A further general description of miscible and immiscible polymer blends and the various analytical techniques for their characterization may be found in Polymer Blends Volumes 1 and 2, Edited by D.R. Paul and C.B. Bucknall, 2000, John Wiley & Sons, Inc.

Non-limiting examples of water-dispersible polymers that may be blended with the sulfopolyester are polymethacrylic acid, polyvinyl pyrrolidone, polyethylene-acrylic acid copolymers, polyvinyl methyl ether, polyvinyl alcohol, polyethylene oxide, hydroxy propyl cellulose, hydroxypropyl methyl cellulose, methyl cellulose, ethyl hydroxyethyl cellulose, isopropyl cellulose, methyl ether starch, polyacrylamides, poly(N-vinyl caprolactam), polyethyl oxazoline, poly(2-isopropyl-2-oxazoline), polyvinyl methyl oxazolidone, water-dispersible sulfopolyesters, polyvinyl methyl oxazolidimone, poly(2,4-dimethyl-6-triazinylethylene), and ethylene oxide-propylene oxide copolymers. Examples of polymers which are water non-dispersible that may be blended with the sulfopolyester include, but are not limited to, polyolefins, such as homo- and copolymers of polyethylene and polypropylene; poly(ethylene terephthalate); poly(butylene terephthalate); and polyamides, such as nylon-6; polylactides; caprolactone; Eastar Bio® (poly(tetramethylene adipate-co-terephthalate), a product of Eastman Chemical Company); polycarbonate; polyurethane; and polyvinyl chloride.

According to our invention, blends of more than one sulfopolyester may be used to tailor the end-use properties of the resulting fiber or fibrous article, for example, a nonwoven fabric or web. The blends of one or more sulfopolyesters will have a Tg of at least 57° C. Thus, blending may also be exploited to alter the processing characteristics of a sulfopolyester to facilitate the fabrication of a nonwoven. In another example, an immiscible blend of polypropylene and sulfopolyester may provide a conventional nonwoven web that will break apart and completely disperse in water as true solubility is not needed. In this latter example, the desired performance is related to maintaining the physical properties of the polypropylene while the sulfopolyester is only a spectator during the actual use of the product or, alternatively, the sulfopolyester is fugitive and is removed before the final form of the product is utilized.

The sulfopolyester and supplemental polymer may be blended in batch, semicontinuous, or continuous processes. Small scale batches may be readily prepared in any high-intensity mixing devices well-known to those skilled in the art, such as Banbury mixers, prior to melt-spinning fibers. The components may also be blended in solution in an appropriate solvent. The melt blending method includes blending the sulfopolyester and supplemental polymer at a temperature sufficient to melt the polymers. The blend may be cooled and pelletized for further use or the melt blend can be melt spun directly from this molten blend into fiber form. The term “melt” as used herein includes, but is not limited to, merely softening the polyester. For melt mixing methods generally known in the polymers art, see Mixing and Compounding of Polymers (I. Manas-Zloczower & Z. Tadmor editors, Carl Hanser Verlag Publisher, 1994, New York, N. Y.).

The water dispersible sulfopolyesters, unicomponent, multicomponent, and short cut fibers and fibrous articles made therefrom also may contain other conventional additives and ingredients which do not deleteriously affect their end use. For example, additives such as fillers, surface friction modifiers, light and heat stabilizers, extrusion aids, antistatic agents, colorants, dyes, pigments, fluorescent brighteners, antimicrobials, anticounterfeiting markers, hydrophobic and hydrophilic enhancers, viscosity modifiers, slip agents, tougheners, adhesion promoters, and the like may be used.

The fibers and fibrous articles of our invention do not require the presence of additives such as, for example, pigments, fillers, oils, waxes, or fatty acid finishes, to prevent blocking or fusing of the fibers during processing. The terms “blocking or fusing”, as used herein, is understood to mean that the fibers or fibrous articles stick together or fuse into a mass such that the fiber cannot be processed or used for its intended purpose. Blocking and fusing can occur during processing of the fiber or fibrous article or during storage over a period of days or weeks and is exacerbated under hot, humid conditions.

In one embodiment of the invention, the fibers and fibrous articles will contain less than 10 weight % of such anti-blocking additives, based on the total weight of the fiber or fibrous article. For example, the fibers and fibrous articles may contain less than 10 weight % of a pigment or filler. In other examples, the fibers and fibrous articles may contain less than 9 weight %, less than 5 weight%, less than 3 weight %, less than 1 weight %, and 0 weight % of a pigment or filler, based on the total weight of the fiber. Colorants, sometimes referred to as toners, may be added to impart a desired neutral hue and/or brightness to the sulfopolyester. When colored fibers are desired, pigments or colorants may be included in the sulfopolyester reaction mixture during the reaction of the diol monomer and the dicarboxylic acid monomer or they may be melt blended with the preformed sulfopolyester. A preferred method of including colorants is to use a colorant having thermally stable organic colored compounds having reactive groups such that the colorant is copolymerized and incorporated into the sulfopolyester to improve its hue. For example, colorants such as dyes possessing reactive hydroxyl and/or carboxyl groups, including, but not limited to, blue and red substituted anthraquinones, may be copolymerized into the polymer chain. When dyes are employed as colorants, they may be added to the copolyester reaction process after an ester interchange or direct esterification reaction.

Monofilament fibers generally range in size from about 15 to about 8000 denier per filament (abbreviated herein as “d/f”). Fibers comprising our inventive sulfopolyesters typically will have d/f values in the range of about 40 to about 5000. Monofilaments may be in the form of unicomponent or multicomponent fibers. The multifilament fibers of our invention will preferably range in size from about 1.5 micrometers for melt blown webs, about 0.5 to about 50 d/f for staple fibers, and up to about 5000 d/f for monofilament fibers. Multifilament fibers may also be used as crimped or uncrimped yarns and tows. Fibers used in melt blown web and melt spun fabrics may be produced in microdenier sizes. The term “microdenier”, as used herein, is intended to mean a d/f value of 1 d/f or less. For example, the microdenier fibers of the instant invention typically have d/f values of 1 or less, 0.5 or less, or 0.1 or less. Nanofibers can also be produced by electrostatic spinning.

As noted hereinabove, the sulfopolyesters also are advantageous for the preparation of bicomponent and multicomponent fibers having a shaped cross section.

In one embodiment, a multicomponent fiber having a shaped cross section is provided. The multicomponent fiber comprises: (a) a water dispersible sulfopolyester comprising: (i) residues of one or more dicarboxylic acids, (ii) at least 4 mole percent and less than 8.5 mole percent of residues of at least one sulfomonomer, and (iii) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), wherein all stated mole percentages are based on the total of all acid and hydroxy moiety repeating units being equal to 200 mole percent; and (b) one or more domains comprising one or more water non-dispersible polymers immiscible with said sulfopolyester.

In another embodiment; a multicomponentfiber having a shaped cross section is provided. The multicomponent fiber comprises: (a) a water dispersible sulfopolyester comprising: (i) residues of one or more dicarboxylic acids, (ii) greater than 8.5 mole percent of residues of at least one sulfomonomer, and (iii) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (b) one or more domains comprising one or more water non-dispersible polymers immiscible with said amorphous sulfopolyester

In another embodiment; a multicomponentfiber having a shaped cross section is provided. The multicomponent fiber comprises: (a) a water dispersible sulfopolyester comprising - (i) residues of one or more dicarboxylic acids, (ii) greater than 8.5 mole percent of residues of at least one sulfomonomer, and (iii) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (b) one or more domains comprising one or more water non-dispersible polymers immiscible with said sulfopolyester.

The dicarboxylic acids, diols, sulfopolyester, sulfomonomers, and branching monomers residues are as described previously for other embodiments of the invention.

In another embodiment of the invention, the water dispersible sulfopolyester component of the multicomponent fiber presents properties which allow at least one of the following: (A) the multicomponent fibers to be spun to a desired low denier; (B) the multicomponent fibers to prevent fusing or blocking; (C) the dispersing of the sulfopolyester at a temperature less than or equal to 90° C. to form a dispersion of at least 5 wt% sulfopolyester; (D) the sulfopolyester in these mulficomponent fibers is resistant to removal during hydroentangling of a web formed from the fibers but is efficiently removed at elevated temperatures after hydroentanglement; and (E) the multicomponent fibers are heat settable to yield a stable, strong fabric.

The water non-dispersible component of the multicomponent fiber may comprise any of those water non-dispersible polymers described herein. Spinning of the fiber may also occur according to any method described herein. However, the improved rheological properties of multicomponent fibers in accordance with this aspect of the invention provide for enhanced drawings speeds. When the sulfopolyester and water non-dispersible polymer are extruded to produce multicomponent extrudates, the multicomponent extrudate is capable of being melt drawn to produce the multicomponent fiber, using any of the methods disclosed herein, at a speed of at least about 2000 m/min, more preferably at least about 3000 m/min, even more preferably at least about 4000 m/min, and most preferably at least about 4500 m/min. Although not intending to be bound by theory, melt drawing of the multicomponent extrudates at these speeds results in at least some oriented crystallinity in the water non-dispersible component of the multicomponent fiber. This oriented crystallinity can increase the dimensional stability of non-woven materials made from the multicomponent fibers during subsequent processing.

Another advantage of the multicomponent extrudate is that it can be melt drawn to a multicomponent fiber having an as-spun denier of less than 6 deniers per filament. Other ranges of multicomponent fiber sizes include an as-spun denier of less than 4 deniers per filament and less than 2.5 deniers per filament.

The multicomponent fiber comprises a plurality of segments or domains of one or more water non-dispersible polymers immiscible with the sulfopolyester in which the segments or domains are substantially isolated from each other by the sulfopolyester intervening between the segments or domains. The term “substantially isolated”, as used herein, is intended to mean that the segments or domains are set apart from each other to permit the segments domains to form individual fibers upon removal of the sulfopolyester. For example, the segments or domains may be touching each others as in, for example, a segmented pie configuration but can be split apart by impact or when the sulfopolyester is removed.

The ratio by weight of the sulfopolyester to water non-dispersible polymer component in the multicomponent fiber of the invention is generally in the range of about 60:40 to about 2:98 or, in another example, in the range of about 50:50 to about 5:95. Typically, the sulfopolyester comprises 50% by weight or less of the total weight of the multicomponent fiber.

The segments or domains of multicomponent fiber may comprise one of more water non-dispersible polymers. Examples of water non-dispersible polymers which may be used in segments of the multicomponent fiber include, but are not limited to, polyolefins, polyesters, polyamides, polylactides, polycaprolactone, polycarbonate, polyurethane, cellulose ester, and polyvinyl chloride. For example, the water non-dispersible polymer may be polyester such as poly(ethylene) terephthalate, poly(butylene) terephthalate, poly(cyclohexylene) cyclohexanedicarboxylate, poly(cyclohexylene) terephthalate, poly(trimethylene) terephthalate, and the like. In another example, the water non-dispersible polymer can be biodistintegratable as determined by DIN Standard 54900 and/or biodegradable as determined by ASTM Standard Method, D6340-98. Examples of biodegradable polyesters and polyester blends are disclosed in U.S. Pat. No.’s 5,599,858; 5,580,911; 5,446,079; and 5,559,171. The term “biodegradable”, as used herein in reference to the water non-dispersible polymers of the present invention, is understood to mean that the polymers are degraded under environmental influences such as, for example, in a composting environment, in an appropriate and demonstrable time span as defined, for example, by ASTM Standard Method, D6340-98, entitled “Standard Test Methods for Determining Aerobic Biodegradation of Radiolabeled Plastic Materials in an Aqueous or Compost Environment”. The water non-dispersible polymers of the present invention also may be “biodisintegratable”, meaning that the polymers are easily fragmented in a composting environment as defined, for example, by DIN Standard 54900. For example, the biodegradable polymer is initially reduced in molecular weight in the environment by the action of heat, water, air, microbes and other factors. This reduction in molecular weight results in a loss of physical properties (tenacity) and often in fiber breakage. Once the molecular weight of the polymer is sufficiently low, the monomers and oligomers are then assimilated by the microbes. In an aerobic environment, these monomers or oligomers are ultimately oxidized to CO₂, H₂O, and new cell biomass. In an anaerobic environment, the monomers or oligomers are ultimately converted to CO₂, H₂, acetate, methane, and cell biomass.

For example, water non-dispersible polymer may be an aliphatic-aromatic polyester, abbreviated herein as “AAPE”. The term “aliphatic-aromatic polyester”, as used herein, means a polyester comprising a mixture of residues from aliphatic or cycloaliphatic dicarboxylic acids or diols and aromatic dicarboxylic acids or diols. The term “non-aromatic”, as used herein with respect to the dicarboxylic acid and diol monomers of the present invention, means that carboxyl or hydroxyl groups of the monomer are not connected through an aromatic nucleus. For example, adipic acid contains no aromatic nucleus in its backbone, i.e., the chain of carbon atoms connecting the carboxylic acid groups, thus is “non-aromatic”. By contrast, the term “aromatic” means the dicarboxylic acid or diol contains an aromatic nucleus in the backbone such as, for example, terephthalic acid or 2,6-naphthalene dicarboxylic acid. “Non-aromatic”, therefore, is intended to include both aliphatic and cycloaliphatic structures such as, for example, diols and dicarboxylic acids, which contain as a backbone a straight or branched chain or cyclic arrangement of the constituent carbon atoms which may be saturated or paraffinic in nature, unsaturated, i.e., containing non-aromatic carbon-carbon double bonds, or acetylenic, i.e., containing carbon-carbon triple bonds. Thus, in the context of the description and the claims of the present invention, non-aromatic is intended to include linear and branched, chain structures (referred to herein as “aliphatic”) and cyclic structures (referred to herein as “alicyclic” or “cycloaliphatic”). The term “non-aromatic”, however, is not intended to exclude any aromatic substituents which may be attached to the backbone of an aliphatic or cycloaliphatic diol or dicarboxylic acid. In the present invention, the difunctional carboxylic acid typically is a aliphatic dicarboxylic acid such as, for example, adipic acid, or an aromatic dicarboxylic acid such as, for example, terephthalic acid. The difunctional hydroxyl compound may be cycloaliphatic diol such as, for example, 1,4-cyclohexanedimethanol, a linear or branched aliphatic diol such as, for example, 1,4-butanediol, or an aromatic diol such as, for example, hydroquinone.

The AAPE may be a linear or branched random copolyester and/or chain extended copolyester comprising diol residues which comprise the residues of one or more substituted or unsubstituted, linear or branched, diols selected from aliphatic diols containing 2 to about 8 carbon atoms, polyalkylene ether glycols containing 2 to 8 carbon atoms, and cycloaliphatic diols containing about 4 to about 12 carbon atoms. The substituted diols, typically, will comprise 1 to about 4 substituents independently selected from halo, C₆-C₁₀ aryl, and C₁-C₄ alkoxy. Examples of diols which may be used include, but are not limited to, ethylene glycol, diethylene glycol, propylene glycol, 1,3-propanediol, 2,2-dimethyl-1,3-propanediol, 1,3-butanediol, 1,4-butanediol, 1,5-pentanediol, 1,6-hexanediol, polyethylene glycol, diethylene glycol, 2,2,4-trimethyl-1,6-hexanediol, thiodiethanol, 1,3-cyclohexanedimethanol, 1,4-cyclohexanedimethanol, 2,2,4,4-tetramethyl-1,3-cyclobutanediol, triethylene glycol, and tetraethylene glycol with the preferred diols comprising one or more diols selected from 1,4-butanediol; 1,3-propanediol; ethylene glycol; 1,6-hexanediol; diethylene glycol; or 1,4-cyclohexanedimethanol. The AAPE also comprises diacid residues which contain about 35 to about 99 mole %, based on the total moles of diacid residues, of the residues of one or more substituted or unsubstituted, linear or branched, non-aromatic dicarboxylic acids selected from aliphatic dicarboxylic acids containing 2 to about 12 carbon atoms and cycloaliphatic acids containing about 5 to about 10 carbon atoms. The substituted non-aromatic dicarboxylic acids will typically contain 1 to about 4 substituents selected from halo, C₆-C₁₀ aryl, and C₁-C₄ alkoxy. Non-limiting examples of non-aromatic diacids include malonic, succinic, glutaric, adipic, pimelic, azelaic, sebacic, fumaric, 2,2-dimethyl glutaric, suberic, 1,3-cyclopentanedicarboxylic, 1,4-cyclohexanedicarboxylic, 1,3-cyclohexanedicarboxylic, diglycolic, itaconic, maleic, and 2,5-norbornanedicarboxylic. In addition to the non-aromatic dicarboxylic acids, the AAPE comprises about 1 to about 65 mole %, based on the total moles of diacid residues, of the residues of one or more substituted or unsubstituted aromatic dicarboxylic acids containing 6 to about 10 carbon atoms. In the case where substituted aromatic dicarboxylic acids are used, they will typically contain 1 to about 4 substituents selected from halo, C₆-C₁₀ aryl, and C₁-C₄ alkoxy. Non-limiting examples of aromatic dicarboxylic acids which may be used in the AAPE of our invention are terephthalic acid, isophthalic acid, salts of 5-sulfoisophthalic acid, and 2,6-naphthalenedicarboxylic acid. More preferably, the non-aromatic dicarboxylic acid will comprise adipic acid, the aromatic dicarboxylic acid will comprise terephthalic acid, and the diol will comprise 1,4-butanediol.

Other possible compositions for the AAPE’s of our invention are those prepared from the following diols and dicarboxylic acids (or polyester-forming equivalents thereof such as diesters) in the following mole %ages, based on 100 mole % of a diacid component and 100 mole % of a diol component: (1) glutaric acid (about 30 to about 75%); terephthalic acid (about 25 to about 70%); 1,4-butanediol (about 90 to 100%); and modifying diol (0 about 10%); (2) succinic acid (about 30 to about 95%); terephthalic acid (about 5 to about 70%); 1,4-butanediol (about 90 to 100%); and modifying diol (0 to about 10%); and (3) adipic acid (about 30 to about 75%); terephthalic acid (about 25 to about 70%); 1,4-butanediol (about 90 to 100%); and modifying diol (0 to about 10%).

The modifying diol preferably is selected from 1,4-cyclohexanedimethanol, triethylene glycol, polyethylene glycol and neopentyl glycol. The most preferred AAPE’s are linear, branched or chain extended copolyesters comprising about 50 to about 60 mole % adipic acid residues, about 40 to about 50 mole % terephthalic acid residues, and at least 95 mole % 1,4-butanediol residues. Even more preferably, the adipic acid residues comprise about 55 to about 60 mole %, the terephthalic acid residues comprise about 40 to about 45 mole %, and the diol residues comprise about 95 mole % 1,4-butanediol residues. Such compositions are commercially available under the trademark EASTAR BIO® copolyester from Eastman Chemical Company, Kingsport, TN, and under the trademark ECOFLEX® from BASF Corporation.

Additional, specific examples of preferred AAPE’s include a poly(tetramethylene glutarate-co-terephthalate) containing (a) 50 mole percent glutaric acid residues, 50 mole percent terephthalic acid residues, and 100 mole percent 1,4-butanediol residues, (b) 60 mole percent glutaric acid residues, 40 mole percent terephthalic acid residues, and100 mole percent 1,4-butanediol residues or (c) 40 mole percent glutaric acid residues, 60 mole percent terephthalic acid residues, and 100 mole percent 1,4-butanediol residues; a poly(tetramethylene succinate-co-terephthalate) containing (a) 85 mole percent succinic acid residues, 15 mole percent terephthalic acid residues, and 100 mole percent 1,4-butanediol residues or (b) 70 mole percent succinic acid residues, 30 mole percent terephthalic acid residues, and 100 mole percent 1,4-butanediol residues; a poly(ethylene succinate-co-terephthalate) containing 70 mole percent succinic acid residues, 30 mole percent terephthalic acid residues, and 100 mole percent ethylene glycol residues; and a poly(tetramethylene adipate-co-terephthalate) containing (a) 85 mole percent adipic acid residues, 15 mole percent terephthalic acid residues, and 100 mole percent 1,4-butanediol residues; or (b) 55 mole percent adipic acid residues, 45 mole percent terephthalic acid residues, and 100 mole percent 1,4-butanediol residues.

The AAPE preferably comprises from about 10 to about 1,000 repeating units and preferably, from about 15 to about 600 repeating units. The AAPE may have an inherent viscosity of about 0.4 to about 2.0 dL/g, or more preferably about 0.7 to about 1.6 dL/g, as measured at a temperature of 25° C. using a concentration of 0.5 gram copolyester in 100 ml of a 60/40 by weight solution of phenol/tetrachloroethane.

The AAPE, optionally, may contain the residues of a branching agent. The mole %age ranges for the branching agent are from about 0 to about 2 mole %, preferably about 0.1 to about 1 mole %, and most preferably about 0.1 to about 0.5 mole % based on the total moles of diacid or diol residues (depending on whether the branching agent contains carboxyl or hydroxyl groups). The branching agent preferably has a weight average molecular weight of about 50 to about 5000, more preferably about 92 to about 3000, and a functionality of about 3 to about 6. The branching agent, for example, may be the esterified residue of a polyol having 3 to 6 hydroxyl groups, a polycarboxylic acid having 3 or 4 carboxyl groups (or ester-forming equivalent groups) or a hydroxy acid having a total of 3 to 6 hydroxyl and carboxyl groups. In addition, the AAPE may be branched by the addition of a peroxide during reactive extrusion.

Each segment of the water non-dispersible polymer may be different from others in fineness and may be arranged in any shaped or engineered cross-sectional geometry known to persons skilled in the art. For example, the sulfopolyester and a water non-dispersible polymer may be used to prepare a bicomponent fiber having an engineered geometry such as, for example, a side-by-side, “islands-in-the-sea”, segmented pie, sheath/core, ribbon (stripped), or other configurations known to persons skilled in the art. Other multicomponent configurations are also possible. Subsequent removal of a side, the “sea”, or a portion of the “pie” can result in very fine fibers. The process of preparing bicomponent fibers also is well known to persons skilled in the art. In a bicomponent fiber, the sulfopolyester fibers of this invention may be present in amounts of about 10 to about 90 weight % and will generally be used in the sheath portion of sheath/core fibers. Typically, when a water-insoluble or water non-dispersible polymer is used, the resulting bicomponent or multicomponent fiber is not completely water-dispersible. Side by side combinations with significant differences in thermal shrinkage can be utilized for the development of a spiral crimp. If crimping is desired, a saw tooth or stuffer box crimp is generally suitable for many applications. If the second polymer component is in the core of a sheath/core configuration, such a core optionally may be stabilized.

The sulfopolyesters are particularly useful for fibers having an “islands-in-the-sea” or “segmented pie” cross section as they only requires neutral or slightly acidic (i.e., “soft” water) to disperse, as compared to the caustic-containing solutions that are sometimes required to remove other water dispersible polymers from multicomponent fibers. The term “soft water” as used in this disclosure means that the water has up to 5 grains per gallon as CaCOs (1 grain of CaCOs per gallon is equivalent to 17.1 ppm).

In one embodiment, the multicomponent fiber has an islands-in-the-sea or segmented pie cross section and contains less than 10 weight % of a pigment or filler, based on the total weight of the fiber.

### Process of Making Multicomponent Fibers

Our novel multicomponent fiber may be prepared by any number of methods known to persons skilled in the art. In one embodiment, a process for producing at least one multicomponent fiber is provided. The process comprises spinning at least one water dispersible sulfopolyester and at least one water-nondispersable polymer immiscible with the sulfopolyester into the multicomponent fiber, the sulfopolyester comprising: (i) residues of one or more dicarboxylic acids, (ii) at least 4 mole percent and less than 8.5 mole percent of residues of at least one sulfomonomer, and (iii) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), wherein all stated mole percentages are based on the total of all acid and hydroxy moiety repeating units being equal to 200 mole percent.

In another embodiment of the invention, a process for producing at least one multicomponent fiber having a shaped cross section is provided. The process comprises spinning at least one water dispersible sulfopolyester and at least one water-nondispersable polymer immiscible with the sulfopolyester into the multicomponent fiber, the sulfopolyester comprising: (i) residues of one or more dicarboxylic acids, (ii) greater than 8.5 mole percent of residues of at least one sulfomonomer, and (iii) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

In another embodiment of the invention, a process for producing at least one multicomponent fiber having a shaped cross section is provided. The process comprises spinning at least one water dispersible sulfopolyester and at least one water-nondispersable polymer immiscible with the sulfopolyester into the multicomponent fiber, the sulfopolyester comprising: (i) residues of one or more dicarboxylic acids, (ii) greater than 8.5 mole percent of residues of at least one sulfomonomer, and (iii) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein the sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent.

The multicomponent fiber has a plurality of segments comprising the water non-dispersible polymers and the segments are substantially isolated from each other by the sulfopolyester intervening between the segments. In one embodiment, the fiber contains less than 10 weight % of a pigment or filler, based on the total weight of the fiber. For example, the multicomponent fiber may be prepared by melting the sulfopolyester and one or more water non-dispersible polymers in separate extruders and directing the individual polymer flows into one spinneret or extrusion die with a plurality of distribution flow paths such that the water non-dispersible polymer component form small segments or thin strands which are substantially isolated from each other by the intervening sulfopolyester. The cross section of such a fiber may be, for example, a segmented pie arrangement or an islands-in-the-sea arrangement. In another example, the sulfopolyester and one or more water non-dispersible polymers are separately fed to the spinneret orifices and then extruded in sheath-core form in which the water non-dispersible polymer forms a “core” that is substantially enclosed by the sulfopolyester “sheath” polymer. In the case of such concentric fibers, the orifice supplying the “core” polymer is in the center of the spinning orifice outlet and flow conditions of core polymer fluid are strictly controlled to maintain the concentricity of both components when spinning. Modifications in spinneret orifices enable different shapes of core and/or sheath to be obtained within the fiber cross-section. In yet another example, a multicomponent fiber having a side-by-side cross section or configuration may be produced (1) by coextruding the water dispersible sulfopolyester and water non-dispersible polymer through orifices separately and converging the separate polymer streams at substantially the same speed to merge side-by-side as a combined stream below the face of the spinneret; or (2) by feeding the two polymer streams separately through orifices, which converge at the surface of the spinneret, at substantially the same speed to merge side-by-side as a combined stream at the surface of the spinneret. In both cases, the velocity of each polymer stream, at the point of merge, is determined by its metering pump speed, the number of orifices, and the size of the orifice.

Typically, upon exiting the spinneret, the fibers are quenched with a cross flow of air whereupon the fibers solidify. Various finishes and sizes may be applied to the fiber at this stage. The cooled fibers, typically, are subsequently drawn and wound up on a take up spool. Other additives may be incorporated in the finish in effective amounts like emulsifiers, antistatics, antimicrobials, antifoams, lubricants, thermostabilizers, UV stabilizers, and the like.

Optionally, the drawn fibers may be textured and wound-up to form a bulky continuous filament. This one-step technique is known in the art as spin-draw-texturing. Other embodiments include flat filament (non-textured) yarns, or cut staple fiber, either crimped or uncrimped.

### End Use Applications for Multicomponent Fibers

The multicomponent fibers of this invention can utilized in any end use application known in the art. In one embodiment of the invention, multicomponent fibers of this invention are used to produce yarns. Yarns are defined as continuous strands of fibers that are suitable for weaving, knitting, fusing, or otherwise intertwining to produce a textile article, such as a fabric. In one embodiment of the invention, the multicomponent fiber is a filament yarn. Filament yarns are first drawn into continuous lengths of fiber and may be twisted during post processing. In another embodiment of this invention, the multicomponent fiber is cut into staple lengths and then twisted into a continuous strand called a spun yarn.

In another embodiment of this invention, the multicomponent fiber can be combined with at least one other fiber to produce a yarn. The yarn may be a spun yarn or filament yarn. The other fiber can include, but is not limited to, cotton, linen, silk, sisal/grass, leather, acetate, acrylic, modacrylic, polylactide, saran, cellulosic fiber pulp, inorganic fibers (e.g., glass, carbon, boron, ceramic, and combinations thereof), polyester fibers, nylon fibers, polyolefin fibers, rayon fibers, lyocell fibers, cellulose ester fibers, post-consumer recycled fibers, elastomeric fibers and combinations thereof.

Optionally, the multicomponent fibers may be post processed by various techniques, such as, drawing or texturing. Drawn fibers may be textured and wound-up to form a bulky continuous filament. A one-step technique is known in the art as spin-draw-texturing. Other embodiments include flat filament (non-textured) yarns, or cut staple fiber, either crimped or uncrimped.

Texturing, as used herein, refers to treating the flat filaments (or fibers) so that they are distorted to have loops, coils, curl, crimps or other deformation (i.e., ‘texture’) along the length of the filaments. Texturing the filaments or fibers increases bulkiness, porosity, elasticity and/or softness of the fiber. Different amounts (or degrees) of texturing can provide filaments and fibers with different properties. Texturing and texturizing may be used interchangeably herein.

The filaments and fibers are then used to make a yarn. The filaments or fibers may be combined with other filaments or fibers to make yarn, and more than one yarn may be combined together to make a new yarn by processes such as texturing, wrapping and the like, as known to one of skill in the art.

The drawn filaments or fibers may be textured to add crimp or deformation as well as bulk to the fiber depending on the desired properties using processes such as friction disk draw texturing (also referred to as false twist texturing), air jet texturing, knife edge texturing, stuffer box texturing and draw winding.

The inventive multicomponent fibers can be used to produce any articles known in the art. Inventive articles according to the instant invention include, but are not limited to, non-woven fabrics, knitted fabrics, woven fabrics, braids, and combinations thereof. Synthetic fabrics comprising the inventive multicomponent fibers can also be produced, such as, for example, synthetic suedes and leathers.

The inventive woven fabrics according to the instant invention may be fabricated from the inventive multicomponent fibers via different techniques. Such methods include, but are not limited to, weaving, braiding, and knitting processes.

In the weaving process, two sets of yarns, i.e. warp and weft, are interlaced to form the inventive woven fabric. The manner in which the two sets of yarns are interlaced determines the weave. The weaving process may be achieved via different equipment including, but not limited to, a Dobby loom, Jacquard loom, and Power loom. By using various combinations of the five basic weaves, i.e. plain, twill, satin, jacquard, and pile, it is possible to produce an almost unlimited variety of constructions.

In the knitting process, the inventive fabric is formed by interlooping a series of loops or one or more yarns. The two major classes of knitting include, but are not limited to, warp knitting and weft knitting.

Warp knitting is a type of knitting in which the yarns generally run lengthwise in the fabric. The yarns are prepared as warps on beams with one or more yarns for each needle. Weft knitting is, however, a common type of knitting in which one continuous thread runs crosswise in the fabric making all of the loops in one course. Weft knitting types are circular and flat knitting.

Braiding is a method to produce fabric wherein the interlacing is at an angle other than 90 degrees. To braid is to interweave or twine three or more separate strands of one or more materials in a diagonally overlapping pattern. Compared with the process of weaving, which usually involves two separate, perpendicular groups of strands (warp and weft), a braid is usually long and narrow, with each component strand functionally equivalent in zigzagging forward through the overlapping mass of the other strands resulting in an intersection angle other than perpendicular.

The woven, knitted, braided, or combination fabrics can be utilized in any article known in the art. The woven, knitted, or braided articles can be used in any type of apparel, footwear, home décor articles, military applications, and technical applications. Apparel can include sports and outdoor garments, industrial clothing, and everyday use clothing. Examples of sports and outdoor garments include, but are not limited to, base layers, jackets and vests, woven sports and fishing shirts, pants and shorts, socks, accessories, swimwear, and mid-layers, sweaters, and sweatshirts. Examples of industrial clothing includes military exercise clothing, clean room clothing, personal protective equipment, medical drapes and gowns, industrial uniforms, and prescription compression orthopedics. Examples of everyday apparel include, but are not limited to, intimate wear, jackets and vests, suits, dresses, oxford and collared woven shirts, skirts, tops, shirts, leggings, tights, pants, shorts and jeans. Footwear includes, but is not limited to, sandals, boots, hiking boots, trail runners, ski and snow boots, other sports and outdoor footwear, tennis shoes, business shoes, work boots, other everyday and athletic/leisure shoes. Examples of home décor articles include, but are not limited to, accessories, awnings, bath items, bed linens, bedspreads and comforters, blankets and throws, broadloom carpet, carpet backing, curtains, draperies, fiberfill paddings, kitchen linens, lampshades, linings, mattress pads, mattress ticking, oriental folk and designer rugs, outdoor carpeting/upholstery, passementerie (fringe), scatter and accent rugs, slipcovers, tablecloths and linens, upholstery, wallcoverings, wall tapestries, cleaning cloths, and woven floor mats and squares. Technical applications include, but are not limited to, barrier fabrics, geotextiles, and auto fabrics. Examples of barrier fabrics include, but are not limited to, clean room cloths, filtration, flags and banners, packaging, and tapes. Auto fabrics include, but are not limited to, auto upholstery, airbags, and other auto fabrics. Geotextiles include permeable fabrics which, when used in association with soil, have the ability to separate, filter, reinforce, protect, or drain.

The non-woven fabrics according to the instant invention may be fabricated via different techniques. Such methods include, but are not limited to, melt blown process, spun-bond process, carded web process, air laid process, thermo-calendering process, adhesive bonding process, hot air bonding process, needle punch process, hydroentangling process, electrospinning process, and combinations thereof.

In the melt blown process, the inventive non-woven fabric is formed by extruding molten water dispersible polymer and water non-dispersible polymer in addition to any other polymers known in the art through a die, then, attenuating and/or optionally breaking the resulting filaments with hot, high-velocity air or stream thereby forming short or long fiber lengths collected on a moving screen where they bond during cooling.

In the alternative, the melt blown process generally includes the following steps: (a) extruding strands from a spinneret; (b) simultaneously quenching and attenuating the polymer stream immediately below the spinneret using streams of high velocity heated air; (c) collecting the drawn strands into a web on a foraminous surface. Melt blown webs can be bonded by a variety of means including, but not limited to, autogeneous bonding, i.e. self bonding without further treatment, thermo-calendering process, adhesive bonding process, hot air bonding process, needle punch process, hydroentangling process, and combinations thereof.

In the spunbond process, the fabrication of non-woven fabric includes the following steps: (a) extruding strands of the water dispersible polymer and water non-dispersible polymer in addition to any other polymers known in the art from a spinneret; (b) quenching the strands with a flow of air which is generally cooled in order to hasten the solidification of the molten strands; (c) attenuating the filaments by advancing them through the quench zone with a draw tension that can be applied by either pneumatically entraining the filaments in an air stream or by wrapping them around mechanical draw rolls of the type commonly used in the textile fibers industry; (d) collecting the drawn strands into a web on a foraminous surface, e.g. moving screen or porous belt; and (e) bonding the web of loose strands into the non-woven fabric. Bonding can be achieved by a variety of means including, but not limited to, thermo-calendering process, adhesive bonding process, hot air bonding process, needle punch process, hydroentangling process, and combinations thereof.

The inventive multicomponent fibers may be used to produce a wide variety of nonwoven articles including filter media (e.g., HEPA filters, ULPA filters, coalescent filters, liquid filters, desalination filters, automotive filters, coffee filters, tea bags, and vacuum dust bags), battery separators, personal hygiene articles, sanitary napkins, tampons, diapers, disposable wipes (e.g., automotive wipes, baby wipes, hand and body wipes, floor cleaning wipes, facial wipes, toddler wipes, dusting and polishing wipes, and nail polish removal wipes), flexible packaging (e.g., envelopes, food packages, multiwall bags, and terminally sterilized medical packages), geotextiles (e.g., weed barriers, irrigation barriers, erosion barriers, and seed support media), building and construction materials (e.g., housing envelopes, moisture barrier film, gypsum board, wall paper, asphalt, papers, roofing underlayment, and decorative materials), surgical and medical materials (e.g., surgical drapes and gowns, bone support media, and tissue support media), security papers (e.g., currency paper, gaming and lottery paper, bank notes, and checks), cardboard, recycled cardboard, synthetic leather and suede, automotive headliners, personal protective garments, acoustical media, concrete reinforcement, flexible perform for compression molded composites, electrical materials (e.g., transformer boards, cable wrap and fillers, slot insulations, capacitor papers, and lampshade), catalytic support membranes, thermal insulation, labels, food packaging materials (e.g., aseptic, liquid packaging board, tobacco, release, pouch and packet, grease resistant, ovenable board, cup stock, food wrap, and coated one side), and printing and publishing papers (e.g., water and tear resistant printing paper, trade book, banners, map and chart, opaque, and carbonless). In one embodiment, the nonwoven article is selected from the group consisting of a battery separator, a high efficiency filter, and a high strength paper.

Additional nonwoven articles and the processes to produce such nonwoven articles are disclosed in U.S. Pat. No. 6,989,193, U.S. Pat. Application Publication No. 2005/0282008, U.S. Pat. Application Publication No. 2006/0194047, U.S. Pat. No. 7,687,143, U.S. Pat. Application No. 2008/0311815, and U.S. Pat. Application Publication No. 2008/0160859, the disclosures of which are incorporated herein by reference.

A binder dispersion may be applied to the nonwoven article by any method known in the art. In one embodiment, the binder dispersion is applied as an aqueous dispersion to the nonwoven article by spraying or rolling the binder dispersion onto the nonwoven article. Subsequent to applying the binder dispersion, the nonwoven article and the binder dispersion can be subjected to a drying step in order to allow the binder to set.

The binder dispersion may comprise a synthetic resin binder and/or a phenolic resin binder. The synthetic resin binder is selected from the group consisting of acrylic copolymers, styrenic copolymers, styrene-butadiene copolymers, vinyl copolymers, polyurethanes, sulfopolyesters, and combinations thereof. In one embodiment, the binder can comprise a blend of different sulfopolyesters having different sulfomonomer contents. For example, at least one of the sulfopolyesters comprises at least 15 mole percent of sulfomonomer and at least 45 mole percent of CHDM (consider spelling out the first time) and/or at least one of the sulfopolyesters comprises less than 10 mole percent of sulfomonomer and at least 70 mole percent of CHDM. The amount of sulfomonomer present in a sulfopolyester greatly affects its water-permeability. In another embodiment, the binder can be comprised of a sulfopolyester blend comprising at least one hydrophilic sulfopolyester and at least one hydrophobic sulfopolyester. An example of a hydrophilic sulfopolyester that can be useful as a binder is Eastek 1100® by EASTMAN. Likewise, an example of a hydrophobic sulfopolyester useful as a binder includes Eastek 1200® by EASTMAN. These two sulfopolyesters may be blended accordingly to optimize the water-permeability of the binder. Depending on the desired end use for the nonwoven article, the binder may be either hydrophilic or hydrophobic.

Undissolved or dried sulfopolyesters are known to form strong adhesive bonds to a wide array of substrates, including, but not limited to fluff pulp, cotton, acrylics, rayon, lyocell, PLA (polylactides), cellulose acetate, cellulose acetate propionate, poly(ethylene) terephthalate, poly(butylene) terephthalate, poly(trimethylene) terephthalate, poly(cyclohexylene) terephthalate, copolyesters, polyamides (e.g., nylons), stainless steel, aluminum, treated polyolefins, PAN (polyacrylonitriles), and polycarbonates. Thus, sulfopolyesters function as excellent binders for the nonwoven article. Therefore, our novel nonwoven articles may have multiple functionalities when a sulfopolyester binder is utilized.

The nonwoven article may further comprise a coating. After the nonwoven article and the optional binder dispersion are subjected to drying, a coating may be applied to the nonwoven article. The coating can comprise a decorative coating, a printing ink, a barrier coating, an adhesive coating, or a heat seal coating. In another example, the coating can comprise a liquid barrier and/or a microbial barrier.

After producing the nonwoven article, adding the optional binder, and/or after adding the optional coating, the nonwoven article may undergo a heat setting step comprising heating the nonwoven article to a temperature of at least 100° C., and more preferably to at least about 120° C. The heat setting step relaxes out internal fiber stresses and aids in producing a dimensionally stable fabric product. It is preferred that when the heat set material is reheated to the temperature to which it was heated during the heat setting step that it exhibits surface area shrinkage of less than about 10, 5, or 1 percent of its original surface area. However, if the nonwoven article is subjected to heat setting, then the nonwoven article may not be repulpable and/or recycled by repulping the nonwoven article after use.

The term “repulpable,” as used herein, refers to any nonwoven article that has not been subjected to heat setting and is capable of disintegrating at 3,000 rpm at 1.2 percent consistency after 5,000, 10,000, or 15,000 revolutions according to TAPPI standards.

In another aspect of the invention, the nonwoven article can further comprise at least one or more additional fibers. The additional fibers can have a different composition and/or configuration (e.g., length, minimum transverse dimension, maximum transverse dimension, cross-sectional shape, or combinations thereof) than the ribbon fibers and can be of any type of fiber that is known in the art depending on the type of nonwoven article to be produced. In one embodiment of the invention, the additional fiber can be selected from the group consisting cellulosic fiber pulp, inorganic fibers (e.g., glass, carbon, boron, ceramic, and combinations thereof), polyester fibers, nylon fibers, polyolefin fibers, rayon fibers, lyocell fibers, cellulose ester fibers, post-consumer recycled fibers, and combinations thereof. The nonwoven article can comprise additional fibers in an amount of at least 10, 15, 20, 25, 30, 40, or 60 weight percent of the nonwoven article and/or not more than 99, 98, 95, 90, 85, 80, 70, 60, or 50 weight percent of the nonwoven article. In one embodiment, the additional fiber is a cellulosic fiber that comprises at least 10, 25, or 40 weight percent and/or no more than 80, 70, 60, or 50 weight percent of the nonwoven article. The cellulosic fibers can comprise hardwood pulp fibers, softwood pulp fibers, and/or regenerated cellulose fibers. In another embodiment, at least one of the additional fibers is a glass fiber that has a minimum transverse dimension of less than 30, 25, 10, 8, 6, 4, 2, or 1 microns.

The nonwoven article can further comprise one or more additives. The additives may be added to the wet lap of water non-dispersible microfibers prior to subjecting the wet lap to a wet-laid or dry-laid process. Additives include, but are not limited to, starches, fillers, light and heat stabilizers, antistatic agents, extrusion aids, dyes, anticounterfeiting markers, slip agents, tougheners, adhesion promoters, oxidative stabilizers, UV absorbers, colorants, pigments, opacifiers (delustrants), optical brighteners, fillers, nucleating agents, plasticizers, viscosity modifiers, surface modifiers, antimicrobials, antifoams, lubricants, thermostabilizers, emulsifiers, disinfectants, cold flow inhibitors, branching agents, oils, waxes, and catalysts. The nonwoven article can comprise at least 0.05, 0.1, or 0.5 weight percent and/or not more than 10, 5, or 2 weight percent of one or more additives.

Generally, manufacturing processes to produce nonwoven articles from multicomponent fibers can be split into the following groups: dry-laid webs, wet-laid webs, combinations of these processes with each other, or other nonwoven processes.

Generally, dry-laid nonwoven articles are made with staple fiber processing machinery that is designed to manipulate fibers in a dry state. These include mechanical processes, such as carding, aerodynamic, and other air-laid routes. Also included in this category are nonwoven articles made from filaments in the form of tow, fabrics composed of staple fibers, and stitching filaments or yards (should this be cards?) (i.e., stitchbonded nonwovens). Carding is the process of disentangling, cleaning, and intermixing fibers to make a web for further processing into a nonwoven article. The process predominantly aligns the fibers which are held together as a web by mechanical entanglement and fiber-fiber friction. Cards (e.g., a roller card) are generally configured with one or more main cylinders, roller or stationary tops, one or more doffers, or various combinations of these principal components. The carding action is the combing or working of the water non-dispersible microfibers between the points of the card on a series of interworking card rollers. Types of cards include roller, woolen, cotton, and random cards. Garnetts can also be used to align these fibers.

The multicomponent fibers in the dry-laid process can also be aligned by air-laying. These fibers are directed by air current onto a collector which can be a flat conveyor or a drum.

Wet laid processes involve the use of papermaking technology to produce nonwoven articles. These nonwoven articles are made with machinery associated with pulp fiberizing (e.g., hammer mills) and paperforming (e.g., slurry pumping onto continuous screens which are designed to manipulate short fibers in a fluid).

In one embodiment of the wet-laid process, multicomponent fibers are suspended in water, brought to a forming unit wherein the water is drained off through a forming screen, and the fibers are deposited on the screen wire.

In another embodiment of the wet-laid process, multicomponent fibers are dewatered on a sieve or a wire mesh which revolves at high speeds of up to 1,500 meters per minute at the beginning of hydraulic formers over dewatering modules (e.g., suction boxes, foils, and curatures). The sheet is dewatered to a solid content of approximately 20 to 30 percent. The sheet can then be pressed and dried.

The nonwoven article can be held together by 1) mechanical fiber cohesion and interlocking in a web or mat; 2) various techniques of fusing of fibers, including the use of binder fibers and/or utilizing the thermoplastic properties of certain polymers and polymer blends; 3) use of a binding resin such as a starch, casein, a cellulose derivative, or a synthetic resin, such as an acrylic copolymer latex, a styrenic copolymer, a vinyl copolymer, a polyurethane, or a sulfopolyester; 4) use of powder adhesive binders; or 5) combinations thereof. The fibers are often deposited in a random manner, although orientation in one direction is possible, followed by bonding using one of the methods described above. In one embodiment, the multicomponent fibers can be substantially evenly distributed throughout the nonwoven article.

The nonwoven articles also may comprise one or more layers of water-dispersible fibers, multicomponent fibers, or microdenier fibers.

The nonwoven articles may also include various powders and particulates to improve the absorbency of the nonwoven article and its ability to function as a delivery vehicle for other additives. Examples of powders and particulates include, but are not limited to, talc, starches, various water absorbent, water-dispersible, or water swellable polymers (e.g., super absorbent polymers, sulfopolyesters, and poly(vinyl alcohols)), silica, activated carbon, pigments, and microcapsules. As previously mentioned, additives may also be present, but are not required, as needed for specific applications.

### Process to Produce Microfibers

The inventive sulfopolyester may be later removed from the multicomponent fibers by dissolving the water-dispersible sulfopolyester segments and leaving the smaller filaments or microdenier fibers of the water non-dispersible polymer(s). Our invention thus provides a process for microdenier fibers comprising: (A) spinning a water dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) contacting the multicomponent fibers with water to remove the sulfopolyester thereby forming microdenier fibers.

In another embodiment, the multicomponent fibers contain less than 10 weight % of a pigment or filler, based on the total weight of the fibers.

Typically, the multicomponent fiber is contacted with water at a temperature in a range of about 25° C. to about 100° C. or in a range of about 50° C. to about 80° C. for a time period of from about 10 to about 600 seconds whereby the sulfopolyester is dissipated or dissolved. After removal of the sulfopolyester, the remaining water non-dispersible polymer microfibers typically will have an average fineness of 1 d/f or less, typically, 0.5 d/f or less, or more typically, 0.1 d/f or less.

Typical applications of these remaining water non-dispersible polymer microfibers include nonwoven fabrics, such as, for example, artificial leathers, suedes, wipes, and filter media. Filter media produce from these microfibers can be utilized to filter air or liquids. Filter media for liquids include, but are not limited to, water, bodily fluids, solvents, and hydrocarbons. The ionic nature of sulfopolyesters also results in advantageously poor “solubility” in saline media, such as body fluids. Such properties are desirable in personal care products and cleaning wipes that are flushable or otherwise disposed in sanitary sewage systems. Selected sulfopolyesters have also been utilized as dispersing agents in dye baths and soil redeposition preventative agents during laundry cycles.

In one embodiment, that the water used to remove the sulfopolyester from the multicomponent fibers is above room temperature. In other embodiments, the water used to remove the sulfopolyester is at least about 45° C., at least about 60° C., or at least about 80° C.

### Process to Produce Short Cut Microfibers

In another embodiment of this invention, a process is provided to produce cut water non-dispersible polymer microfibers. The process comprises: (A) cutting a multicomponent fiber into cut multicomponent fibers; wherein the multicomponent fiber comprises at least one water-dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) contacting a fiber-containing feedstock with water to produce a fiber mix slurry; wherein the fiber-containing feedstock comprises cut multicomponent fibers; (C) heating the fiber mix slurry to produce a heated fiber mix slurry; (D) optionally, mixing the fiber mix slurry in a shearing zone; (E) removing at least a portion of the sulfopolyester from the cut multicomponent fiber to produce a slurry mixture comprising a sulfopolyester dispersion and the water non-dispersible polymer microfibers; and (F) separating the water non-dispersible polymer microfibers from the slurry mixture.

The multicomponent fiber can be cut into any length that can be utilized to produce nonwoven articles. In one embodiment of the invention, the multicomponent fiber is cut into lengths ranging from about 1 mm to about 50 mm. In other embodiments, the multicomponent fiber can be cut into lengths ranging from about 1 mm to about 25 mm, from about 1 mm to about 20 mm, from about 1 mm to about 15 mm, from about 1 mm to about 10 mm, from about 1 mm to about 6 mm, from about 1 mm to about 5 mm, from about 1 mm to about 5 mm. In another embodiment, the cut multicomponent fiber is cut into lengths of less than about 25 mm, less than about 20 mm, less than about 15 mm, less than about 10 mm, or less than about 5 mm. In another aspect of the invention, the multicomponent fiber can be cut into a mixture of different lengths.

As used in this disclosure, the term “staple fiber” is used to define fiber cut into lengths of greater than 25 mm to about 50 mm. The term “short-cut fiber” is used to define fiber cut to lengths of about 25 mm or less.

The fiber-containing feedstock can comprise any other type of fiber that is useful in the production of nonwoven articles. In one embodiment, the fiber-containing feedstock further comprises at least one fiber selected from the group consisting of cellulosic fiber pulp, glass fiber, polyester fibers, nylon fibers, polyolefin fibers, rayon fibers and cellulose ester fibers.

The fiber-containing feedstock is mixed with water to produce a fiber mix slurry. To facilitate the removal of the water-dispersible sulfopolyester, the water utilized can be soft water or deionized water. Soft water has been previously defined in this disclosure. In one embodiment of this invention, at least one water softening agent may be used to facilitate the removal of the water-dispersible sulfopolyester from the multicomponent fiber. Any water softening agent known in the art can be utilized. In one embodiment, the water softening agent is a chelating agent or calcium ion sequestrant. Applicable chelating agents or calcium ion sequestrants are compounds containing a plurality of carboxylic acid groups per molecule where the carboxylic groups in the molecular structure of the chelating agent are separated by 2 to 6 atoms. Tetrasodium ethylene diamine tetraacetic acid (EDTA) is an example of the most common chelating agent, containing four carboxylic acid moieties per molecular structure with a separation of 3 atoms between adjacent carboxylic acid groups. Poly acrylic acid, sodium salt is an example of a calcium sequestrant containing carboxylic acid groups separated by two atoms between carboxylic groups. Sodium salts of maleic acid or succinic acid are examples of the most basic chelating agent compounds. Further examples of applicable chelating agents include compounds which have in common the presence of multiple carboxylic acid groups in the molecular structure where the carboxylic acid groups are separated by the required distance (2 to 6 atom units) which yield a favorable steric interaction with di- or multi- valent cations such as calcium which cause the chelating agent to preferentially bind to di- or multi valent cations. Such compounds include, but are not limited to, diethylenetriaminepentaacetic acid; diethylenetriamine-N,N,N′,N′,N″-pentaacetic acid; pentetic acid; N,N-bis(2-(bis-(carboxymethyl)amino)ethyl)-glycine; diethylenetriamine pentaacetic acid; [[(carboxymethyl)imino]bis(ethylenenitrilo)]-tetra-acetic acid; edetic acid; ethylenedinitrilotetraacetic acid; EDTA, free base; EDTA free acid; ethylenediamine-N,N,N′,N′-tetraacetic acid; hampene; versene; N,N′-1,2-ethane diylbis-(N-(carboxymethyl)glycine); ethylenediamine tetra-acetic acid; N,N-bis(carboxymethyl)glycine; triglycollamic acid; trilone A; alpha,alpha′,alpha″-trimethylaminetricarboxylic acid; tri(carboxymethyl)amine; aminotriacetic acid; hampshire NTA acid; nitrilo-2,2′,2″-triacetic acid; titriplex i; nitrilotriacetic acid; and mixtures thereof.

The amount of water softening agent needed depends on the hardness of the water utilized in terms of Ca⁺⁺ and other multivalent ions.

The fiber mix slurry is heated to produce a heated fiber mix slurry. The temperature is that which is sufficient to remove a portion of the sulfopolyester from the multicomponent fiber. In one embodiment of the invention, the fiber mix slurry is heated to a temperature ranging from about 50° C. to about 100° C. Other temperature ranges are from about 70° C. to about 100° C., about 80° C. to about 100° C., and about 90° C. to about 100° C.

Optionally, the fiber mix slurry is mixed in a shearing zone. The amount of mixing is that which is sufficient to disperse and remove a portion of the water dispersible sulfopolyester from the multicomponent fiber and separate the water non-dispersible polymer microfibers. In one embodiment of the invention, 90% of the sulfopolyester is removed. In another embodiment, 95% of the sulfopolyester is removed, and in yet another embodiment, 98% or greater of the sulfopolyester is removed. The shearing zone can comprise any type of equipment that can provide shearing action necessary to disperse and remove a portion of the water dispersible sulfopolyester from the multicomponent fiber and separate the water non-dispersible polymer microfibers. Examples of such equipment include, but is not limited to, pulpers and refiners.

The water dispersible sulfopolyester in the multicomponent fiber after contact with water and heating will disperse and separate from the water non-dispersible polymer fiber to produce a slurry mixture comprising a sulfopolyester dispersion and the water non-dispersible polymer microfibers. The water non-dispersible polymer microfibers can then be separated from the sulfopolyester dispersion by any means known in the art. For examples, the slurry mixture can be routed through separating equipment, such as for example, screens and filters. Optionally, the water non-dispersible polymer microfibers may be washed once or numerous times to remove more of the water-dispersible sulfopolyester.

The removal of the water-dispersible sulfopolyester can be determined by physical observation of the slurry mixture. The water utilized to rinse the water non-dispersible polymer microfibers is clear if the water-dispersible sulfopolyester has been mostly removed. If the water-dispersible sulfopolyester is still being removed, the water utilized to rinse the water non-dispersible polymer microfibers can be milky. Further, if water-dispersible sulfopolyester remains on the water non-dispersible polymer microfibers, the microfibers can be somewhat sticky to the touch.

The water-dispersible sulfopolyester can be recovered from the sulfopolyester dispersion by any method known in the art.

In another embodiment of this invention, a water non-dispersible polymer microfiber is provided comprising at least one water non-dispersible polymer wherein the water non-dispersible polymer microfiber has an equivalent diameter of less than 5 microns and length of less than 25 millimeters. This water non-dispersible polymer microfiber is produced by the processes previously described to produce microfibers. In another aspect of the invention, the water non-dispersible polymer microfiber has an equivalent diameter of less than 3 microns and length of less than 25 millimeters. In other embodiments of the invention, the water non-dispersible polymer microfiber has an equivalent diameter of less than 5 microns or less than 3 microns. In other embodiments of the invention, the water non-dispersible polymer microfiber can have lengths of less than 12 millimeters; less than 10 millimeters, less than 6.5 millimeters, and less than 3.5 millimeters. The domains or segments in the multicomponent fiber once separated yield the water non-dispersible polymer microfibers.

The instant invention also includes a fibrous article comprising the water-dispersible fiber, the multicomponent fiber, microdenier fibers, or water non-dispersible polymer microfibers described hereinabove. The term “fibrous article” is understood to mean any article having or resembling fibers. Non-limiting examples of fibrous articles include multifilament fibers, yarns, cords, tapes, fabrics, wet-laid webs, dry-laid webs, melt blown webs, spunbonded webs, thermobonded webs, hydroentangled webs, nonwoven webs and fabrics, and combinations thereof; items having one or more layers of fibers, such as, for example, multilayer nonwovens, laminates, and composites from such fibers, gauzes, bandages, diapers, training pants, tampons, surgical gowns and masks, feminine napkins; and the like. In addition, the water non-dispersible microdfibers can be utilized in filter media for air filtration, liquid filtration, filtration for food preparation, filtration for medical applications, and for paper making processes and paper products. Further, the fibrous articles may include replacement inserts for various personal hygiene and cleaning products. The fibrous article of the present invention may be bonded, laminated, attached to, or used in conjunction with other materials which may or may not be water-dispersible. The fibrous article, for example, a nonwoven fabric layer, may be bonded to a flexible plastic film or backing of a water non-dispersible material, such as polyethylene. Such an assembly, for example, could be used as one component of a disposable diaper. In addition, the fibrous article may result from overblowing fibers onto another substrate to form highly assorted combinations of engineered melt blown, spunbond, film, or membrane structures.

The fibrous articles of the instant invention include nonwoven fabrics and webs. A nonwoven fabric is defined as a fabric made directly from fibrous webs without weaving or knitting operations. The Textile Institue defines nonwovens as textile structures made directly from fiber rather than yarn. These fabrics are normally made from continuous filments or from fibre webs or batts strengthened by bonding using various techniques, which include, but are not limited to, adhesive bonding, mechanical interlocking by needling or fluid jet entanglement, thermal bonding, and stitch bonding. For example, the multicomponent fiber of the present invention may be formed into a fabric by any known fabric forming process. The resulting fabric or web may be converted into a microdenier fiber web by exerting sufficient force to cause the multicomponent fibers to split or by contacting the web with water to remove the sulfopolyester leaving the remaining microdenier fibers behind.

In another embodiment of the invention, a process is provided for producing a microdenier fiber web, comprising: (A) spinning a water dispersible sulfopolyester having a glass transition temperature (Tg) of at least 57° C. and one or more water non-dispersible polymers immiscible with the sulfopolyester into multicomponent fibers, wherein the multicomponent fiber comprises at least one water-dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; wherein the multicomponent fibers have a plurality of segments comprising the water non-dispersible polymers wherein the segments are substantially isolated from each other by the sulfopolyester intervening between the segments; (B) overlapping and collecting the multicomponent fibers of Step A to form a nonwoven web; and (C) contacting the nonwoven web with water to remove the sulfopolyester thereby forming a microdenier fiber web.

In another embodiment of the invention, the multicomponent fiber utilized contains less than 10 weight % of a pigment or filler, based on the total weight of the fiber.

In another embodiment of the invention, a process for a microdenier fiber web is provided which comprises: (A) extruding at least one water dispersible sulfopolyester and one or more water non-dispersible polymers immiscible with the water dispersible sulfopolyester into multicomponent extrudates, the multicomponent extrudates have a plurality of domains comprising the water non-dispersible polymers wherein the domains are substantially isolated from each other by the water dispersible sulfopolyester intervening between the domains; wherein the multicomponent fiber comprises at least one water-dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) melt drawing the multicomponent extrudates at a speed of at least about 2000 m/min to produce multicomponent fibers; (C) collecting the multicomponent fibers of Step (B) to form a non-woven web; and (D) contacting the non-woven web with water to remove the sulfopolyester thereby forming a microdenier fiber web.

Prior to Step (C), the process can further comprise the step of hydroentangling the multicomponent fibers of the non-woven web. In one embodiment of the invention, the hydroentangling step results in a loss of less than about 20 weight % of the sulfopolyester contained in the multicomponent fibers, or less than 15 weight %, or less than 10 weight %. In furtherance of the goal of reducing the loss of sulfopolyester during hydroentanglement, the water used during this process can have a temperature of less than about 45° C., less than about 35° C., or less than about 30° C. In one embodiment of the invention, to minimize loss of sulfopolyester from the multicomponent fibers, the water used during hydroentanglement is as close to room temperature as possible. Conversely, removal of the sulfopolyester polymer during Step (D) can be carried out using water having a temperature of at least about 45° C., at least about 60° C., or at least about 80° C.

After hydroentanglement and prior to Step (D), the non-woven web may under go a heat setting step comprising heating the non-woven web to a temperature of at least about 100° C. or at least about 120° C. The heat setting step relaxes out internal fiber stresses and aids in producing a dimensionally stable fabric product. In other embodiments of the invention, when the heat set material is reheated to the temperature to which it was heated during the heat setting step that it exhibits surface area shrinkage of less than about 5% of its original surface area, less than about 2% of the original surface area, or less than about 1% of its original surface area.

Furthermore, the inventive method can comprise the step of drawing the multicomponent fiber at a fiber velocity of at least 2000 m/min, at least about 3000 m/min, at least about 4000 m/min, or at least about 5000 m/min.

In another embodiment of this invention, nonwoven articles comprising water non-dispersible polymer microfibers can be produced. The nonwoven article comprises water non-dispersible polymer microfibers and is produced by a process selected from the group consisting of a dry-laid process and a wet-laid process. Multicomponent fibers and processes for producing water non-dispersible polymer microfibers were previously disclosed in the specification.

In one embodiment of the invention, at least 1% of the water non-dispersible polymer microfiber is contained in the nonwoven article. Other amounts of water non-dispersible polymer microfiber contained in the nonwoven article are at least 10%, at least 25%, and at least 50%.

In another aspect of the invention, the nonwoven article can further comprise at least one other fiber. The other fiber can be any that is known in the art depending on the type of nonwoven article to be produced. In one embodiment of the invention, the other fiber can be selected from the group consisting cellulosic fiber pulp, glass fiber, polyester fibers, nylon fibers, polyolefin fibers, rayon fibers cellulose ester fibers, and mixtures thereof.

The nonwoven article can also further comprise at least one additive. Additives include, but are not limited to, starches, fillers, and binders. Other additives are discussed in other sections of this disclosure.

Generally, manufacturing processes to produce these nonwoven articles from water non-dispersible microfibers produced from multicomponent fibers can be split into the following groups: dry-laid webs, wet-laid webs, and combinations of these processes with each other or other nonwoven processes.

Generally, dry-laid nonwoven articles are made with staple fiber processing machinery which is designed to manipulate fibers in the dry state. These include mechnical processes, such as, carding, aerodynamic, and other air-laid routes. Also included in this category are nonwoven articles made from filaments in the form of tow, and fabrics composed of staple fibers and stitching filaments or yards i.e. stitchbonded nonwovens. Carding is the process of disentangling, cleaning, and intermixing fibers to make a web for further processing into a nonwoven article. The process predominantly aligns the fibers which are held together as a web by mechanical entanglement and fiber-fiber friction. Cards are generally configured with one or more main cylinders, roller or stationary tops, one or more doffers, or various combinations of these principal components. One example of a card is a roller card. The carding action is the combing or working of the cut multicomponent fibers or the water non-dispersible polymer microfibers between the points of the card on a series of interworking card rollers. Other types of cards include woolen, cotton, and random cards. Garnetts can also be used to align these fibers.

The cut multicomponent fibers or water non-dispersible polymer microfibers in the dried-laid process can also be aligned by air-laying. These fibers are directed by air current onto a collector which can be a flat conveyor or a drum.

Extrusion-formed webs can also be produced from the multicomponents fibers of this invention. Examples include spunbonded and melt-blown. Extrusion technology is used to produce spunbond, meltblown, and porous-film nonwoven articles. These nonwoven articles are made with machinery associated with polymer extrusion methods such as melt spinning, film casting, and extrusion coating. The nonwoven article is then contacted with water to remove the water dispersible sulfopolyester thus producing a nonwoven article comprising water non-dispersible polymer microfibers.

In the spunbond process, the water dispersible sulfopolyester and water non-dispersible polymer are transformed directly to fabric by extruding multicomponent filaments, orienting them as bundles or groupings, layering them on a conveying screen, and interlocking them. The interlocking can be conducted by thermal fusion, mechnical entanglement, hydroentangling, chemical binders, or combinations of these processes.

Meltblown fabrics are also made directly from the water dispersible sulfopolyester and the water non-dispersible polymer. The polymers are melted and extruded. When the melt passes through the extrusion orifice, it is blown with air at high temperature. The air stream attenuates and solidifies the molten polymers. The multicomponent fibers can then be separated from the air stream as a web and compressed between heated rolls.

Combined spunbond and meltbond processes can also be utilized to produce nonwoven articles.

Wet laid processes involve the use of papermaking technology to produce nonwoven articles. These nonwoven articles are made with machinery associated with pulp fiberizing, such as hammer mills, and paperforming. For example, slurry pumping onto continous screens which are designed to manipulate short fibers in a fluid.

In one embodiment of the wet laid process, water non-dispersible polymer microfibers are suspended in water, brought to a forming unit where the water is drained off through a forming screen, and the fibers are deposited on the screen wire.

In another embodiment of the wet laid process, water non-dispersible polymer microfibers are dewatered on a sieve or a wire mesh which revolves at the beginning of hydraulic formers over dewatering modules (suction boxes, foils and curatures) at high speeds of up to 1500 meters per minute. The sheet is then set on this wire mesh or sieve and dewatering proceeds to a solid content of approximately 20-30 weight %. The sheet can then be pressed and dried.

In another embodiment of the wet-laid process, a process is provided comprising: (A) optionally, rinsing the water non-dispersible polymer microfibers with water; (B) adding water to the water non-dispersible polymer microfibers to produce a water non-dispersible polymer microfiber slurry; (C) optionally, adding other fibers and /or additives to the water non-dispersible polymer microfibers or slurry; and (D) transferring the water non-dispersible polymer microfibers containing slurry to a wet-laid nonwoven zone to produce the nonwoven article.

In Step a), the number of rinses depends on the particular use chosen for the water non-dispersible polymer microfibers. In Step b), sufficient water is added to the microfibers to allow them to be routed to the wet-laid nonwoven zone.

The wet-laid nonwoven zone comprises any equipment known in the art to produce wet-laid nonwoven articles. In one embodiment of the invention, the wet-laid nonwoven zone comprises at least one screen, mesh, or sieve in order to remove the water from the water non-dispersible polymer microfiber slurry.

In another embodiment of the wet laid process, a process is provided comprising: (A) contacting a cut multicomponent fiber with water to remove a portion of the water dispersible sulfopolyester to produce a water non-dispersible polymer microfiber slurry; wherein the water non-dispersible polymer microfiber slurry comprises water non-dispersible polymer microfibers and water dispersible sulfopolyester; wherein the cut multicomponent fiber comprises at least one water-dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) optionally, rinsing the water non-dispersible polymer microfibers with water; (C) optionally, adding other fibers and /or additives to the water non-dispersible polymer slurry; and (D) transferring the water non-dispersible polymer microfibers containing slurry to a wet-laid nonwoven zone to produce the nonwoven article.

In another embodiment of the invention, the water non-dispersible polymer microfiber slurry is mixed prior to transferring to the wet-laid nonwoven zone.

Web-bonding processes can also be utilized to produce nonwoven articles. These can be split into chemical and physical processes. Chemical bonding refers to the use of water-based and solvent-based polymers to bind together the fibers and/or fibrous webs. These binders can be applied by saturation, impregnation, spraying, printing, or application as a foam. Physical bonding processes include thermal processes such as calendaring and hot air bonding, and mechanical processes such as needling and hydroentangling. Needling or needle-punching processes mechanically interlock the fibers by physically moving some of the fibers from a near-horizontal to a near-vertical position. Needle-punching can be conducted by a needleloom. A needleloom generally contains a web-feeding mechanism, a needle beam which comprises a needleboard which holds the needles, a stripper plate, a bed plate, and a fabric take-up mechanism.

Stitchbonding is a mechanical bonding method that uses knitting elements, with or without yarn, to interlock the fiber webs. Examples of stitchbonding machines include, but are not limited to, Maliwatt, Arachne, Malivlies, and Arabeva.

The nonwoven article can be held together by 1) mechanical fiber cohesion and interlocking in a web or mat; 2) various techniques of fusing of fibers, including the use of binder fibers, utilizing the thermoplastic properties of certain polymers and polymer blends; 3) use of a binding resin such as starch, casein, a cellulose derivative, or a synthetic resin, such as an acrylic latex or urethane; 4) powder adhesive binders; or 5) combinations thereof. The fibers are often deposited in a random manner, although orientation in one direction is possible, followed by bonding using one of the methods described above.

The fibrous articles of our invention also may comprise one or more layers of water-dispersible fibers, multicomponent fibers, or microdenier fibers. The fiber layers may be one or more nonwoven fabric layers, a layer of loosely bound overlapping fibers, or a combination thereof. In addition, the fibrous articles may include personal and health care products such as, but not limited to, child care products, such as infant diapers; child training pants; adult care products, such as adult diapers and adult incontinence pads; feminine care products, such as feminine napkins, panty liners, and tampons; wipes; fiber-containing cleaning products; medical and surgical care products, such as medical wipes, tissues, gauzes, examination bed coverings, surgical masks, gowns, bandages, and wound dressings; fabrics; elastomeric yarns, wipes, tapes, other protective barriers, and packaging material. The fibrous articles may be used to absorb liquids or may be pre-moistened with various liquid compositions and used to deliver these compositions to a surface. Non-limiting examples of liquid compositions include detergents; wetting agents; cleaning agents; skin care products, such as cosmetics, ointments, medications, emollients, and fragrances. The fibrous articles also may include various powders and particulates to improve absorbency or as delivery vehicles. Examples of powders and particulates include, but are not limited to, talc, starches, various water absorbent, water-dispersible, or water swellable polymers, such as super absorbent polymers, sulfopolyesters, and poly(vinylalcohols), silica, pigments, and microcapsules. Additives may also be present, but are not required, as needed for specific applications. Examples of additives include, but are not limited to, oxidative stabilizers, UV absorbers, colorants, pigments, opacifiers (delustrants), optical brighteners, fillers, nucleating agents, plasticizers, viscosity modifiers, surface modifiers, antimicrobials, disinfectants, cold flow inhibitors, branching agents, and catalysts.

In addition to being water-dispersible, the fibrous articles described above may be flushable. The term “flushable” as used herein means capable of being flushed in a conventional toilet, and being introduced into a municipal sewage or residential septic system, without causing an obstruction or blockage in the toilet or sewage system.

The fibrous article may further comprise a water-dispersible film comprising a second water-dispersible polymer. The second water-dispersible polymer may be the same as or different from the previously described water-dispersible polymers used in the fibers and fibrous articles of the present invention. In one embodiment, for example, the second water-dispersible polymer may be an additional sulfopolyester which, in turn, comprises: (A) about 50 to about 96 mole % of one or more residues of isophthalic acid or terephthalic acid, based on the total acid residues; (B) about 4 to about 30 mole %, based on the total acid residues, of a residue of sodiosulfoisophthalic acid; (C) one or more diol residues wherein at least 15 mole %, based on the total diol residues, is a poly(ethylene glycol) having a structure H-(OCH₂-CH₂)ₙ-OH wherein n is an integer in the range of 2 to about 500; (D) 0 to about 20 mole %, based on the total repeating units, of residues of a branching monomer having 3 or more functional groups wherein the functional groups are hydroxyl, carboxyl, or a combination thereof. The additional sulfopolyester may be blended with one or more supplemental polymers, as described hereinabove, to modify the properties of the resulting fibrous article. The supplemental polymer may or may not be water-dispersible depending on the application. The supplemental polymer may be miscible or immiscible with the additional sulfopolyester.

The additional sulfopolyester may contain other concentrations of isophthalic acid residues, for example, about 60 to about 95 mole %, and about 75 to about 95 mole %. Further examples of isophthalic acid residue concentrations ranges are about 70 to about 85 mole %, about 85 to about 95 mole % and about 90 to about 95 mole %. The additional sulfopolyester also may comprise about 25 to about 95 mole % of the residues of diethylene glycol. Further examples of diethylene glycol residue concentration ranges include about 50 to about 95 mole %, about 70 to about 95 mole %, and about 75 to about 95 mole %. The additional sulfopolyester also may include the residues of ethylene glycol and/or 1,4-cyclohexanedimethanol. Typical concentration ranges of CHDM residues are about 10 to about 75 mole %, about 25 to about 65 mole %, and about 40 to about 60 mole %. Typical concentration ranges of ethylene glycol residues are about 10 to about 75 mole %, about 25 to about 65 mole %, and about 40 to about 60 mole %. In another embodiment, the additional sulfopolyester comprises is about 75 to about 96 mole % of the residues of isophthalic acid and about 25 to about 95 mole % of the residues of diethylene glycol.

According to the invention, the sulfopolyester film component of the fibrous article may be produced as a monolayer or multilayer film. The monolayer film may be produced by conventional casting techniques. The multilayered films may be produced by conventional lamination methods or the like. The film may be of any convenient thickness, but total thickness will normally be between about 2 and about 50 mil.

The film-containing fibrous articles may include one or more layers of water-dispersible fibers as described above. The fiber layers may be one or more nonwoven fabric layers, a layer of loosely bound overlapping fibers, or a combination thereof. In addition, the film-containing fibrous articles may include personal and health care products as described hereinabove.

As described previously, the fibrous articles also may include various powders and particulates to improve absorbency or as delivery vehicles. Thus, in one embodiment, our fibrous article comprises a powder comprising a third water-dispersible polymer that may be the same as or different from the water-dispersible polymer components described previously herein. Other examples of powders and particulates include, but are not limited to, talc, starches, various water absorbent, water-dispersible, or water swellable polymers, such as poly(acrylonitiles), sulfopolyesters, and poly(vinyl alcohols), silica, pigments, and microcapsules.

Our novel fiber and fibrous articles have many possible uses in addition to the applications described above. One novel application involves the melt blowing a film or nonwoven fabric onto flat, curved, or shaped surfaces to provide a protective layer. One such layer might provide surface protection to durable equipment during shipping. At the destination, before putting the equipment into service, the outer layers of sulfopolyester could be washed off. A further embodiment of this general application concept could involve articles of personal protection to provide temporary barrier layers for some reusable or limited use garments or coverings. For the military, activated carbon and chemical absorbers could be sprayed onto the attenuating filament pattern just prior to the collector to allow the melt blown matrix to anchor these entities on the exposed surface. The chemical absorbers can even be changed in the forward operations area as the threat evolves by melt blowing on another layer.

A major advantage inherent to sulfopolyesters is the facile ability to remove or recover the polymer from aqueous dispersions via flocculation or precipitation by adding ionic moieties (i.e., salts). Other methods, such as pH adjustment, adding nonsolvents, freezing, and so forth may also be employed. Therefore, fibrous articles, such as outer wear protective garments, after successful protective barrier use and even if the polymer is rendered as hazardous waste, can potentially be handled safely at much lower volumes for disposal using accepted protocols, such as incineration.

Undissolved or dried sulfopolyesters are known to form strong adhesive bonds to a wide array of substrates, including, but not limited to fluff pulp, cotton, acrylics, rayon, lyocell, PLA (polylactides), cellulose acetate, cellulose acetate propionate, poly(ethylene) terephthalate, poly(butylene) terephthalate, poly(trimethylene) terephthalate, poly(cyclohexylene) terephthalate, copolyesters, polyamides (nylons), stainless steel, aluminum, treated polyolefins, PAN (polyacrylonitriles), and polycarbonates. Thus, our nonwoven fabrics may be used as laminating adhesives or binders that may be bonded by known techniques, such as thermal, radio frequency (RF), microwave, and ultrasonic methods. Adaptation of sulfopolyesters to enable RF activation is disclosed in a number of recent patents. Thus, our novel nonwoven fabrics may have dual or even multifunctionality in addition to adhesive properties. For example, a disposable baby diaper could be obtained where a nonwoven of the present invention serves as both an water-responsive adhesive as well as a fluid managing component of the final assembly.

Our invention also provides a process for water-dispersible sulfopolyester fibers comprising: (A) heating a water-dispersible polymer composition to a temperature above its flow point, wherein the polymer composition comprises at least one sulfopolyester selected from the group consisting of: wherein the multicomponent fiber comprises at least one water-dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (B) melt spinning filaments.

As described hereinabove, a water-dispersible polymer, optionally, may be blended with the sulfopolyester. In addition, a water non-dispersible polymer, optionally, may be blended with the sulfopolyester to form a blend such that blend is an immiscible blend. The term “flow point”, as used herein, means the temperature at which the viscosity of the polymer composition permits extrusion or other forms of processing through a spinneret or extrusion die.

The water-dispersible sulfopolyester fibers can be prepared by a melt blowing process. The polymer is melted in an extruder and forced through a die. The extrudate exiting the die is rapidly attenuated to ultrafine diameters by hot, high velocity air. The orientation, rate of cooling, glass transition temperature (T_{g}), and rate of crystallization of the fiber are important because they affect the viscosity and processing properties of the polymer during attenuation. The filament is collected on a renewable surface, such as a moving belt, cylindrical drum, rotating mandrel, and so forth. Predrying of pellets (if needed), extruder zone temperature, melt temperature, screw design, throughput rate, air temperature, air flow (velocity), die air gap and set back, nose tip hole size, die temperature, die-to-collector (DCP) distance, quenching environment, collector speed, and post treatments are all factors that influence product characteristics such as filament diameters, basis weight, web thickness, pore size, softness, and shrinkage. The high velocity air also may be used to move the filaments in a somewhat random fashion that results in extensive interlacing. If a moving belt is passed under the die, a nonwoven fabric can be produced by a combination of over-lapping laydown, mechanical cohesiveness, and thermal bonding of the filaments. Overblowing onto another substrate, such as a spunbond or backing layer, is also possible. If the filaments are taken up on an rotating mandrel, a cylindrical product is formed. A water-dispersible fiber lay-down can also be prepared by the spunbond process.

The instant invention, therefore, further provides a process for water-dispersible, nonwoven fabric comprising: (A) heating a water-dispersible polymer composition to a temperature above its flow point, wherein the polymer composition comprises at least one water-dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) melt-spinning filaments; and (C) overlapping and collecting the filaments of Step (B) to form a nonwoven fabric. As described hereinabove, a water-dispersible polymer, optionally, may be blended with the sulfopolyester. In addition, a water non-dispersible polymer, optionally, may be blended with the sulfopolyester to form a blend such that blend is an immiscible blend. The water-dispersible sulfopolyesters were previously described in this disclosure.

In certain embodiments of the present invention, the water-wet microfibrous product (wet lap) produced after the multicomponent fibers have been cut, washed, and drained of excess water can be directly used (i.e., without further drying) in a wet-laid nonwoven process. Direct use of the wet lap product in a wet-laid nonwoven process avoids the need for complete drying of the wet lap, thereby saving significant energy and equipment costs. When the wet lap production facility is located remotely from the facility for making wet-laid nonwovens, the wet lap can be packaged and transported from the wet lap production location to the nonwoven production location. Such a wet lap composition is described in further detail immediately below.

One embodiment of the present invention is directed to a wet lap composition comprising water and a plurality of synthetic fibers. Water can make up at least 50, 55, or 60 weight % and/or not more than 90, 85, or 80 weight % of the wet lap composition. The synthetic fibers can make up at least 10, 15, or 20 weight % and/or not more than 50, 45, or 40 weight % of the wet lap composition. The water and the synthetic fibers in combination make up at least 95, 98, or 99 weight % of the wet lap composition. The synthetic fibers can have a length of at least 0.25, 0.5, or 1 millimeter and/or not more than 25, 10, or 2 millimeters. The synthetic fibers can have a minimum transverse dimension at least 0.1, 0.5, or 0.75 microns and/or not more than 10, 5, or 2 microns.

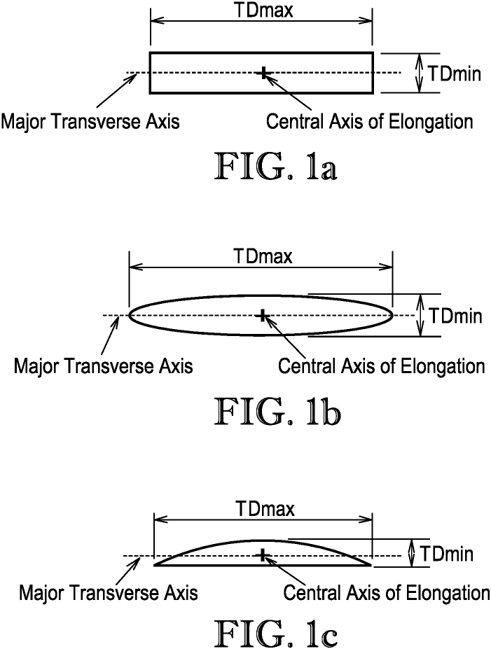

As used herein, “minimum transverse dimension” denotes the minimum dimension of a fiber measured perpendicular to the axis of elongation of the fiber by an external caliper method. As used herein, “maximum transverse dimension” is the maximum dimension of a fiber measured perpendicular to the axis of elongation of the fiber by the external caliper. FIGS. 1a, 1b, and 1c depict how these dimensions may be measured in various fiber cross-sections. In FIGS. 1a, 1a, and 1c, “TDmin” is the minimum transverse dimension and “TDmax” is the maximum transverse dimension. As used herein, “external caliper method” denotes a method of measuring an outer dimension of a fiber where the measured dimension is the distance separating two coplanar parallel lines between which the fiber is located and where each of the parallel lines touches the external surface of the fiber on generally opposite sides of the fiber. All fiber dimensions provided herein (e.g., length, minimum transverse dimension, and maximum transverse dimension) are the average dimensions of the fibers belonging to the specified group.

The wet lap composition can further comprise a fiber finishing composition in an amount of at least 10, 50, or 100 ppmw and/or not more than 1,000, 500, 250 ppmw. In one embobiment, the fiber finishing composition can comprise an oil, a wax, and/or a fatty acid. In another embodiment, the fiber finishing composition can comprise a naturally-derived fatty acid and/or a naturally-derived oil. In yet another embodiment, the wherein the fiber finishing composition comprises mineral oil, stearate esters, sorbitan esters, and/or neatsfoot oil. In still another embodiment, the fiiber finishing composition comprises mineral oil.

The wet lap composition can further comprise a water dispersible polymer in an amount of at least 0.001, 0.01, or 0.1 and/or not more than 5, 2, or 1 weight %. In one embodiment the water dispersible polymer comprises at least one sulfopolyester. Sulfopolyesters were previously described in this disclosure.

The water non-dispersible synthetic polymer of the wet lap compostition can be selected from the group consisting of polyolefins, polyesters, copolyesters, polyamides, polylactides, polycaprolactones, polycarbonates, polyurethanes, cellulose esters, acrylics, polyvinyl chlorides, and blends thereof. In one embodiment, the water non-dispersible synthetic polymer is selected from the group consisting of polyethylene terephthalate homopolymer, polyethylene terephthalate copolymers, polybutylene terephthalate, polypropylene terephthalate, nylon 6, nylon 66, and blends thereof.

The wet-lap composition can be made by a process comprising the following steps: (A) producing multicomponent fibers comprising at least one water dispersible sulfopolyester and one or more water non-dispersible synthetic polymers immiscible with the water dispersible sulfopolyester, wherein the multicomponent fibers have an as-spun denier of less than 15 dpf; wherein the multicomponent fiber comprises at least one water-dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) cutting the multicomponent fibers into cut multicomponent fibers having a length of less than 25 millimeters; (C) contacting the cut multicomponent fibers with wash water to remove the water dispersible sulfopolyester thereby forming a slurry of synthetic fibers in a sulfopolyester dispersion, wherein the sulfopolyester dispersion comprises water and at least a portion of the sulfopolyester; and (D) removing at least a portion of the sulfopolyester dispersion from the slurry to thereby producing a wet lap composition.

As discussed above, the wet lap composition can be used directly in a wet-laid process to make a nonwoven articles. In order to use the wet lap in a wet-laid process, the wet lap compostion is transferred from its place of production to a wet-laid nonwoven zone. The wet lap composition can be combined with additional fibers in the wet-laid nonwoven zone and/or immediately upstream of the wet-laid nonwoven zone. The additional fibers can be selected from a group consisting of cellulosic fiber pulp, inorganic fibers, polyester fibers, nylon fibers, lyocell fibers, polyolefin fibers, rayon fibers, cellulose ester fibers, and combinations thereof.

As part of the wet-laid process, the wet lap composition can be combined with dilution water in the wet-laid nonwoven zone and/or immediately upstream of the wet-laid nonwoven zone. The dilution water and wet lap can be combined in amounts such that at least 50, 75, 90, or 95 parts by weight of the dilution water is used per one part of the wetlap.

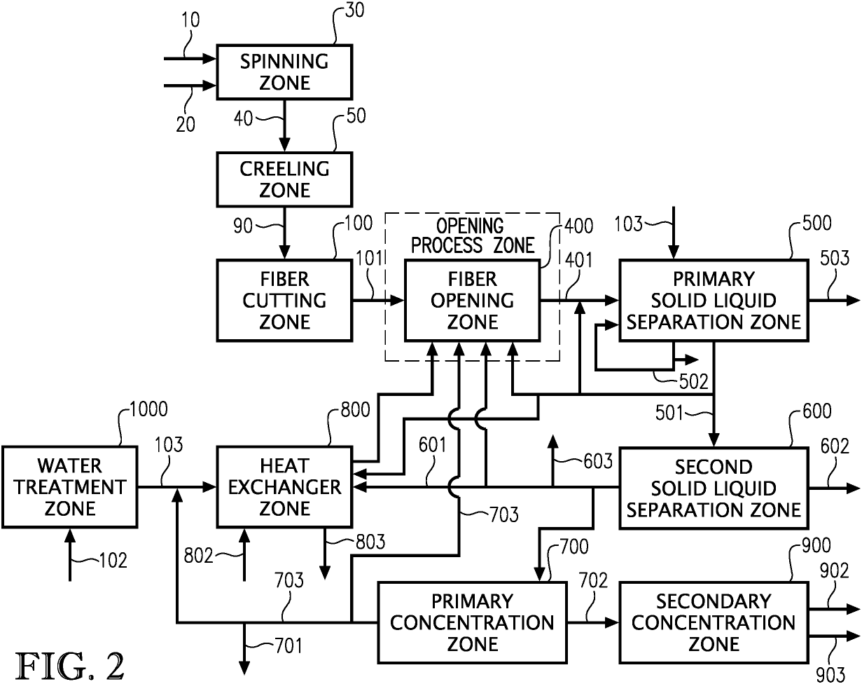

In other embodiments of the invention, as shown in FIGS. 2, 3a, 3b, and 4, processes for producing a microfiber product stream are provided. Multicomponent fibers were previously discussed in this disclosure. Further disclosures concerning multicomponent fibers are provided in the following patents and patents applications: U.S. Pat. 6,989,193; 7,635,745; 7,902,094; 7,892,993; 7,687,143; and U.S. Pat. Applications 12/199,304; 12/909,574; 13/273,692; 13/273,648; 13/273,710; 13/273,720; 13/273,929, 13/273,937; 13/273,727, 13/273,737; 13/273,745; 13/273,749; 12/966,502; 12/966,507; 12/975,450; 12/975,452; 12/975,456; 13/053,615; 13/352,362; 13/433,812; 13/433,854; 61/471,259; 61/472,964; and 61/558,744, which are all hereby incorporated by reference to the extent they do not contradict the statements herein.

The terms “wet lap” and “microfiber product stream” will be used interchangeably in this disclosure.

### One Step Process to Produce Short Cut Microfibers

In one embodiment of the invention as shown in FIG. 2, a process for producing a microfiber product stream is provided. The process comprises: (A) contacting short cut multicomponent fibers 101 having a length of less than 25 millimeters with a heated aqueous stream 801 in a fiber opening zone 400 to remove a portion of the water dispersible sulfopolyester to produce an opened microfiber slurry 401; wherein the short cut multicomponent fibers comprise at least one water dispersible sulfopolyester and at least one water non-dispersible synthetic polymer immiscible with the water dispersible sulfopolyester; wherein the heated aqueous stream 801 is at a temperature of at least 40° C.; wherein the opened microfiber slurry 401 comprises water, microfiber, and water dispersible sulfopolyester; wherein the short cut multicomponent fiber comprises at least one water-dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) routing the opened microfiber slurry 401 to a primary solid liquid separation zone 500 to produce the microfiber product stream 503 and a first mother liquor stream 501; wherein the first mother liquor stream 501 comprises water and the water dispersible sulfopolyester.

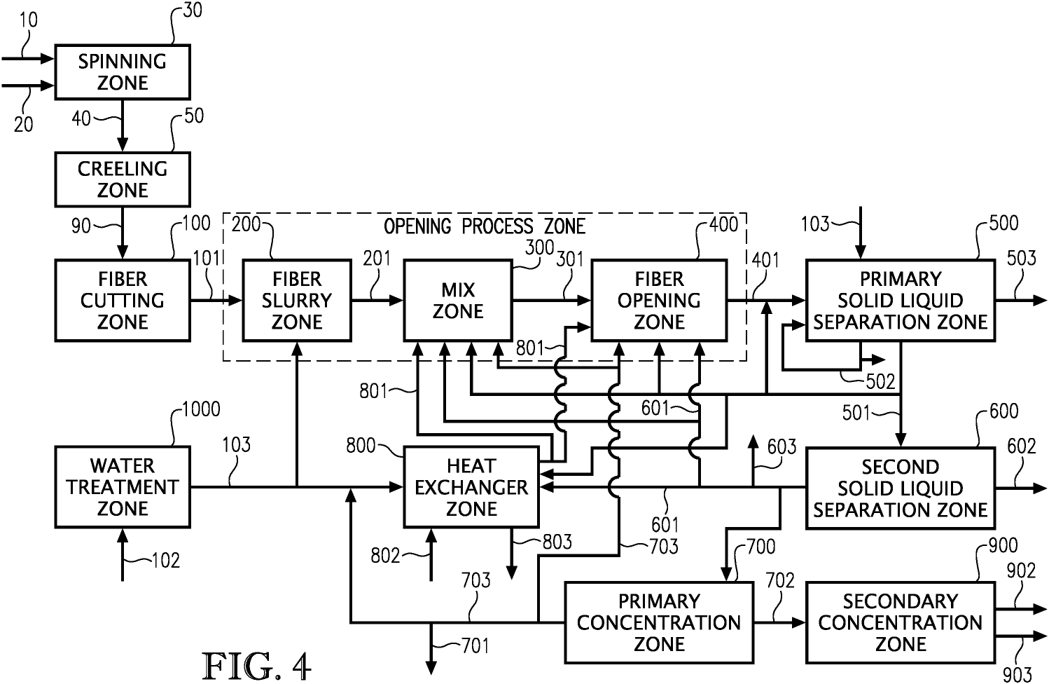

In this embodiment of the invention, the fiber slurry zone 200, mix zone 300, and the fiber opening zone 400 as shown in FIG. 4 have been combined into one unit operation in the opening process zone 1100. The opening process zone 1100 comprises a fiber opening zone 400.

A treated aqueous stream 103 for use in the process can be produced by routing an aqueous stream 102 to an aqueous treatment zone 1000 to produce a treated aqueous stream 103. The aqueous stream comprises water. In embodiments of the invention, the concentration of monovalent metal cations in the treated aqueous stream 103 can be less than about 1000 ppm by weight, less than about 500 ppm by weight, less than about 100 ppm by weight, or less than about 50 ppm by weight. Removal of divalent and multivalent metal cations from the aqueous stream 102 is one function of the aqueous treatment zone 1000. In other embodiments of the invention, the concentration of divalent and multivalent cations is less than about 50 ppm by weight, less than about 25 ppm by weight, less than about 10 ppm by weight, or less than about 5 ppm by weight. The temperature of stream 103 can range from ground water temperature to about 40° C.

The treatment of the aqueous stream 102 in the aqueous treatment zone 1000 can be accomplished in any way know in the art. In one embodiment, aqueous treatment zone 1000 comprises distillation equipment wherein water vapor is generated and condensed to produce the treated aqueous stream 103. In another embodiment, water is routed to a reverse osmosis membrane separation capable of separating monovalent and divalent metal cations from water to produce the treated aqueous stream 103. In another embodiment, water is routed to an ion exchange resin to generate the treated aqueous stream 103 with acceptably low concentration of metal cations. In yet another embodiment, water can be routed to a commercial water softening apparatus to generate the treated aqueous stream 103 with an acceptably low concentration of divalent and multivalent metal cations. It is understood that any combinations of these water treatment options may be employed to achieve the required treated water characteristics.

The treated aqueous stream 103 may be routed to any location in the process where it is needed. In one embodiment, a portion of stream 103 is routed to a primary solid liquid separation zone 500 to serve as a cloth wash and/or a wash for solids contained in the primary solid liquid separation zone 500.

In one embodiment, at least a portion of the treated aqueous stream 103 is routed to heat exchanger zone 800 to produce a heated aqeous stream. One function of heat exchanger zone 800 is to generate a heated aqueous stream 801 at a specific and controlled temperature.

In one embodiment, streams that can feed heat exchanger zone 800 are the treated aqueous stream 103 and the second mother liquor stream 601. In another embodiment, streams that can feed heat exchanger zone 800 comprise the treated aqueous stream 103, a portion of the primary recovered water stream 703, a portion of the first mother liquor stream 501, and a portion the second mother liquor stream 601.

Any equipment know in the art for controlling the temperature of stream 801 may be used including, but not limited to, any heat exchanger with steam used to provide a portion of the required energy, any heat exchanger with a heat transfer fluid used to provide a portion of the required energy, any heat exchanger with electrical heating elements used to provide a portion of the required energy, and any vessel or tank with direct steam injection wherein the steam condenses and the condensate mixes with the water feeds to heat exchanger zone 800. The multicomponent fiber stream 90 is routed to fiber cutting zone 100 to generate cut multicomponent fiber stream 101. The multicomponent fiber can be of any multicomponent structure known in the art. The multicomponent fiber comprises a water dispersible sulfopolyester and a water non-dispersible polymer as previously discussed in this disclosure.

Any equipment know in the art may be used to cut multicomponent fiber stream 90 to generate cut multicomponent fiber stream 101. In one embodiment, the length of the cut fibers in the cut multicomponent fiber stream 101 is less than about 50 mm. In other embodiments, the length of cut fibers in the cut multicomponent fiber stream 101 is less than about 25 mm, less than about 20 mm, less than about 15 mm, less than about 10 mm, less than about 5 mm, or less than 2.5 mm.

The cut multicomponent fiber stream 101 and a portion of the heated treated aqueous stream 801 are routed to a fiber opening zone 400 to generate opened microfiber slurry 401. One function of fiber opening zone 400 is to separate the water dispersible polymer from the cut multicomponent fiber such that at least a portion of the water non-dispersible polymer microfibers separate from the cut multicomponent fiber and become suspended in the opened microfiber slurry 401. In another embodiment of the invention, from about 50 weight % to about 100 weight % of water non-dispersible polymer microfiber contained in the cut multicomponent fiber slurry 201 becomes suspended in the opened microfiber slurry 401 as water non-dispersible polymer microfibers and is no longer a part of the cut multicomponent fiber. In other embodiments, from about 75 weight % to about 100 weight %, from about 90 weight % to about 100 weight %, or from about 95 weight % to about 100 weight % of the water non-dispersible polymer microfiber contained in the cut multicomponent fiber stream 201 becomes suspended in the opened microfiber slurry 401 as water non-dispersible polymer microfibers and are no longer a part of a cut multicomponent fiber.

The diameter or denier of the starting cut multicomponent fiber in stream 201 impacts the extent of separation of the water dispersible sulfopolyester from the cut multicomponent fiber in the fiber opening zone 400. Typical multicomponent fiber types generally have a diameter in the range from about 12 microns to about 20 microns. Useful multicomponent fibers can have larger starting diameters to a size of about 40 microns diameter or more. The time required to separate a desired amount of water dispersible sulfopolyester from the cut multicomponent fiber increases as the diameter of the cut multicomponent fiber in stream 201 increases.

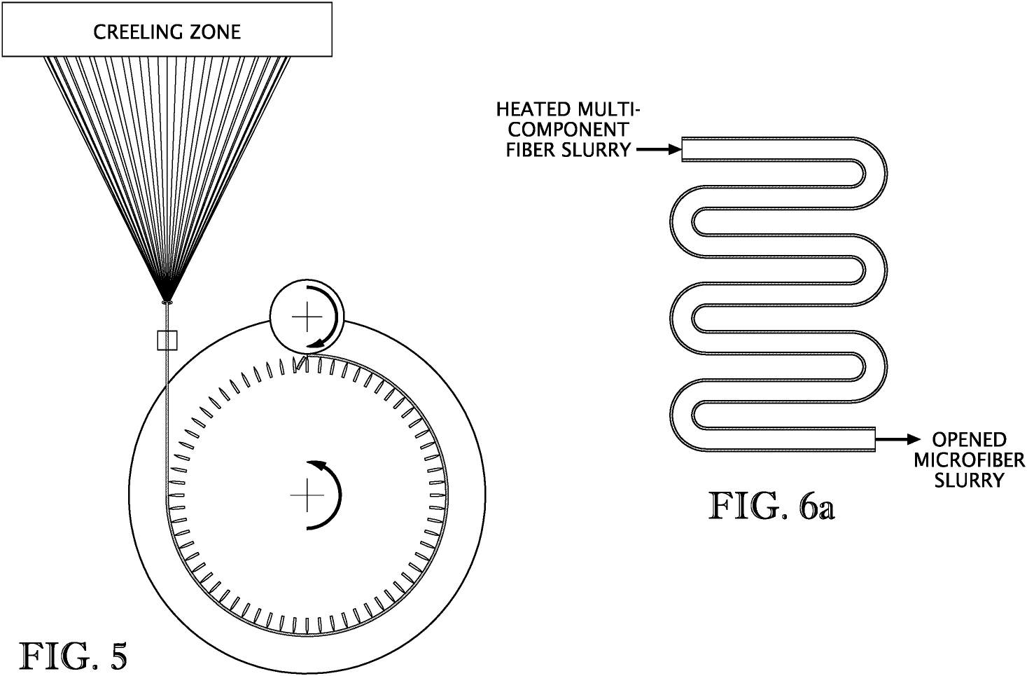

In this embodiment of the invention, fiber slurry zone 200, mix zone 300, and fiber opening zone 400 as shown in FIG. 4 are combined and accomplished in a single unit operation as shown in FIG. 2. In this embodiment, the cut multicomponent fiber stream 101 is routed directly to single unit operation where it mixed with the heated aqueous stream 801 within fiber opening zone 400. For example, a batch mixing device where the opening or washing of the cut multicomponent fibers is accomplished in a single batch mixing device wherein cut multicomponent fiber stream 101 and the heated aqueous stream 801 are added directly to the in the fiber opening zone 400. The fiber opening zone can comprise at least one mix tank. In this embodiment, the combined functions of zones 200, 300 and 400 may be accomplished in a continuous stirred tank reactor as shown in FIGS. 5b and 5c. In this embodiment, the combined functions of zones 200, 300 and 400 may be accomplished in any batch or continuous mixing device capable of achieving the functional requirements of residence time, temperature, and mixing shear forces required for proper function of zones 200, 300, and 400.

Residence time, temperature, and shear forces in the fiber opening zone 400 also influence the extent of separation of the water dispersible sulfopolyester from the cut multicomponent fiber. The conditions influencing the opening process in fiber opening zone 400 comprise residence time, slurry temperature, and shear forces where the ranges of water temperature, residence time in the fiber opening zone 400, and amount of applied shear are dictated by the need to separate the water dispersible sulfopolyester from the starting multicomponent fiber to a sufficient degree to result in water non-dispersible polymer microfibers becoming separated and suspended in the continuous aqueous phase of the opened microfiber slurry 401.

Residence time, temperature, and shear forces in fiber opening zone 400 influence the extent of separation of the water dispersible sulfopolyester from the cut multicomponent fiber. The temperature of the fiber opening zone 400 can range from about 55 degrees centigrade to about 100 degrees centigrade, from about 60 degrees centigrade to about 90 degrees centigrade, or from about 65 degrees centigrade to about 80 degrees centigrade. The residence time in the fiber opening zone 400 can range from about 5 minutes to about 10 seconds, from about 3 minutes to about 20 seconds, or from about 2 minutes to about 30 seconds. Sufficient mixing is maintained in fiber opening zone 400 to maintain a suspension of cut water non-dispersible polymer microfibers such that the settling of the cut microfibers is minimal. In other embodiments of the invention, the mass per unit time of cut water non-dispersible microfibers settling in the fiber opening zone 400 is less than about 5% of the mass per unit time of cut water non-dispersible polymer microfibers entering the zone 400, less than about 3% of the mass per unit time of cut water non-dispersible polymer microfibers entering zone 400, or less than about 1% of the mass per unit time of cut water non-dispersible polymer microfibers entering the fiber opening zone 400.

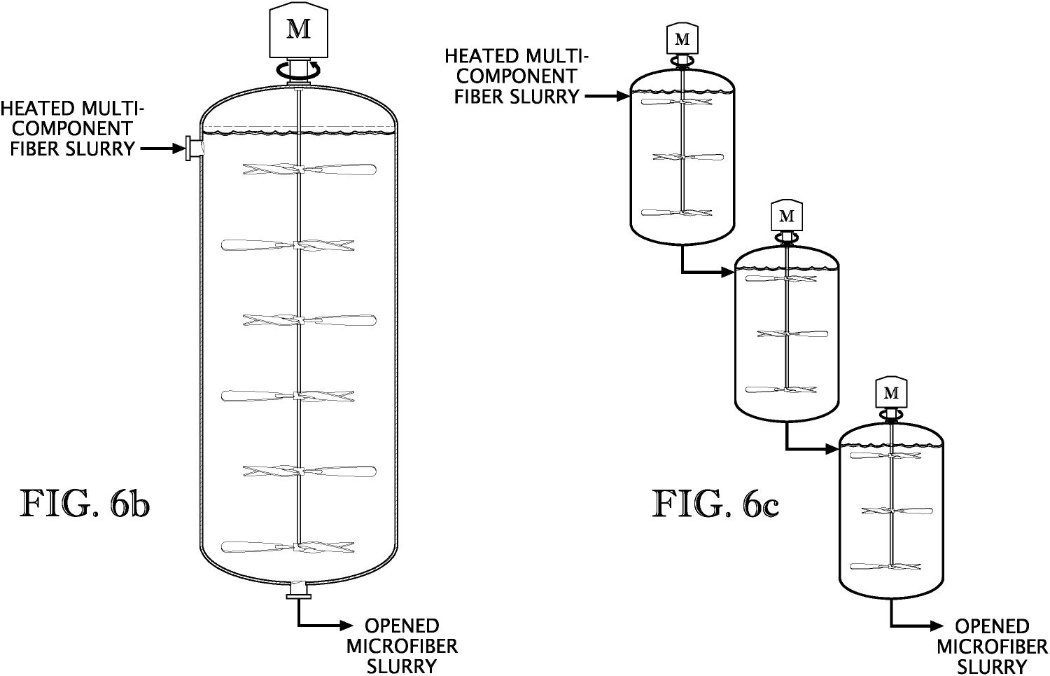

Fiber opening in fiber opening zone 400 may be accomplished in any equipment capable of allowing for acceptable ranges of residence time, temperature, and mixing. Examples of suitable equipment include, but are not limited to, an agitated batch tank, a continuous stirred tank reactor, as shown in FIGS. 6b and 6c, and a pipe with sufficient flow to minimize solids from settling out of the slurry as shown in FIG. 6a. One example of a unit operation to accomplish fiber opening in fiber opening zone 400 is a plug flow reactor where the heated multicomponent fiber slurry 301 is routed to zone 400 plug flow device, typically a circular pipe or conduit. The residence time of material in a plug flow device is calculated by dividing the filled volume within the device by the volumetric flow rate in the device. Velocity of the mass in the device is defined by the cross sectional area of the flow channel divided by the volumetric flow of the liquid through the device.

In other embodiments of the invention, the fiber opening zone 400 can comprise a pipe or conduit wherein the velocity of mass flowing in the pipe can range from 0.1 ft/second to about 20 feet/second, from 0.2 ft/sec to about 10 ft/sec, or from about 0.5 ft/sec to about 5 ft/sec. For flow of a fluid or slurry in a pipe or conduit, the Reynolds number Re is a dimensionless number useful for describing the turbulence or motion of fluid eddy currents that are irregular with respect both to direction and time. For flow in a pipe or tube, the Reynolds number is generally defined as:

$$\text{Re} \text{=} \frac{ρ \text{v} {D}_{H}}{μ} = \frac{\text{v} {D}_{H}}{v} = \frac{\text{Q} {D}_{H}}{v A}$$

Where:
D_{H} is the hydraulic diameter of the pipe; L, (m).
Q is the volumetric flow rate (m³/s).
A is the pipe cross-sectional area (m²).
v is the mean velocity of the object relative to the fluid (Sl units: m/s).
µ is the dynamic viscosity of the fluid (Pa·s or N·s/m² or kg/(m·s)).
v is the kinematic viscosity (v = µ / ρ) (m²/s).
ρ is the density of the fluid (kg/m³).

For flow in a pipe of diameter D, experimental observations show that for fully developed flow, laminar flow occurs when Re_{D} < 2000, and turbulent flow occurs when Re_{D} > 4000. In the interval between 2300 and 4000, laminar and turbulent flows are possible (‘transition’ flows), depending on other factors, such as, pipe roughness and flow uniformity.

Fiber opening zone 400 can comprise a pipe or conduit to facilitate the opening process, and the Reynolds number for flow through the pipe or conduit in fiber opening zone 400 can range from about 2,100 to about 6,000, from about 3,000 to about 6,000, or from about 3,500 to about 6,000. In other embodiments, the fiber opening zone 400 can comprise a pipe or conduit to facilitate the opening process, and the Reynolds number for flow through the pipe or conduit is at least 2,500, at least about 3,500, or at least about 4,000.

Fiber opening zone 400 can be achieved in a pipe or conduit containing a mixing device inserted within the pipe or conduit. The device can comprise an in-line mixing device. The in-line mixing device can be a static mixer with no moving parts. In another embodiment, the in-line mixing device comprises moving parts. Without being limiting, such an element is a mechanical device for the purpose of imparting more mixing energy to the heated multicomponent fiber slurry 301 than achieved by the flow through the pipe. The device can be inserted at the beginning of the pipe section used as the fiber opening zone, at the end of the pipe section, or at any location within the pipe flow path.

The opened fiber slurry stream 401 comprising water non-dispersible polymer microfiber, water, and water dispersible sulfopolyester can be routed to a primary solid liquid separation zone 500 to generate a microfiber product stream 503 comprising microfiber and a first mother liquor stream 501. In one embodiment, the first mother liquor stream 501 comprises water and water dispersible sulfopolyester.

The weight % of solids in the opened microfiber slurry 401 can range from about 0.1 weight % to about 20 weight %, from about 0.3 weight % to about about 10 weight %, from about 0.3 weight % to about 5 weight %, or from about 0.3 weight % to about 2.5 weight %.

The weight % of solids in the microfiber product stream 503 can range from about 10 weight % to about 65 weight %, from about 15 weight % to about 50 weight %, from about 25 weight % to about 45 weight %, or from about 30 weight % to about 40 weight %.

Separation of the microfiber product stream 503 from the opened microfiber slurry 401 can be accomplished by any method known in the art. In one embodiment, wash stream 103 comprising water is routed to the primary solid liquid separation zone 500. Wash stream 103 can be used to wash the microfiber product stream in the primary solid liquid separation zone 500 and/or the filter cloth media in the primary solid liquid separation zone 500 to generate wash liquor stream 502. A portion up to 100 weight % of wash liquor stream 502 can be combined with the opened microfiber slurry 401 prior to entering the primary solid liquid separation zone 500. A portion up to 100 weight % of wash liquor stream 502 can be routed to a second solid liquid separation zone 600. Wash liquor stream 502 can contain microfiber. In one embodiment, the grams of microfiber mass breaking though the filter media with openings up to 2000 microns in the primary solid liquid separation zone 500 ranges from about 1 to 2 grams/cm² of filter area. In other embodiments of the invention, the filter openings in the filter media in the primary solid liquid separation zone 500 can range from about 43 microns to 3000 microns, from about 100 microns to 2000 microns, or from about 500 microns to about 2000 microns.

Separation of the microfiber product stream from the opened microfiber slurry in primary solid liquid separation zone 500 may be accomplished by a single or multiple solid liquid separation devices. Separation in the primary solid liquid separation zone 500 may be accomplished by a solid liquid separation device or devices operated in batch and or continuous fashion. Suitable solid liquid separation devices in the primary solid liquid separation zone 500 can include, but is not limited to, at least one of the following: perforated basket centrifuges, continuous vacuum belt filters, batch vacuum nutschfilters, batch perforated settling tanks, twin wire dewatering devices, continuous horizontal belt filters with a compressive zone, non vibrating inclined screen devices with wedge wire filter media, continuous vacuum drum filters, dewatering conveyor belts, and the like.

In one embodiment, the primary solid liquid separation zone 500 comprises a twin wire dewatering device wherein the opened microfiber sturry 401 is routed to a tapering gap between a pair of traveling filter cloths traveling in the same direction. In the first zone of the twin wire dewatering device, water drains from the opened microfiber slurry 401 due to gravity and the every narrowing gap between the two moving filter cloths. In a downstream zone of the twin wire dewatering device, the two filter cloths and the microfiber mass between the two filter cloths are compressed one or more times to mechanically reduce moisture in the microfiber mass. In one embodiment, mechanical dewatering is accomplished by passing the two filter cloths and contained microfiber mass through at least one set of rollers that exert a compressive force on the two filter cloths and microfiber mass between. In another embodiment, mechanical dewatering is accomplished by passing the two filter cloths and microfiber mass between at least one set of pressure rollers.

In other embodiments of the invention, the force exerted by mechanical dewatering for each set of pressure rollers can range from about 25 to about 300 lbs/linear inch of filter media width, from about 50 to about 200 lbs/linear inch of filter media width, or from about 70 to about 125 lbs/linear inch of filter media width. The microfiber product stream 503 is discharged from the twin wire water dewatering device as the two filter cloths separate and diverge at the solids discharge zone of the device. The thickness of the discharged microfiber mass can range from about 0.2 inches to about 1.5 inches, from about 0.3 inches to about 1.25 inches, or from about 0.4 inches to about 1 inch. In one embodiment, a wash stream comprising water is continuously applied to the filter media. In another embodiment, a wash stream comprising water is periodically applied to the filter media.

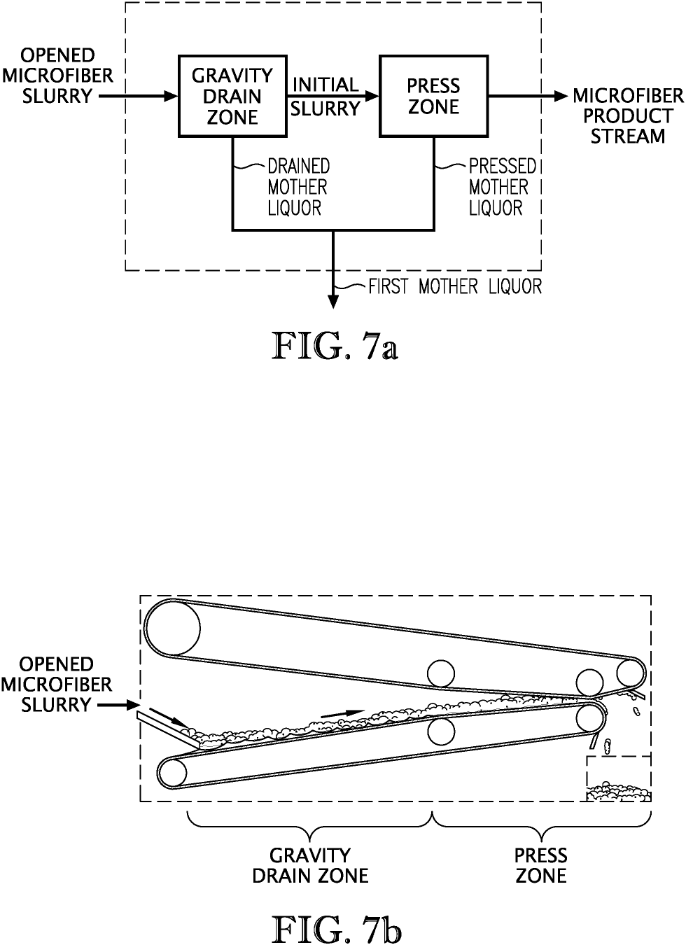

In another embodiment, the primary solid liquid separation zone 500 comprises a belt filter device comprising a gravity drainage zone and a pressure dewatering zone as illustrated in FIG. 7. Opened microfiber slurry 401 is routed to a tapering gap between a pair of moving filter cloths traveling in the same direction which first pass through a gravity drainage zone and then pass through a pressure dewatering zone or press zone comprising a convoluted arrangement of rollers as illustrated in FIG. 6b. As the belts are fed through the rollers, water is squeezed out of the solids. When the belts pass through the final pair of rollers in the process, the filter cloths are separated and the solids exit the belt filter device.

In another embodiment of the invention, at least a portion of the water contained in the first mother liquor stream 501 comprising water and water dispersible sulfopolyester polymer is recovered and recycled. The first mother liquor stream 501 can be recycled to the primary solid liquid separation zone 500. Depending on the efficiency of the primary liquid separation zone in the removal of the water non-dispersible microfiber, the first mother liquid stream 501 can be recycled to the fiber opening zone 400, or the heat exchanger zone 800 prior to being routed to Zone 400. The first mother liquor stream 501 can contain a small amount of solids comprising water non-dispersible polymer microfiber due to breakthrough and cloth wash. In one embodiment, the grams of water non-dispersible polymer microfiber mass breaking though filter media in the primary solid liquid separation zone with openings up to 2000 microns ranges from about 1 to about 2 grams/cm² of filter area. It is desirable to minimize the water non-dispersible polymer microfiber solids in the first mother liquor stream 501 prior to routing stream 501 to the primary concentration zone 700 and heat exchange zone 800 where water non-dispersible polymer microfiber solids can collect and accumulate in the zones having a negative impact on their function.

A secondary solid liquid separation zone 600 can serve to remove at least a portion of water non-dispersible polymer microfiber solids present in the first mother liquor stream 501 to generate a secondary wet cake stream 602 comprising water non-dispersible microfiber and a second mother liquor stream 601 comprising water and water dispersible sulfopolyester.

In one embodiment, the second mother liquor stream 601 can be routed to a primary concentration zone 700 and or heat exchanger zone 800 wherein the weight % of the second mother liquor stream 601 routed to the primary concentration zone 700 can range from 0% to 100% with the balance of the stream being routed to heat exchanger zone 800. The second mother liquor stream 601 can be recycled to the fiber opening zone 400, or the heat exchanger zone 800 prior to being routed to Zone 400. The amount of the water dispersible sulfopolyester in the second mother liquor stream routed to the fiber opening zone 400 can range from about 0.01 weight % to about 7 weight %, based on the weight % of the second mother liquor stream, or from about 0.1 weight % to about 7 weight %, from about 0.2 weight % to about 5 weight %, or from about 0.3 weight % to about 3 weight %.

Any portion of the second mother liquor 601 routed to primary concentration zone is subjected to a separation process to generate a primary recovered water stream 703 and a primary polymer concentrate stream 702 enriched in water dispersible sulfopolyester wherein the weight % of water dispersible sulfopolyester in the primary polymer concentrate stream 702 can range from about 5 weight % to about 85%, from about 10 weight % to about 65 weight %, or from about 15 weight % to about 45 weight %. The primary recovered water stream 703 can be recycled to the fiber opening zone 400, or the heat exchanger zone 800 prior to being routed to Zone 400. The amount of the water dispersible sulfopolyester in the second mother liquor stream routed to the fiber opening zone 400 can range from about 0.01 weight % to about 7 weight %, based on the weight % of the second mother liquor stream, or from about 0.1 weight % to about 7 weight %, from about 0.2 weight % to about 5 weight %, or from about 0.3 weight % to about 3 weight %.

Water can be removed from the second mother liquor stream 601 by any method know in the art in the primary concentration zone 700 to produce the primary polymer concentrate stream 702. In one embodiment, removal of water involves an evaporative process by boiling water away in batch or continuous evaporative equipment. For example, at least one thin film evaporator can be used for this application. In another embodiment, membrane technology comprising nanofiltration media can be used to generate the primary polymer concentrate stream 702. In another embodiment, a process comprising extraction equipment may be used to extract water dispersible polymer from the second mother liquor stream 601 and generate the primary polymer concentrate stream 702. It is understood than any combination of evaporation, membrane, and extraction steps may be used to separate the water dispersible sulfopolyester from the second mother liquor stream 601 and generate the primary polymer concentrate stream 702. The primary polymer concentration stream 702 may then exit the process.

In one embodiment, the primary polymer concentrate stream 702 can be routed to a secondary concentration zone 900 to generate a melted polymer stream 903 comprising water dispersible sulfopolyester wherein the weight % of polymer ranges from about 95% to about 100% and a vapor stream 902 comprising water. In one embodiment, the 903 comprises water dispersible sulfopolyester. Equipment suitable for the secondary concentration zone 900 includes any equipment known in the art capable of being fed an aqueous dispersion of water dispersible polymer and generating a 95% to 100% water dispersible polymer stream 903. This embodiment comprises feeding an aqueous dispersion of water dispersible sulfopolyester polymer to a secondary concentration zone 902. The temperature of feed stream is typically below 100° C.

In one embodiment, the secondary concentration zone 900 comprises at least one device characterized by a jacketed tubular shell containing a rotating convey screw wherein the convey screw is heated with a heat transfer fluid or steam and comprises both convey and high shear mixing elements. The jacket or shell is vented to allow for vapor to escape. The shell jacket may be zoned to allow for different temperature set points along the length of the device. During continuous operation, the primary polymer concentrate stream 702 comprises water and water dispersible sulfopolyester and is continuously fed to the secondary concentration zone 900. Within the device, during steady state, mass exists in at least three distinct and different forms. Mass first exists in the device as an aqueous dispersion of water dispersible sulfopolyester polymer. As the aqueous dispersion of sulfopolyester polymer moves through the device, water is evaporated due to the heat of the jacket and internal screw. When sufficient water is evaporated, the mass becomes a second form comprising a viscous plug at a temperature less than the melt temperature of the sulfopolyester polymer. The aqueous dispersion cannot flow past this viscous plug and is confined to the first aqueous dispersion zone of the device. Due to the heat of the jacket, heat of the internally heated screw, and the heat due to mixing shear forces of this high viscosity plug mass, substantially all the water present at this location evaporates, and the temperature rises until the melt temperature of the sulfopolyester is reached resulting in the third and final physical form of mass in the device comprising melted sulfopolyester polymer. The melted sulfopolyester polymer then exits the device through an extrusion dye and is typically cooled and cut into pellets by any fashion know in the art. It is understood that the device for secondary concentration zone 900 described above may also be operated in batch fashion wherein the three physical forms of mass described above occur throughout the length of the device but at different times in sequential order beginning with the aqueous dispersion, the viscous plug mass, and finally the sulfopolyester melt.

In one embodiment, vapor generated in the secondary concentration zone 900 may be condensed and routed to heat exchanger zone 800, discarded, and/or routed to wash stream 103. In another embodiment, condensed vapor stream 902 comprising water vapor can be routed to heat exchanger zone 800 to provide at least part of the energy required for generating the required temperature for stream 801. The melted polymer stream 903 comprising water dispersible polymer comprising sulfopolyester in the melt phase can be cooled and chopped into pellets by any method known in the art.

Impurities can enter the process and concentrated in water recovered and recycled. One or more purge streams (603 and 701) can be utilized to control the concentration of impurities in the second mother liquor 601 and primary recovered water stream 701 to acceptable levels. In one embodiment, a portion of the second mother liquor stream 601 can be isolated and purged from the process. In one embodiment, a portion of the primary recovered water stream 701 can be isolated and purged from the process.

### Two Step Process to Produce Short-Cut Microfibers

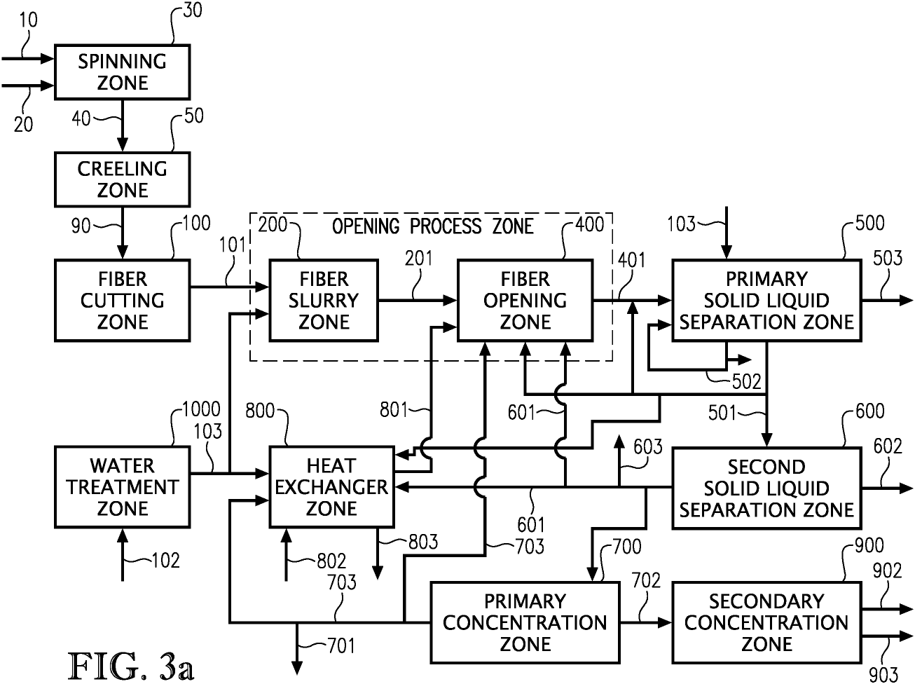

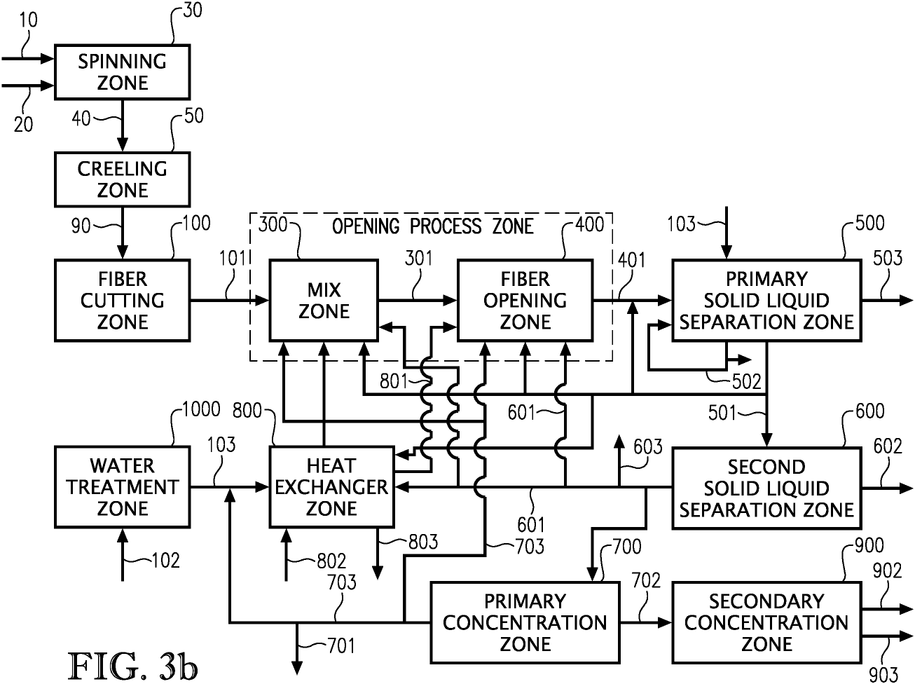

In another embodiment of the invention, as shown in FIG. 3a, a process for producing a microfiber product stream is provided. The process comprises: (A) contacting short cut multicomponent fibers 101 having a length of less than 25 millimeters with a treated aqueous stream 103 in a fiber slurry zone 200 to produce a short cut multicomponent fiber slurry 201; wherein the short cut multicomponent fibers 101 comprise at least one water dispersible sulfopolyester and at least one water non-dispersible synthetic polymer immiscible with the water dispersible sulfopolyester; and wherein the treated aqueous stream 103 is at a temperature of less than 40° C.; wherein the multicomponent fiber comprises at least one water-dispersible sulfopolyester selected from the group consisting of: (1) a sulfopolyester comprising: (a) residues of one or more dicarboxylic acids; (b) at least 4 mole percent and less than 8.5 mole percent of residues of at least one sulfomonomer; and (c) residues of one or more diols, wherein said sulfopolyester comprises a carboxylate ends to acid ends ratio of at least 0.6, wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (2) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends to acid ends ratio of at least 0.35, wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; and (3) a sulfopolyester comprising: (a) residues of one or more dicarboxylic acids; (b) greater than 8.5 mole percent of residues of at least one sulfomonomer; and (c) residues of one or more diols, wherein said sulfopolyester comprises a carboxylate ends content of at least 12 µeq/g, wherein an aqueous dispersion comprising 25 weight percent of said sulfopolyester exhibits a dispersion viscosity of at least 30 cP and less than 100 cP at 22° C., wherein said sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) contacting the short cut multicomponent fiber slurry 201 and a heated aqueous stream 801 in a fiber opening zone 400 to remove a portion of the water dispersible sulfopolyester to produce an opened microfiber slurry 401; wherein the opened microfiber slurry comprises water non-dispersible polymer microfiber, water dispersible sulfopolyester, and water; and (C) routing the opened microfiber slurry 401 to a primary solid liquid separation zone 500 to produce the microfiber product stream 503 and a first mother liquor stream 501; wherein the first mother liquor stream 501 comprises water and the water dispersible sulfopolyester.

In this embodiment of the invention, the mix zone 300 and the fiber opening zone 400 as shown in FIG. 4 have been combined into one unit operation in the opening process zone 1100. The opening process zone 1100 comprises a fiber slurry zone 200 and a fiber opening zone 400.

A treated aqueous stream 103 for use in the process can be produced by routing an aqueous stream 102 to an aqueous treatment zone 1000 to produce a treated aqueous stream 103. The aqueous stream comprises water. In embodiments of the invention, the concentration of monovalent metal cations in the treated aqueous stream 103 can be less than about 1000 ppm by weight, less than about 500 ppm by weight, less than about 100 ppm by weight, or less than about 50 ppm by weight. Removal of divalent and multivalent metal cations from the aqueous stream 102 is one function of the aqueous treatment zone 1000. In other embodiments of the invention, the concentration of divalent and multivalent cations is less than about 50 ppm by weight, less than about 25 ppm by weight, less than about 10 ppm by weight, or less than about 5 ppm by weight. The temperature of stream 103 can range from ground water temperature to about 40° C.

The treatment of the aqueous stream 102 in the aqueous treatment zone 1000 can be accomplished in any way know in the art. In one embodiment, aqueous treatment zone 1000 comprises distillation equipment wherein water vapor is generated and condensed to produce the treated aqueous stream 103. In another embodiment, water is routed to a reverse osmosis membrane separation capable of separating monovalent and divalent metal cations from water to produce the treated aqueous stream 103. In another embodiment, water is routed to an ion exchange resin to generate the treated aqueous stream 103 with acceptably low concentration of metal cations. In yet another embodiment, water can be routed to a commercial water softening apparatus to generate the treated aqueous stream 103 with an acceptably low concentration of divalent and multivalent metal cations. It is understood that any combinations of these water treatment options may be employed to achieve the required treated water characteristics.

The treated aqueous stream 103 may be routed to any location in the process where it is needed. In one embodiment, a portion of stream 103 is routed to a prim ary solid liquid separation zone 500 to serve as a cloth wash and/or a wash for solids contained in the primary solid liquid separation zone 500.

In one embodiment, at least a portion of the treated aqueous stream 103 is routed to heat exchanger zone 800. In another embodiment, at least a portion of treated aqueous stream 103 is routed to a fiber slurry zone 200. In another embodiment, at least a portion of the treated aqueous stream 103 is routed to heat exchanger zone 800 and at least a portion of the treated aqueous stream 103 is routed to the fiber slurry zone 200. One function of heat exchanger zone 800 is to generate a heated aqueous stream 801 at a specific and controlled temperature.

In one embodiment, streams that can feed heat exchanger zone 800 are the treated aqueous stream 103 and the second mother liquor stream 601. In another embodiment, streams that can feed heat exchanger zone 800 comprise the treated aqueous stream 103, the primary recovered water stream 703, the first mother liquor stream 501, and the second mother liquor stream 601.

Any equipment know in the art for controlling the temperature of stream 801 may be used including, but not limited to, any heat exchanger with steam used to provide a portion of the required energy, any heat exchanger with a heat transfer fluid used to provide a portion of the required energy, any heat exchanger with electrical heating elements used to provide a portion of the required energy, and any vessel or tank with direct steam injection wherein the steam condenses and the condensate mixes with the water feeds to heat exchanger zone 800. The multicomponent fiber stream 90 is routed to fiber cutting zone 100 to generate cut multicomponent fiber stream 101. The multicomponent fiber can be of any multicomponent structure known in the art. The multicomponent fiber comprises a water dispersible sulfopolyester and a water non-dispersible polymer as previously discussed in this disclosure.

Any equipment know in the art may be used to cut multicomponent fiber stream 90 to generate cut multicomponent fiber stream 101. In one embodiment, the length of the cut fibers in the cut multicomponent fiber stream 101 is less than about 50 mm. In other embodiments, the length of cut fibers in the cut multicomponent fiber stream 101 is less than about 25 mm, less than about 20 mm, less than about 15 mm, less than about 10 mm, less than about 5 mm, or less than 2.5 mm.

The cut multicomponent fiber stream 101 and a portion of the treated aqueous stream 103 are routed to a fiber slurry zone 200 to generate a cut multicomponent fiber slurry 201 comprising water and cut multicomponent fibers. In one embodiment, the weight % of cut multicomponent fibers in the cut multicomponent fiber slurry 201 can range from about 35 weight % to about 1% weight %, from about 25 weight % to about 1 weight %, from about 15 weight % to about 1 weight %, or from about 7 weight % to about 1 weight %.

The temperature of the cut multicomponent fiber slurry 201 can range from about 5 degrees centigrade to about 45 degrees centigrade, from about 10 degrees centigrade to about 35 degrees centigrade, or from about 10 degrees centigrade to about 25 degrees centigrade. In one embodiment, fiber slurry zone 200 comprises a tank with sufficient agitation to generate a suspension of cut multicomponent fiber in a continuous aqueous phase.

Any equipment known in the art suitable for mixing a solid with water and maintaining the resulting suspension of cut multicomponent fibers in the continuous phase may be used in the fiber slurry zone 200. The fiber slurry zone 200 can comprise batch or continuous mixing devices operated in continuous or batch mode. Suitable devices for use in the fiber slurry zone 200 include, but are not limited to, a hydro-pulper, a continuous stirred tank reactor, a tank with agitation operated in batch mode.

The cut multicomponent fiber slurry 201 can then be routed to a fiber opening zone 400. One function of fiber opening zone 400 is to separate the water dispersible polymer from the cut multicomponent fiber such that at least a portion of the water non-dispersible polymer microfibers separate from the cut multicomponent fiber and become suspended in the opened microfiber slurry 401. In another embodiment of the invention, from about 50 weight % to about 100 weight % of water non-dispersible polymer microfiber contained in the cut multicomponent fiber slurry 201 becomes suspended in the opened microfiber slurry 401 as water non-dispersible polymer microfibers and is no longer a part of the cut multicomponent fiber. In other embodiments, from about 75 weight % to about 100 weight %, from about 90 weight % to about 100 weight %, or from about 95 weight % to about 100 weight % of the water non-dispersible polymer microfiber contained in the cut multicomponent fiber stream 201 becomes suspended in the opened microfiber slurry 401 as water non-dispersible polymer microfibers and are no longer a part of a cut multicomponent fiber.

The diameter or denier of the starting cut multicomponent fiber in stream 201 impacts the extent of separation of the water dispersible sulfopolyester from the cut multicomponent fiber in the fiber opening zone 400. Typical multicomponent fiber types generally have a diameter in the range from about 12 microns to about 20 microns. Useful multicomponent fibers can have larger starting diameters to a size of about 40 microns diameter or more. The time required to separate a desired amount of water dispersible sulfopolyester from the cut multicomponent fiber increases as the diameter of the cut multicomponent fiber in stream 201 increases.

Residence time, temperature, and shear forces in the fiber opening zone 400 also influence the extent of separation of the water dispersible sulfopolyester from the cut multicomponent fiber. The conditions influencing the opening process in fiber opening zone 400 comprise residence time, slurry temperature, and shear forces where the ranges of water temperature, residence time in the fiber opening zone 400, and amount of applied shear are dictated by the need to separate the water dispersible sulfopolyester from the starting multicomponent fiber to a sufficient degree to result in water non-dispersible polymer microfibers becoming separated and suspended in the continuous aqueous phase of the opened microfiber slurry 401.

Residence time, temperature, and shear forces in fiber opening zone 400 influence the extent of separation of the water dispersible sulfopolyester from the cut multicomponent fiber. The temperature of the fiber opening zone 400 can range from about 55 degrees centigrade to about 100 degrees centigrade, from about 60 degrees centigrade to about 90 degrees centigrade, or from about 65 degrees centigrade to about 80 degrees centigrade. The residence time in the fiber opening zone 400 can range from about 5 minutes to about 10 seconds, from about 3 minutes to about 20 seconds, or from about 2 minutes to about 30 seconds. Sufficient mixing is maintained in fiber opening zone 400 to maintain a suspension of cut water non-dispersible polymer microfibers such that the settling of the cut microfibers is minimal. In other embodiments of the invention, the mass per unit time of cut water non-dispersible microfibers settling in the fiber opening zone 400 is less than about 5% of the mass per unit time of cut water non-dispersible polymer microfibers entering the zone 400, less than about 3% of the mass per unit time of cut water non-dispersible polymer microfibers entering zone 400, or less than about 1% of the mass per unit time of cut water non-dispersible polymer microfibers entering the fiber opening zone 400.

Fiber opening in fiber opening zone 400 may be accomplished in any equipment capable of allowing for acceptable ranges of residence time, temperature, and mixing. Examples of suitable equipment include, but are not limited to, an agitated batch tank, a continuous stirred tank reactor, as shown in FIGS. 6b and 6c, and a pipe with sufficient flow to minimize solids from settling out of the slurry as shown in FIG. 6a. One example of a unit operation to accomplish fiber opening in fiber opening zone 400 is a plug flow reactor where the heated multicomponent fiber slurry 301 is routed to zone 400 plug flow device, typically a circular pipe or conduit. The residence time of material in a plug flow device is calculated by dividing the filled volume within the device by the volumetric flow rate in the device. Velocity of the mass in the device is defined by the cross sectional area of the flow channel divided by the volumetric flow of the liquid through the device.

In other embodiments of the invention, the fiber opening zone 400 can comprise a pipe or conduit wherein the velocity of mass flowing in the pipe can range from 0.1 ft/second to about 20 feet/second, from 0.2 ft/sec to about 10 ft/sec, or from about 0.5 ft/sec to about 5 ft/sec. For flow of a fluid or slurry in a pipe or conduit, the Reynolds number Re is a dimensionless number useful for describing the turbulence or motion of fluid eddy currents that are irregular with respect both to direction and time. For flow in a pipe or tube, the Reynolds number is generally defined as:

$$\text{Re} \text{=} \frac{ρ \text{v} {D}_{H}}{μ} = \frac{\text{v} {D}_{H}}{v} = \frac{\text{Q} {D}_{H}}{v A}$$

Where:
D_{H} is the hydraulic diameter of the pipe; L, (m).
Q is the volumetric flow rate (m³/s).
A is the pipe cross-sectional area (m²).
v is the mean velocity of the object relative to the fluid (SI units: m/s).
µ is the dynamic viscosity of the fluid (Pa▪s or N▪s/m² or kg/(m▪s)).
v is the kinematic viscosity (v = µ / ρ) (m²/s).
ρ is the density of the fluid (kg/m³).

For flow in a pipe of diameter D, experimental observations show that for fully developed flow, laminar flow occurs when Re_{D} < 2000, and turbulent flow occurs when Re_{D} > 4000. In the interval between 2300 and 4000, laminar and turbulent flows are possible (‘transition’ flows), depending on other factors, such as, pipe roughness and flow uniformity.

Fiber opening zone 400 can comprise a pipe or conduit to facilitate the opening process, and the Reynolds number for flow through the pipe or conduit in fiber opening zone 400 can range from about 2,100 to about 6,000, from about 3,000 to about 6,000, or from about 3,500 to about 6,000. In other embodiments, the fiber opening zone 400 can comprise a pipe or conduit to facilitate the opening process, and the Reynolds number for flow through the pipe or conduit is at least 2,500, at least about 3,500, or at least about 4,000.

Fiber opening zone 400 can be achieved in a pipe or conduit containing a mixing device inserted within the pipe or conduit. The device can comprise an in-line mixing device. The in-line mixing device can be a static mixer with no moving parts. In another embodiment, the in-line mixing device comprises moving parts. Without being limiting, such an element is a mechanical device for the purpose of imparting more mixing energy to the heated multicomponent fiber slurry 301 than achieved by the flow through the pipe. The device can be inserted at the beginning of the pipe section used as the fiber opening zone, at the end of the pipe section, or at any location within the pipe flow path.

The opened fiber slurry stream 401 comprising water non-dispersible polymer microfiber, water, and water dispersible sulfopolyester can be routed to a primary solid liquid separation zone 500 to generate a microfiber product stream 503 comprising microfiber and a first mother liquor stream 501. In one embodiment, the first mother liquor stream 501 comprises water and water dispersible sulfopolyester.

The weight % of solids in the opened microfiber slurry 401 can range from about 0.1 weight % to about 20 weight %, from about 0.3 weight % to about about 10 weight %, from about 0.3 weight % to about 5 weight %, or from about 0.3 weight % to about 2.5 weight %.

The weight % of solids in the microfiber product stream 503 can range from about 10 weight % to about 65 weight %, from about 15 weight % to about 50 weight %, from about 25 weight % to about 45 weight %, or from about 30 weight % to about 40 weight %.

Separation of the microfiber product stream 503 from the opened microfiber slurry 401 can be accomplished by any method known in the art. In one embodiment, wash stream 103 comprising water is routed to the primary solid liquid separation zone 500. Wash stream 103 can be used to wash the microfiber product stream in the primary solid liquid separation zone 500 and/or the filter cloth media in the primary solid liquid separation zone 500 to generate wash liquor stream 502. A portion up to 100 weight % of wash liquor stream 502 can be combined with the opened microfiber slurry 401 prior to entering the primary solid liquid separation zone 500. A portion up to 100 weight % of wash liquor stream 502 can be routed to a second solid liquid separation zone 600. Wash liquor stream 502 can contain microfiber. In one embodiment, the grams of microfiber mass breaking though the filter media with openings up to 2000 microns in the primary solid liquid separation zone 500 ranges from about 1 to 2 grams/cm² of filter area. In other embodiments of the invention, the filter openings in the filter media in the primary solid liquid separation zone 500 can range from about 43 microns to 3000 microns, from about 100 microns to 2000 microns, or from about 500 microns to about 2000 microns.

Separation of the microfiber product stream from the opened microfiber slurry in primary solid liquid separation zone 500 may be accomplished by a single or multiple solid liquid separation devices. Separation in the primary solid liquid separation zone 500 may be accomplished by a solid liquid separation device or devices operated in batch and or continuous fashion. Suitable solid liquid separation devices in the primary solid liquid separation zone 500 can include, but is not limited to, at least one of the following: perforated basket centrifuges, continuous vacuum belt filters, batch vacuum nutschfilters, batch perforated settling tanks, twin wire dewatering devices, continuous horizontal belt filters with a compressive zone, non vibrating inclined screen devices with wedge wire filter media, continuous vacuum drum filters, dewatering conveyor belts, and the like.

In one embodiment, the primary solid liquid separation zone 500 comprises a twin wire dewatering device wherein the opened microfiber sturry 401 is routed to a tapering gap between a pair of traveling filter cloths traveling in the same direction. In the first zone of the twin wire dewatering device, water drains from the opened microfiber slurry 401 due to gravity and the every narrowing gap between the two moving filter cloths. In a downstream zone of the twin wire dewatering device, the two filter cloths and the microfiber mass between the two filter cloths are compressed one or more times to mechanically reduce moisture in the microfiber mass. In one embodiment, mechanical dewatering is accomplished by passing the two filter cloths and contained microfiber mass through at least one set of rollers that exert a compressive force on the two filter cloths and microfiber mass between. In another embodiment, mechanical dewatering is accomplished by passing the two filter cloths and microfiber mass between at least one set of pressure rollers.

In other embodiments of the invention, the force exerted by mechanical dewatering for each set of pressure rollers can range from about 25 to about 300 lbs/linear inch of filter media width, from about 50 to about 200 lbs/linear inch of filter media width, or from about 70 to about 125 lbs/linear inch of filter media width. The microfiber product stream 503 is discharged from the twin wire water dewatering device as the two filter cloths separate and diverge at the solids discharge zone of the device. The thickness of the discharged microfiber mass can range from about 0.2 inches to about 1.5 inches, from about 0.3 inches to about 1.25 inches, or from about 0.4 inches to about 1 inch. In one embodiment, a wash stream comprising water is continuously applied to the filter media. In another embodiment, a wash stream comprising water is periodically applied to the filter media.

In another embodiment, the primary solid liquid separation zone 500 comprises a belt filter device comprising a gravity drainage zone and a pressure dewatering zone as illustrated in FIG. 7. Opened microfiber slurry 401 is routed to a tapering gap between a pair of moving filter cloths traveling in the same direction which first pass through a gravity drainage zone and then pass through a pressure dewatering zone or press zone comprising a convoluted arrangement of rollers as illustrated in FIG. 6b. As the belts are fed through the rollers, water is squeezed out of the solids. When the belts pass through the final pair of rollers in the process, the filter cloths are separated and the solids exit the belt filter device.

In another embodiment of the invention, at least a portion of the water contained in the first mother liquor stream 501 comprising water and water dispersible sulfopolyester polymer is recovered and recycled. The first mother liquor stream 501 can be recycled to the primary solid liquid separation zone 500. Depending on the efficiency of the primary liquid separation zone in the removal of the water non-dispersible microfiber, the first mother liquid stream 501 can be recycled to the fiber slurry zone 200, the fiber opening zone 400, or the heat exchanger zone 800 prior to being routed to Zones 200 and/or 400. The first mother liquor stream 501 can contain a small amount of solids comprising water non-dispersible polymer microfiber due to breakthrough and cloth wash. In one embodiment, the grams of water non-dispersible polymer microfiber mass breaking though filter media in the primary solid liquid separation zone with openings up to 2000 microns ranges from about 1 to about 2 grams/cm² of filter area. It is desirable to minimize the water non-dispersible polymer microfiber solids in the first mother liquor stream 501 prior to routing stream 501 to the primary concentration zone 700 and heat exchange zone 800 where water non-dispersible polymer microfiber solids can collect and accumulate in the zones having a negative impact on their function.

A secondary solid liquid separation zone 600 can serve to remove at least a portion of water non-dispersible polymer microfiber solids present in the first mother liquor stream 501 to generate a secondary wet cake stream 602 comprising water non-dispersible microfiber and a second mother liquor stream 601 comprising water and water dispersible sulfopolyester.

In one embodiment, the second mother liquor stream 601 can be routed to a primary concentration zone 700 and or heat exchanger zone 800 wherein the weight % of the second mother liquor stream 601 routed to the primary concentration zone 700 can range from 0% to 100% with the balance of the stream being routed to heat exchanger zone 800. The second mother liquor stream 601 can be recycled to the fiber slurry zone 200, the fiber opening zone 400, or the heat exchanger zone 800 prior to being routed to Zones 200 and/or 400. The amount of the water dispersible sulfopolyester in the second mother liquor stream routed to the fiber opening zone 400 can range from about 0.01 weight % to about 7 weight %, based on the weight % of the second mother liquor stream, or from about 0.1 weight % to about 7 weight %, from about 0.2 weight % to about 5 weight %, or from about 0.3 weight % to about 3 weight %.

Any portion of the second mother liquor 601 routed to primary concentration zone is subjected to a separation process to generate a primary recovered water stream 703 and a primary polymer concentrate stream 702 enriched in water dispersible sulfopolyester wherein the weight % of water dispersible sulfopolyester in the primary polymer concentrate stream 702 can range from about 5 weight % to about 85%, from about 10 weight % to about 65 weight %, or from about 15 weight % to about 45 weight %. The primary recovered water stream 703 can be recycled to the fiber slurry zone 200, the fiber opening zone 400, or the heat exchanger zone 800 prior to being routed to Zones 200 and/or 400. The amount of the water dispersible sulfopolyester in the second mother liquor stream routed to the fiber opening zone 400 can range from about 0.01 weight % to about 7 weight %, based on the weight % of the second mother liquor stream, or from about 0.1 weight % to about 7 weight %, from about 0.2 weight % to about 5 weight %, or from about 0.3 weight % to about 3 weight %.

Water can be removed from the second mother liquor stream 601 by any method know in the art in the primary concentration zone 700 to produce the primary polymer concentrate stream 702. In one embodiment, removal of water involves an evaporative process by boiling water away in batch or continuous evaporative equipment. For example, at least one thin film evaporator can be used for this application. In another embodiment, membrane technology comprising nanofiltration media can be used to generate the primary polymer concentrate stream 702. In another embodiment, a process comprising extraction equipment may be used to extract water dispersible polymer from the second mother liquor stream 601 and generate the primary polymer concentrate stream 702. It is understood than any combination of evaporation, membrane, and extraction steps may be used to separate the water dispersible sulfopolyester from the second mother liquor stream 601 and generate the primary polymer concentrate stream 702. The primary polymer concentration stream 702 may then exit the process.

In one embodiment, the primary polymer concentrate stream 702 can be routed to a secondary concentration zone 900 to generate a melted polymer stream 903 comprising water dispersible sulfopolyester wherein the weight % of polymer ranges from about 95% to about 100% and a vapor stream 902 comprising water. In one embodiment, the 903 comprises water dispersible sulfopolyester. Equipment suitable for the secondary concentration zone 900 includes any equipment known in the art capable of being fed an aqueous dispersion of water dispersible polymer and generating a 95% to 100% water dispersible polymer stream 903. This embodiment comprises feeding an aqueous dispersion of water dispersible sulfopolyester polymer to a secondary concentration zone 902. The temperature of feed stream is typically below 100° C.

In one embodiment, the secondary concentration zone 900 comprises at least one device characterized by a jacketed tubular shell containing a rotating convey screw wherein the convey screw is heated with a heat transfer fluid or steam and comprises both convey and high shear mixing elements. The jacket or shell is vented to allow for vapor to escape. The shell jacket may be zoned to allow for different temperature set points along the length of the device. During continuous operation, the primary polymer concentrate stream 702 comprises water and water dispersible sulfopolyester and is continuously fed to the secondary concentration zone 900. Within the device, during steady state, mass exists in at least three distinct and different forms. Mass first exists in the device as an aqueous dispersion of water dispersible sulfopolyester polymer. As the aqueous dispersion of sulfopolyester polymer moves through the device, water is evaporated due to the heat of the jacket and internal screw. When sufficient water is evaporated, the mass becomes a second form comprising a viscous plug at a temperature less than the melt temperature of the sulfopolyester polymer. The aqueous dispersion cannot flow past this viscous plug and is confined to the first aqueous dispersion zone of the device. Due to the heat of the jacket, heat of the internally heated screw, and the heat due to mixing shear forces of this high viscosity plug mass, substantially all the water present at this location evaporates, and the temperature rises until the melt temperature of the sulfopolyester is reached resulting in the third and final physical form of mass in the device comprising melted sulfopolyester polymer. The melted sulfopolyester polymer then exits the device through an extrusion dye and is typically cooled and cut into pellets by any fashion know in the art. It is understood that the device for secondary concentration zone 900 described above may also be operated in batch fashion wherein the three physical forms of mass described above occur throughout the length of the device but at different times in sequential order beginning with the aqueous dispersion, the viscous plug mass, and finally the sulfopolyester melt.

In one embodiment, vapor generated in the secondary concentration zone 900 may be condensed and routed to heat exchanger zone 800, discarded, and/or routed to wash stream 103. In another embodiment, condensed vapor stream 902 comprising water vapor can be routed to heat exchanger zone 800 to provide at least part of the energy required for generating the required temperature for stream 801. The melted polymer stream 903 comprising water dispersible polymer comprising sulfopolyester in the melt phase can be cooled and chopped into pellets by any method known in the art.

Impurities can enter the process and concentrated in water recovered and recycled. One or more purge streams (603 and 701) can be utilized to control the concentration of impurities in the second mother liquor 601 and primary recovered water stream 701 to acceptable levels. In one embodiment, a portion of the second mother liquor stream 601 can be isolated and purged from the process. In one embodiment, a portion of the primary recovered water stream 701 can be isolated and purged from the process.

In another embodiment of the invention, as shown in FIG. 3b, a process for producing a microfiber product stream is provided. The process comprises:

(A) contacting short cut multicomponent fibers 101 having a length of less than 25 millimeters with a heated aqueous stream 801 in a mix zone to produce a short cut multicomponent fiber slurry 301; wherein the short cut multicomponent fibers 101 comprise at least one water dispersible sulfopolyester and at least one water non-dispersible polymer immiscible with the water dispersible sulfopolyester; and wherein the heated aqueous stream 801 is at a temperature of 40° C. or greater; wherein the short cut multicomponent fiber comprises at least one water-dispersible sulfopolyester selected from the group consisting of: (i) a sulfopolyester comprising: (a) residues of one or more dicarboxylic acids, (b) at least 10 mole percent of residues of at least one sulfomonomer, (c) residues of two or more diols, wherein said diols comprise ethylene glycol and diethylene glycol, wherein said sulfopolyester exhibits a glass transition temperature of at least 58° C., wherein said sulfopolyester comprises a diethylene glycol to ethylene glycol molar ratio of less than 0.65, wherein said sulfopolyester contains substantially equimolar proportions of acid moiety repeating units (100 mole percent) to hydroxy moiety repeating units (100 mole percent), wherein all stated mole percentages are based on the total of all acid and hydroxy moiety repeating units being equal to 200 mole percent; and (ii) a sulfpolyester comprising: (a) residues of isophthalic acid, (b) residues of terephthalic acid, (c) residues of at least one sulfomonomer, (d) residues of ethylene glycol, (e) residues of diethylene glycol, wherein said amorphous sulfopolyester exhibits a glass transition temperature of at least 58° C., wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) routing the short cut multicomponent fiber slurry 301 and optionally, a heated aqueous stream 801, to a fiber opening zone 400 to remove a portion of the water dispersible sulfopolyester to produce an opened microfiber slurry 401; wherein the opened microfiber slurry 401 comprises water non-dispersible polymer microfiber, water dispersible sulfopolyester, and water; and (C) routing the opened microfiber slurry 401 to a primary solid liquid separation zone 500 to produce the microfiber product stream 503 and a first mother liquor stream 501; wherein the first mother liquor stream 501 comprises water and the water dispersible sulfopolyester.

In this embodiment of the invention as shown in FIG. 3b, the fiber slurry zone 200 and the fiber mix zone 300 have been combined into one unit operation in the opening process zone 1100. The opening process zone 1100 comprises a mix zone 200 and a fiber opening zone 400.

A treated aqueous stream 103 for use in the process can be produced by routing an aqueous stream 102 to an aqueous treatment zone 1000 to produce a treated aqueous stream 103. The aqueous stream comprises water. In embodiments of the invention, the concentration of monovalent metal cations in the treated aqueous stream 103 can be less than about 1000 ppm by weight, less than about 500 ppm by weight, less than about 100 ppm by weight, or less than about 50 ppm by weight. Removal of divalent and multivalent metal cations from the aqueous stream 102 is one function of the aqueous treatment zone 1000. In other embodiments of the invention, the concentration of divalent and multivalent cations is less than about 50 ppm by weight, less than about 25 ppm by weight, less than about 10 ppm by weight, or less than about 5 ppm by weight. The temperature of stream 103 can range from ground water temperature to about 40° C.

The treatment of the aqueous stream 102 in the aqueous treatment zone 1000 can be accomplished in any way know in the art. In one embodiment, aqueous treatment zone 1000 comprises distillation equipment wherein water vapor is generated and condensed to produce the treated aqueous stream 103. In another embodiment, water is routed to a reverse osmosis membrane separation capable of separating monovalent and divalent metal cations from water to produce the treated aqueous stream 103. In another embodiment, water is routed to an ion exchange resin to generate the treated aqueous stream 103 with acceptably low concentration of metal cations. In yet another embodiment, water can be routed to a commercial water softening apparatus to generate the treated aqueous stream 103 with an acceptably low concentration of divalent and multivalent metal cations. It is understood that any combinations of these water treatment options may be employed to achieve the required treated water characteristics.

The treated aqueous stream 103 may be routed to any location in the process where it is needed. In one embodiment, a portion of stream 103 is routed to a primary solid liquid separation zone 500 to serve as a cloth wash and/or a wash for solids contained in the primary solid liquid separation zone 500.

In one embodiment, at least a portion of the treated aqueous stream 103 is routed to heat exchanger zone 800. In another embodiment, at least a portion of treated aqueous stream 103 is routed to a mix zone 300. In another embodiment, at least a portion of the treated aqueous stream 103 is routed to heat exchanger zone 800 and at least a portion of the treated aqueous stream 103 is routed to the mix zone 300. One function of heat exchanger zone 800 is to generate a heated aqueous stream 801 at a specific and controlled temperature.

In one embodiment, streams that can feed heat exchanger zone 800 are the treated aqueous stream 103 and the second mother liquor stream 601. In another embodiment, streams that can feed heat exchanger zone 800 comprise the treated aqueous stream 103, the primary recovered water stream 703, the first mother liquor stream 501, and the second mother liquor stream 601.

Any equipment know in the art for controlling the temperature of stream 801 may be used including, but not limited to, any heat exchanger with steam used to provide a portion of the required energy, any heat exchanger with a heat transfer fluid used to provide a portion of the required energy, any heat exchanger with electrical heating elements used to provide a portion of the required energy, and any vessel or tank with direct steam injection wherein the steam condenses and the condensate mixes with the water feeds to heat exchanger zone 800. The multicomponent fiber stream 90 is routed to fiber cutting zone 100 to generate cut multicomponent fiber stream 101. The multicomponent fiber can be of any multicomponent structure known in the art. The multicomponent fiber comprises a water dispersible sulfopolyester and a water non-dispersible polymer as previously discussed in this disclosure.

Any equipment know in the art may be used to cut multicomponent fiber stream 90 to generate cut multicomponent fiber stream 101. In one embodiment, the length of the cut fibers in the cut multicomponent fiber stream 101 is less than about 50 mm. In other embodiments, the length of cut fibers in the cut multicomponent fiber stream 101 is less than about 25 mm, less than about 20 mm, less than about 15 mm, less than about 10 mm, less than about 5 mm, or less than 2.5 mm.

The cut multicomponent fiber stream 101 and a portion of the heated aqueous stream 801 are routed to a mix zone 300 to generate a heated multicomponent fiber slurry 301 comprising water and cut multicomponent fibers

The temperature of the heated multicomponent fiber slurry 301 influences the separation of the water dispersible sulfopolyester portion of the cut multicomponent fiber from the water non-dispersible polymer portion of the cut multicomponent fiber in fiber opening zone 400. In other embodiments of the invention, the temperature of the heated multicomponent fiber slurry 301 can range from about 55 degrees centigrade to about 100 degrees centigrade, from about 60 degrees centigrade to about 90 degrees centigrade, or from about 65 degrees centigrade to about 80 degrees centigrade.

The weight % of cut multicomponent fiber in the heated multicomponent fiber slurry 301 can be controlled. In other embodiments, the weight % of cut multicomponent fibers in the heated multicomponent fiber slurry 301 can range from about 10 weight % % to about 0.1% weight %, from about 5 weight % to about 0.2 weight %, from about 3 weight % to about 0.3 weight %, or from about 2 weight % to about 0.4 weight %.

Any device known in the art capable of mixing the heated aqueous stream 801 with the cut multicomponent fibers 101 may be used in mix zone 300. Suitable devices include both continuous and batch mixing devices. In one embodiment, a suitable mixing device for mix zone 300 comprises a tank and an agitator. In another embodiment, a suitable mixing device comprises a pipe or conduit.

In other embodiments, a suitable mixing device in mix zone 300 comprises a pipe or conduit with a diameter such that the speed in the conduit is sufficient to mix the cut multicomponent fiber slurry 201 and the heated aqueous stream 801 wherein less than about 2 weight %, less than about 1 weight %, or less than about 0.5 weight of cut multicomponent mass entering the conduit per minute settles out and accumulates in the conduit.

The heated multicomponent fiber slurry 301 can then be routed to a fiber opening zone 400. One function of fiber opening zone 400 is to separate the water dispersible polymer from the cut multicomponent fiber such that at least a portion of the water non-dispersible polymer microfibers separate from the cut multicomponent fiber and become suspended in the opened microfiber slurry 401. In another embodiment of the invention, from about 50 weight % to about 100 weight % of water non-dispersible polymer microfiber contained in the cut multicomponent fiber slurry 201 becomes suspended in the opened microfiber slurry 401 as water non-dispersible polymer microfibers and is no longer a part of the cut multicomponent fiber. In other embodiments, from about 75 weight % to about 100 weight %, from about 90 weight % to about 100 weight %, or from about 95 weight % to about 100 weight % of the water non-dispersible polymer microfiber contained in the cut multicomponent fiber stream 201 becomes suspended in the opened microfiber slurry 401 as water non-dispersible polymer microfibers and are no longer a part of a cut multicomponent fiber.

The diameter or denier of the starting cut multicomponent fiber in stream 201 impacts the extent of separation of the water dispersible sulfopolyester from the cut multicomponent fiber in the fiber opening zone 400. Typical multicomponent fiber types generally have a diameter in the range from about 12 microns to about 20 microns. Useful multicomponent fibers can have larger starting diameters to a size of about 40 microns diameter or more. The time required to separate a desired amount of water dispersible sulfopolyester from the cut multicomponent fiber increases as the diameter of the cut multicomponent fiber in stream 201 increases.

Residence time, temperature, and shear forces in the fiber opening zone 400 also influence the extent of separation of the water dispersible sulfopolyester from the cut multicomponent fiber. The conditions influencing the opening process in fiber opening zone 400 comprise residence time, slurry temperature, and shear forces where the ranges of water temperature, residence time in the fiber opening zone 400, and amount of applied shear are dictated by the need to separate the water dispersible sulfopolyester from the starting multicomponent fiber to a sufficient degree to result in water non-dispersible polymer microfibers becoming separated and suspended in the continuous aqueous phase of the opened microfiber slurry 401.

Residence time, temperature, and shear forces in fiber opening zone 400 influence the extent of separation of the water dispersible sulfopolyester from the cut multicomponent fiber. The temperature of the fiber opening zone 400 can range from about 55 degrees centigrade to about 100 degrees centigrade, from about 60 degrees centigrade to about 90 degrees centigrade, or from about 65 degrees centigrade to about 80 degrees centigrade. The residence time in the fiber opening zone 400 can range from about 5 minutes to about 10 seconds, from about 3 minutes to about 20 seconds, or from about 2 minutes to about 30 seconds. Sufficient mixing is maintained in fiber opening zone 400 to maintain a suspension of cut water non-dispersible polymer microfibers such that the settling of the cut microfibers is minimal. In other embodiments of the invention, the mass per unit time of cut water non-dispersible microfibers settling in the fiber opening zone 400 is less than about 5% of the mass per unit time of cut water non-dispersible polymer microfibers entering the zone 400, less than about 3% of the mass per unit time of cut water non-dispersible polymer microfibers entering zone 400, or less than about 1% of the mass per unit time of cut water non-dispersible polymer microfibers entering the fiber opening zone 400.

Fiber opening in fiber opening zone 400 may be accomplished in any equipment capable of allowing for acceptable ranges of residence time, temperature, and mixing. Examples of suitable equipment include, but are not limited to, an agitated batch tank, a continuous stirred tank reactor, as shown in FIGS. 6b and 6c, and a pipe with sufficient flow to minimize solids from settling out of the slurry as shown in FIG. 6a. One example of a unit operation to accomplish fiber opening in fiber opening zone 400 is a plug flow reactor where the heated multicomponent fiber slurry 301 is routed to zone 400 plug flow device, typically a circular pipe or conduit. The residence time of material in a plug flow device is calculated by dividing the filled volume within the device by the volumetric flow rate in the device. Velocity of the mass in the device is defined by the cross sectional area of the flow channel divided by the volumetric flow of the liquid through the device.

In other embodiments of the invention, the fiber opening zone 400 can comprise a pipe or conduit wherein the velocity of mass flowing in the pipe can range from 0.1 ft/second to about 20 feet/second, from 0.2 ft/sec to about 10 ft/sec, or from about 0.5 ft/sec to about 5 ft/sec. For flow of a fluid or slurry in a pipe or conduit, the Reynolds number Re is a dimensionless number useful for describing the turbulence or motion of fluid eddy currents that are irregular with respect both to direction and time. For flow in a pipe or tube, the Reynolds number is generally defined as:

$$\text{Re} \text{=} \frac{ρ \text{v} {D}_{H}}{μ} = \frac{\text{v} {D}_{H}}{v} = \frac{\text{Q} {D}_{H}}{v A}$$

Where:
D_{H} is the hydraulic diameter of the pipe; L, (m).
Q is the volumetric flow rate (m³/s).
A is the pipe cross-sectional area (m²).
v is the mean velocity of the object relative to the fluid (SI units: m/s).
µ is the dynamic viscosity of the fluid (Pa▪s or N▪s/m² or kg/(m▪s)).
v is the kinematic viscosity (v = µ / ρ) (m²/s).
ρ is the density of the fluid (kg/m³).

For flow in a pipe of diameter D, experimental observations show that for fully developed flow, laminar flow occurs when Re_{D} < 2000, and turbulent flow occurs when Re_{D} > 4000. In the interval between 2300 and 4000, laminar and turbulent flows are possible (‘transition’ flows), depending on other factors, such as, pipe roughness and flow uniformity.

Fiber opening zone 400 can comprise a pipe or conduit to facilitate the opening process, and the Reynolds number for flow through the pipe or conduit in fiber opening zone 400 can range from about 2,100 to about 6,000, from about 3,000 to about 6,000, or from about 3,500 to about 6,000. In other embodiments, the fiber opening zone 400 can comprise a pipe or conduit to facilitate the opening process, and the Reynolds number for flow through the pipe or conduit is at least 2,500, at least about 3,500, or at least about 4,000.

Fiber opening zone 400 can be achieved in a pipe or conduit containing a mixing device inserted within the pipe or conduit. The device can comprise an in-line mixing device. The in-line mixing device can be a static mixer with no moving parts. In another embodiment, the in-line mixing device comprises moving parts. Without being limiting, such an element is a mechanical device for the purpose of imparting more mixing energy to the heated multicomponent fiber slurry 301 than achieved by the flow through the pipe. The device can be inserted at the beginning of the pipe section used as the fiber opening zone, at the end of the pipe section, or at any location within the pipe flow path.

The opened fiber slurry stream 401 comprising water non-dispersible polymer microfiber, water, and water dispersible sulfopolyester can be routed to a primary solid liquid separation zone 500 to generate a microfiber product stream 503 comprising microfiber and a first mother liquor stream 501. In one embodiment, the first mother liquor stream 501 comprises water and water dispersible sulfopolyester.

The weight % of solids in the opened microfiber slurry 401 can range from about 0.1 weight % to about 20 weight %, from about 0.3 weight % to about about 10 weight %, from about 0.3 weight % to about 5 weight %, or from about 0.3 weight % to about 2.5 weight %.

The weight % of solids in the microfiber product stream 503 can range from about 10 weight % to about 65 weight %, from about 15 weight % to about 50 weight %, from about 25 weight % to about 45 weight %, or from about 30 weight % to about 40 weight %.

Separation of the microfiber product stream 503 from the opened microfiber slurry 401 can be accomplished by any method known in the art. In one embodiment, wash stream 103 comprising water is routed to the primary solid liquid separation zone 500. Wash stream 103 can be used to wash the microfiber product stream in the primary solid liquid separation zone 500 and/or the filter cloth media in the primary solid liquid separation zone 500 to generate wash liquor stream 502. A portion up to 100 weight % of wash liquor stream 502 can be combined with the opened microfiber slurry 401 prior to entering the primary solid liquid separation zone 500. A portion up to 100 weight % of wash liquor stream 502 can be routed to a second solid liquid separation zone 600. Wash liquor stream 502 can contain microfiber. In one embodiment, the grams of microfiber mass breaking though the filter media with openings up to 2000 microns in the primary solid liquid separation zone 500 ranges from about 1 to 2 grams/cm² of filter area. In other embodiments of the invention, the filter openings in the filter media in the primary solid liquid separation zone 500 can range from about 43 microns to 3000 microns, from about 100 microns to 2000 microns, or from about 500 microns to about 2000 microns.

Separation of the microfiber product stream from the opened microfiber slurry in primary solid liquid separation zone 500 may be accomplished by a single or multiple solid liquid separation devices. Separation in the primary solid liquid separation zone 500 may be accomplished by a solid liquid separation device or devices operated in batch and or continuous fashion. Suitable solid liquid separation devices in the primary solid liquid separation zone 500 can include, but is not limited to, at least one of the following: perforated basket centrifuges, continuous vacuum belt filters, batch vacuum nutschfilters, batch perforated settling tanks, twin wire dewatering devices, continuous horizontal belt filters with a compressive zone, non vibrating inclined screen devices with wedge wire filter media, continuous vacuum drum filters, dewatering conveyor belts, and the like.

In one embodiment, the primary solid liquid separation zone 500 comprises a twin wire dewatering device wherein the opened microfiber sturry 401 is routed to a tapering gap between a pair of traveling filter cloths traveling in the same direction. In the first zone of the twin wire dewatering device, water drains from the opened microfiber slurry 401 due to gravity and the every narrowing gap between the two moving filter cloths. In a downstream zone of the twin wire dewatering device, the two filter cloths and the microfiber mass between the two filter cloths are compressed one or more times to mechanically reduce moisture in the microfiber mass. In one embodiment, mechanical dewatering is accomplished by passing the two filter cloths and contained microfiber mass through at least one set of rollers that exert a compressive force on the two filter cloths and microfiber mass between. In another embodiment, mechanical dewatering is accomplished by passing the two filter cloths and microfiber mass between at least one pressure roller and a fixed surface.

In other embodiments of the invention, the force exerted by mechanical dewatering can range from about 25 to about 300 lbs/linear inch of filter media width, from about 50 to about 200 lbs/linear inch of filter media width, or from about 70 to about 125 lbs/linear inch of filter media width. The microfiber product stream 503 is discharged from the twin wire water dewatering device as the two filter cloths separate and diverge at the solids discharge zone of the device. The thickness of the discharged microfiber mass can range from about 0.2 inches to about 1.5 inches, from about 0.3 inches to about 1.25 inches, or from about 0.4 inches to about 1 inch. In one embodiment, a wash stream comprising water is continuously applied to the filter media. In another embodiment, a wash stream comprising water is periodically applied to the filter media.

In another embodiment, the primary solid liquid separation zone 500 comprises a belt filter device comprising a gravity drainage zone and a pressure dewatering zone as illustrated in FIG. 7. Opened microfiber slurry 401 is routed to a tapering gap between a pair of moving filter cloths traveling in the same direction which first pass through a gravity drainage zone and then pass through a pressure dewatering zone or press zone comprising a convoluted arrangement of rollers as illustrated in FIG. 6b. As the belts are fed through the rollers, water is squeezed out of the solids. When the belts pass through the final pair of rollers in the process, the filter cloths are separated and the solids exit the belt filter device.

In another embodiment of the invention, at least a portion of the water contained in the first mother liquor stream 501 comprising water and water dispersible sulfopolyester polymer is recovered and recycled. The first mother liquor stream 501 can be recycled to the primary solid liquid separation zone 500. Depending on the efficiency of the primary liquid separation zone in the removal of the water non-dispersible microfiber, the first mother liquid stream 501 can be recycled to the mix zone 300, the fiber opening zone 400, or the heat exchanger zone 800 prior to being routed to Zones 200, 300 and/or 400. The first mother liquor stream 501 can contain a small amount of solids comprising water non-dispersible polymer microfiber due to breakthrough and cloth wash. In one embodiment, the grams of water non-dispersible polymer microfiber mass breaking though filter media in the primary solid liquid separation zone with openings up to 2000 microns ranges from about 1 to about 2 grams/cm² of filter area. It is desirable to minimize the water non-dispersible polymer microfiber solids in the first mother liquor stream 501 prior to routing stream 501 to the primary concentration zone 700 and heat exchange zone 800 where water non-dispersible polymer microfiber solids can collect and accumulate in the zones having a negative impact on their function.

A secondary solid liquid separation zone 600 can serve to remove at least a portion of water non-dispersible polymer microfiber solids present in the first mother liquor stream 501 to generate a secondary wet cake stream 602 comprising water non-dispersible microfiber and a second mother liquor stream 601 comprising water and water dispersible sulfopolyester.

In one embodiment, the second mother liquor stream 601 can be routed to a primary concentration zone 700 and or heat exchanger zone 800 wherein the weight % of the second mother liquor stream 601 routed to the primary concentration zone 700 can range from 0% to 100% with the balance of the stream being routed to heat exchanger zone 800. The second mother liquor stream 601 can be recycled to the fiber slurry zone 200, the mix zone 300, the fiber opening zone 400, or the heat exchanger zone 800 prior to being routed to Zones 200, 300 and/or 400. The amount of the water dispersible sulfopolyester in the second mother liquor stream routed to the fiber opening zone 400 can range from about 0.01 weight % to about 7 weight %, based on the weight % of the second mother liquor stream, or from about 0.1 weight % to about 7 weight %, from about 0.2 weight % to about 5 weight %, or from about 0.3 weight % to about 3 weight %.

Any portion of the second mother liquor 601 routed to primary concentration zone is subjected to a separation process to generate a primary recovered water stream 703 and a primary polymer concentrate stream 702 enriched in water dispersible sulfopolyester wherein the weight % of water dispersible sulfopolyester in the primary polymer concentrate stream 702 can range from about 5 weight % to about 85%, from about 10 weight % to about 65 weight %, or from about 15 weight % to about 45 weight %. The primary recovered water stream 703 can be the mix zone 300, the fiber opening zone 400, or the heat exchanger zone 800 prior to being routed to Zones 200, 300 and/or 400. The amount of the water dispersible sulfopolyester in the second mother liquor stream routed to the fiber opening zone 400 can range from about 0.01 weight % to about 7 weight %, based on the weight % of the second mother liquor stream, or from about 0.1 weight % to about 7 weight %, from about 0.2 weight % to about 5 weight %, or from about 0.3 weight % to about 3 weight %.

Water can be removed from the second mother liquor stream 601 by any method know in the art in the primary concentration zone 700 to produce the primary polymer concentrate stream 702. In one embodiment, removal of water involves an evaporative process by boiling water away in batch or continuous evaporative equipment. For example, at least one thin film evaporator can be used for this application. In another embodiment, membrane technology comprising nanofiltration media can be used to generate the primary polymer concentrate stream 702. In another embodiment, a process comprising extraction equipment may be used to extract water dispersible polymer from the second mother liquor stream 601 and generate the primary polymer concentrate stream 702. It is understood than any combination of evaporation, membrane, and extraction steps may be used to separate the water dispersible sulfopolyester from the second mother liquor stream 601 and generate the primary polymer concentrate stream 702. The primary polymer concentration stream 702 may then exit the process.

In one embodiment, the primary polymer concentrate stream 702 can be routed to a secondary concentration zone 900 to generate a melted polymer stream 903 comprising water dispersible sulfopolyester wherein the weight % of polymer ranges from about 95% to about 100% and a vapor stream 902 comprising water. In one embodiment, the 903 comprises water dispersible sulfopolyester. Equipment suitable for the secondary concentration zone 900 includes any equipment known in the art capable of being fed an aqueous dispersion of water dispersible polymer and generating a 95% to 100% water dispersible polymer stream 903. This embodiment comprises feeding an aqueous dispersion of water dispersible sulfopolyester polymer to a secondary concentration zone 902. The temperature of feed stream is typically below 100° C.

In one embodiment, the secondary concentration zone 900 comprises at least one device characterized by a jacketed tubular shell containing a rotating convey screw wherein the convey screw is heated with a heat transfer fluid or steam and comprises both convey and high shear mixing elements. The jacket or shell is vented to allow for vapor to escape. The shell jacket may be zoned to allow for different temperature set points along the length of the device. During continuous operation, the primary polymer concentrate stream 702 comprises water and water dispersible sulfopolyester and is continuously fed to the secondary concentration zone 900. Within the device, during steady state, mass exists in at least three distinct and different forms. Mass first exists in the device as an aqueous dispersion of water dispersible sulfopolyester polymer. As the aqueous dispersion of sulfopolyester polymer moves through the device, water is evaporated due to the heat of the jacket and internal screw. When sufficient water is evaporated, the mass becomes a second form comprising a viscous plug at a temperature less than the melt temperature of the sulfopolyester polymer. The aqueous dispersion cannot flow past this viscous plug and is confined to the first aqueous dispersion zone of the device. Due to the heat of the jacket, heat of the internally heated screw, and the heat due to mixing shear forces of this high viscosity plug mass, substantially all the water present at this location evaporates, and the temperature rises until the melt temperature of the sulfopolyester is reached resulting in the third and final physical form of mass in the device comprising melted sulfopolyester polymer. The melted sulfopolyester polymer then exits the device through an extrusion dye and is typically cooled and cut into pellets by any fashion know in the art. It is understood that the device for secondary concentration zone 900 described above may also be operated in batch fashion wherein the three physical forms of mass described above occur throughout the length of the device but at different times in sequential order beginning with the aqueous dispersion, the viscous plug mass, and finally the sulfopolyester melt.

In one embodiment, vapor generated in the secondary concentration zone 900 may be condensed and routed to heat exchanger zone 800, discarded, and/or routed to wash stream 103. In another embodiment, condensed vapor stream 902 comprising water vapor can be routed to heat exchanger zone 800 to provide at least part of the energy required for generating the required temperature for stream 801. The melted polymer stream 903 comprising water dispersible polymer comprising sulfopolyester in the melt phase can be cooled and chopped into pellets by any method known in the art.

Impurities can enter the process and concentrated in water recovered and recycled. One or more purge streams (603 and 701) can be utilized to control the concentration of impurities in the second mother liquor 601 and primary recovered water stream 701 to acceptable levels. In one embodiment, a portion of the second mother liquor stream 601 can be isolated and purged from the process. In one embodiment, a portion of the primary recovered water stream 701 can be isolated and purged from the process.

### Three Step Process to Produce Short Cut Microfibers

In another embodiment of the invention, as shown in FIG. 4, a process for producing a microfiber product stream is provided. The process comprises: (A) contacting short cut multicomponent fibers 101 having a length of less than 25 millimeters with a treated aqueous stream 103 in a fiber slurry zone 200 to produce a short cut multicomponent fiber slurry 201; wherein the short cut multicomponent fibers 101 comprise at least one water dispersible sulfopolyester and at least one water non-dispersible synthetic polymer immiscible with the water dispersible sulfopolyester ; and wherein the treated aqueous stream 103 is at a temperature of less than 40° C.; wherein the short cut multicomponent fiber comprises at least one water-dispersible sulfopolyester selected from the group consisting of: (i) a sulfopolyester comprising: (a) residues of one or more dicarboxylic acids, (b) at least 10 mole percent of residues of at least one sulfomonomer, (c) residues of two or more diols, wherein said diols comprise ethylene glycol and diethylene glycol, wherein said sulfopolyester exhibits a glass transition temperature of at least 58° C., wherein said sulfopolyester comprises a diethylene glycol to ethylene glycol molar ratio of less than 0.65, wherein said sulfopolyester contains substantially equimolar proportions of acid moiety repeating units (100 mole percent) to hydroxy moiety repeating units (100 mole percent), wherein all stated mole percentages are based on the total of all acid and hydroxy moiety repeating units being equal to 200 mole percent; and (ii) a sulfpolyester comprising: (a) residues of isophthalic acid, (b) residues of terephthalic acid, (c) residues of at least one sulfomonomer, (d) residues of ethylene glycol, (e) residues of diethylene glycol, wherein said amorphous sulfopolyester exhibits a glass transition temperature of at least 58° C., wherein said amorphous sulfopolyester contains substantially equimolar proportions of acid moiety repeating units (100 mole percent) to hydroxy moiety repeating units (100 mole percent), and wherein all stated mole percentages are based on the total of all acid and hydroxy moiety repeating units being equal to 200 mole percent; (B) contacting the short cut multicomponent fiber slurry 201 with a heated aqueous stream 801 in a mix zone 300 to produce a heated multicomponent fiber slurry 301; (C) routing the heated multicomponent fiber slurry 301 to a fiber opening zone 400 to remove a portion of the water dispersible sulfopolyester to produce an opened microfiber slurry 401; and (D) routing the opened microfiber slurry 401 to a primary solid liquid separation zone 500 to produce the microfiber product stream 503 and a first mother liquor stream 501 ; wherein the first mother liquor stream 501 comprises water and the water dispersible sulfopolyester.

In this embodiment of the invention as shown in FIG. 4, the opening process zone 1100 comprises a fiber slurry zone 200, mix zone 300 and a fiber opening zone 400.

A treated aqueous stream 103 for use in the process can be produced by routing an aqueous stream 102 to an aqueous treatment zone 1000 to produce a treated aqueous stream 103. The aqueous stream comprises water. In embodiments of the invention, the concentration of monovalent metal cations in the treated aqueous stream 103 can be less than about 1000 ppm by weight, less than about 500 ppm by weight, less than about 100 ppm by weight, or less than about 50 ppm by weight. Removal of divalent and multivalent metal cations from the aqueous stream 102 is one function of the aqueous treatment zone 1000. In other embodiments of the invention, the concentration of divalent and multivalent cations is less than about 50 ppm by weight, less than about 25 ppm by weight, less than about 10 ppm by weight, or less than about 5 ppm by weight. The temperature of stream 103 can range from ground water temperature to about 40° C.

The treatment of the aqueous stream 102 in the aqueous treatment zone 1000 can be accomplished in any way know in the art. In one embodiment, aqueous treatment zone 1000 comprises distillation equipment wherein water vapor is generated and condensed to produce the treated aqueous stream 103. In another embodiment, water is routed to a reverse osmosis membrane separation capable of separating monovalent and divalent metal cations from water to produce the treated aqueous stream 103. In another embodiment, water is routed to an ion exchange resin to generate the treated aqueous stream 103 with acceptably low concentration of metal cations. In yet another embodiment, water can be routed to a commercial water softening apparatus to generate the treated aqueous stream 103 with an acceptably low concentration of divalent and multivalent metal cations. It is understood that any combinations of these water treatment options may be employed to achieve the required treated water characteristics.

The treated aqueous stream 103 may be routed to any location in the process where it is needed. In one embodiment, a portion of stream 103 is routed to a primary solid liquid separation zone 500 to serve as a cloth wash and/or a wash for solids contained in the primary solid liquid separation zone 500.

In one embodiment, at least a portion of the treated aqueous stream 103 is routed to heat exchanger zone 800. In another embodiment, at least a portion of treated aqueous stream 103 is routed to a fiber slurry zone 200. In another embodiment, at least a portion of the treated aqueous stream 103 is routed to heat exchanger zone 800 and at least a portion of the treated aqueous stream 103 is routed to the fiber slurry zone 200. One function of heat exchanger zone 800 is to generate a heated aqueous stream 801 at a specific and controlled temperature.

In one embodiment, streams that can feed heat exchanger zone 800 are the treated aqueous stream 103 and the second mother liquor stream 601. In another embodiment, streams that can feed heat exchanger zone 800 comprise the treated aqueous stream 103, the primary recovered water stream 703, the first mother liquor stream 501, and the second mother liquor stream 601.

Any equipment know in the art for controlling the temperature of stream 801 may be used including, but not limited to, any heat exchanger with steam used to provide a portion of the required energy, any heat exchanger with a heat transfer fluid used to provide a portion of the required energy, any heat exchanger with electrical heating elements used to provide a portion of the required energy, and any vessel or tank with direct steam injection wherein the steam condenses and the condensate mixes with the water feeds to heat exchanger zone 800.

The multicomponent fiber stream 90 is routed to fiber cutting zone 100 to generate cut multicomponent fiber stream 101. The multicomponent fiber can be of any multicomponent structure known in the art. The multicomponent fiber comprises a water dispersible sulfopolyester and a water non-dispersible polymer as previously discussed in this disclosure.

Any equipment know in the art may be used to cut multicomponent fiber stream 90 to generate cut multicomponent fiber stream 101. In one embodiment, the length of the cut fibers in the cut multicomponent fiber stream 101 is less than about 50 mm. In other embodiments, the length of cut fibers in the cut multicomponent fiber stream 101 is less than about 25 mm, less than about 20 mm, less than about 15 mm, less than about 10 mm, less than about 5 mm, or less than 2.5 mm.

The cut multicomponent fiber stream 101 and a portion of the treated aqueous stream 103 are routed to a fiber slurry zone 200 to generate a cut multicomponent fiber slurry 201 comprising water and cut multicomponent fibers. In one embodiment, the weight % of cut multicomponent fibers in the cut multicomponent fiber slurry 201 can range from about 35 weight % to about 1% weight %, from about 25 weight % to about 1 weight %, from about 15 weight % to about 1 weight %, or from about 7 weight % to about 1 weight %.

The temperature of the cut multicomponent fiber slurry 201 can range from about 5 degrees centigrade to about 45 degrees centigrade, from about 10 degrees centigrade to about 35 degrees centigrade, or from about 10 degrees centigrade to about 25 degrees centigrade. In one embodiment, fiber slurry zone 200 comprises a tank with sufficient agitation to generate a suspension of cut multicomponent fiber in a continuous aqueous phase.

Any equipment known in the art suitable for mixing a solid with water and maintaining the resulting suspension of cut multicomponent fibers in the continuous phase may be used in the fiber slurry zone 200. The fiber slurry zone 200 can comprise batch or continuous mixing devices operated in continuous or batch mode. Suitable devices for use in the fiber slurry zone 200 include, but are not limited to, a hydro-pulper, a continuous stirred tank reactor, a tank with agitation operated in batch mode.

The cut multicomponent fiber slurry 201 and a heated aqueous stream 801 are routed to a mix zone 300 and combined to generate a heated multicomponent fiber slurry 301. The temperature of the heated multicomponent fiber slurry 301 influences the separation of the water dispersible sulfopolyester portion of the cut multicomponent fiber from the water non-dispersible polymer portion of the cut multicomponent fiber in fiber opening zone 400. In other embodiments of the invention, the temperature of the heated multicomponent fiber slurry 301 can range from about 55 degrees centigrade to about 100 degrees centigrade, from about 60 degrees centigrade to about 90 degrees centigrade, or from about 65 degrees centigrade to about 80 degrees centigrade.

The weight % of cut multicomponent fiber in the heated multicomponent fiber slurry 301 can be controlled. In other embodiments, the weight % of cut multicomponent fibers in the heated multicomponent fiber slurry 301 can range from about 10 weight % to about 0.1% weight %, from about 5 weight % to about 0.2 weight %, from about 3 weight % to about 0.3 weight %, or from about 2 weight % to about 0.4 weight %.

Any device known in the art capable of mixing the heated aqueous stream 801 with the cut multicomponent fiber slurry 201 may be used in mix zone 300. Suitable devices include both continuous and batch mixing devices. In one embodiment, a suitable mixing device for mix zone 300 comprises a tank and an agitator. In another embodiment, a suitable mixing device comprises a pipe or conduit.

In other embodiments, a suitable mixing device in mix zone 300 comprises a pipe or conduit with a diameter such that the speed in the conduit is sufficient to mix the cut multicomponent fiber slurry 201 and the heated aqueous stream 801 wherein less than about 2 weight %, less than about 1 weight %, or less than about 0.5 weight of cut multicomponent mass entering the conduit per minute settles out and accumulates in the conduit.

The heated multicomponent fiber slurry 301 can then be routed to a fiber opening zone 400. One function of fiber opening zone 400 is to separate the water dispersible polymer from the cut multicomponent fiber such that at least a portion of the water non-dispersible polymer microfibers separate from the cut multicomponent fiber and become suspended in the opened microfiber slurry 401. In another embodiment of the invention, from about 50 weight % to about 100 weight % of water non-dispersible polymer microfiber contained in the cut multicomponent fiber slurry 201 becomes suspended in the opened microfiber slurry 401 as water non-dispersible polymer microfibers and is no longer a part of the cut multicomponent fiber. In other embodiments, from about 75 weight % to about 100 weight %, from about 90 weight % to about 100 weight %, or from about 95 weight % to about 100 weight % of the water non-dispersible polymer microfiber contained in the cut multicomponent fiber stream 201 becomes suspended in the opened microfiber slurry 401 as water non-dispersible polymer microfibers and are no longer a part of a cut multicomponent fiber.

The diameter or denier of the starting cut multicomponent fiber in stream 201 impacts the extent of separation of the water dispersible sulfopolyester from the cut multicomponent fiber in the fiber opening zone 400. Typical multicomponent fiber types generally have a diameter in the range from about 12 microns to about 20 microns. Useful multicomponent fibers can have larger starting diameters to a size of about 40 microns diameter or more. The time required to separate a desired amount of water dispersible sulfopolyester from the cut multicomponent fiber increases as the diameter of the cut multicomponent fiber in stream 201 increases.

Residence time, temperature, and shear forces in the fiber opening zone 400 also influence the extent of separation of the water dispersible sulfopolyester from the cut multicomponent fiber. The conditions influencing the opening process in fiber opening zone 400 comprise residence time, slurry temperature, and shear forces where the ranges of water temperature, residence time in the fiber opening zone 400, and amount of applied shear are dictated by the need to separate the water dispersible sulfopolyester from the starting multicomponent fiber to a sufficient degree to result in water non-dispersible polymer microfibers becoming separated and suspended in the continuous aqueous phase of the opened microfiber slurry 401.

Residence time, temperature, and shear forces in fiber opening zone 400 influence the extent of separation of the water dispersible sulfopolyester from the cut multicomponent fiber. The temperature of the fiber opening zone 400 can range from about 55 degrees centigrade to about 100 degrees centigrade, from about 60 degrees centigrade to about 90 degrees centigrade, or from about 65 degrees centigrade to about 80 degrees centigrade. The residence time in the fiber opening zone 400 can range from about 5 minutes to about 10 seconds, from about 3 minutes to about 20 seconds, or from about 2 minutes to about 30 seconds. Sufficient mixing is maintained in fiber opening zone 400 to maintain a suspension of cut water non-dispersible polymer microfibers such that the settling of the cut microfibers is minimal. In other embodiments of the invention, the mass per unit time of cut water non-dispersible microfibers settling in the fiber opening zone 400 is less than about 5% of the mass per unit time of cut water non-dispersible polymer microfibers entering the zone 400, less than about 3% of the mass per unit time of cut water non-dispersible polymer microfibers entering zone 400, or less than about 1% of the mass per unit time of cut water non-dispersible polymer microfibers entering the fiber opening zone 400.

Fiber opening in fiber opening zone 400 may be accomplished in any equipment capable of allowing for acceptable ranges of residence time, temperature, and mixing. Examples of suitable equipment include, but are not limited to, an agitated batch tank, a continuous stirred tank reactor, as shown in FIGS. 6b and 6c, and a pipe with sufficient flow to minimize solids from settling out of the slurry as shown in FIG. 6a. One example of a unit operation to accomplish fiber opening in fiber opening zone 400 is a plug flow reactor where the heated multicomponent fiber slurry 301 is routed to zone 400 plug flow device, typically a circular pipe or conduit. The residence time of material in a plug flow device is calculated by dividing the filled volume within the device by the volumetric flow rate in the device. Velocity of the mass in the device is defined by the cross sectional area of the flow channel divided by the volumetric flow of the liquid through the device.

In other embodiments of the invention, the fiber opening zone 400 can comprise a pipe or conduit wherein the velocity of mass flowing in the pipe can range from 0.1 ft/second to about 20 feet/second, from 0.2 ft/sec to about 10 ft/sec, or from about 0.5 ft/sec to about 5 ft/sec. For flow of a fluid or slurry in a pipe or conduit, the Reynolds number Re is a dimensionless number useful for describing the turbulence or motion of fluid eddy currents that are irregular with respect both to direction and time. For flow in a pipe or tube, the Reynolds number is generally defined as:

$$\text{Re} \text{=} \frac{ρ \text{v} {D}_{H}}{μ} = \frac{\text{v} {D}_{H}}{v} = \frac{\text{Q} {D}_{H}}{v A}$$

Where:
D_{H} is the hydraulic diameter of the pipe; L, (m).
Q is the volumetric flow rate (m³/s).
A is the pipe cross-sectional area (m²).
v is the mean velocity of the object relative to the fluid (SI units: m/s).
µ is the dynamic viscosity of the fluid (Pa▪s or N▪s/m² or kg/(m▪s)).
v is the kinematic viscosity (v = µ / ρ) (m²/s).
ρ is the density of the fluid (kg/m³).

For flow in a pipe of diameter D, experimental observations show that for fully developed flow, laminar flow occurs when Re_{D} < 2000, and turbulent flow occurs when Re_{D} > 4000. In the interval between 2300 and 4000, laminar and turbulent flows are possible (‘transition’ flows), depending on other factors, such as, pipe roughness and flow uniformity.

Fiber opening zone 400 can comprise a pipe or conduit to facilitate the opening process, and the Reynolds number for flow through the pipe or conduit in fiber opening zone 400 can range from about 2,100 to about 6,000, from about 3,000 to about 6,000, or from about 3,500 to about 6,000. In other embodiments, the fiber opening zone 400 can comprise a pipe or conduit to facilitate the opening process, and the Reynolds number for flow through the pipe or conduit is at least 2,500, at least about 3,500, or at least about 4,000.

Fiber opening zone 400 can be achieved in a pipe or conduit containing a mixing device inserted within the pipe or conduit. The device can comprise an in-line mixing device. The in-line mixing device can be a static mixer with no moving parts. In another embodiment, the in-line mixing device comprises moving parts. Without being limiting, such an element is a mechanical device for the purpose of imparting more mixing energy to the heated multicomponent fiber slurry 301 than achieved by the flow through the pipe. The device can be inserted at the beginning of the pipe section used as the fiber opening zone, at the end of the pipe section, or at any location within the pipe flow path.

The opened fiber slurry stream 401 comprising water non-dispersible polymer microfiber, water, and water dispersible sulfopolyester can be routed to a primary solid liquid separation zone 500 to generate a microfiber product stream 503 comprising microfiber and a first mother liquor stream 501. In one embodiment, the first mother liquor stream 501 comprises water and water dispersible sulfopolyester.

The weight % of solids in the opened microfiber slurry 401 can range from about 0.1 weight % to about 20 weight %, from about 0.3 weight % to about about 10 weight %, from about 0.3 weight % to about 5 weight %, or from about 0.3 weight % to about 2.5 weight %.

The weight % of solids in the microfiber product stream 503 can range from about 10 weight % to about 65 weight %, from about 15 weight % to about 50 weight %, from about 25 weight % to about 45 weight %, or from about 30 weight % to about 40 weight %.

Separation of the microfiber product stream 503 from the opened microfiber slurry 401 can be accomplished by any method known in the art. In one embodiment, wash stream 103 comprising water is routed to the primary solid liquid separation zone 500. Wash stream 103 can be used to wash the microfiber product stream in the primary solid liquid separation zone 500 and/or the filter cloth media in the primary solid liquid separation zone 500 to generate wash liquor stream 502. A portion up to 100 weight % of wash liquor stream 502 can be combined with the opened microfiber slurry 401 prior to entering the primary solid liquid separation zone 500. Wash liquor stream 502 can contain microfiber. In one embodiment, the grams of microfiber mass breaking though the filter media with openings up to 2000 microns in the primary solid liquid separation zone 500 ranges from about 1 to 2 grams/cm² of filter area. In other embodiments of the invention, the filter openings in the filter media in the primary solid liquid separation zone 500 can range from about 43 microns to 3000 microns, from about 100 microns to 2000 microns, or from about 500 microns to about 2000 microns.

Separation of the microfiber product stream from the opened microfiber slurry in primary solid liquid separation zone 500 may be accomplished by a single or multiple solid liquid separation devices. Separation in the primary solid liquid separation zone 500 may be accomplished by a solid liquid separation device or devices operated in batch and or continuous fashion. Suitable solid liquid separation devices in the primary solid liquid separation zone 500 can include, but is not limited to, at least one of the following: perforated basket centrifuges, continuous vacuum belt filters, batch vacuum nutschfilters, batch perforated settling tanks, twin wire dewatering devices, continuous horizontal belt filters with a compressive zone, non vibrating inclined screen devices with wedge wire filter media, continuous vacuum drum filters, dewatering conveyor belts, and the like.

In one embodiment, the primary solid liquid separation zone 500 comprises a twin wire dewatering device wherein the opened microfiber sturry 401 is routed to a tapering gap between a pair of traveling filter cloths traveling in the same direction. In the first zone of the twin wire dewatering device, water drains from the opened microfiber slurry 401 due to gravity and the every narrowing gap between the two moving filter cloths. In a downstream zone of the twin wire dewatering device, the two filter cloths and the microfiber mass between the two filter cloths are compressed one or more times to mechanically reduce moisture in the microfiber mass. In one embodiment, mechanical dewatering is accomplished by passing the two filter cloths and contained microfiber mass through at least one set of rollers that exert a compressive force on the two filter cloths and microfiber mass between. In another embodiment, mechanical dewatering is accomplished by passing the two filter cloths and microfiber mass between at least one pressure roller and a fixed surface.

In other embodiments of the invention, the force exerted by mechanical dewatering can range from about 25 to about 300 lbs/linear inch of filter media width, from about 50 to about 200 lbs/linear inch of filter media width, or from about 70 to about 125 lbs/linear inch of filter media width. The microfiber product stream 503 is discharged from the twin wire water dewatering device as the two filter cloths separate and diverge at the solids discharge zone of the device. The thickness of the discharged microfiber mass can range from about 0.2 inches to about 1.5 inches, from about 0.3 inches to about 1.25 inches, or from about 0.4 inches to about 1 inch. In one embodiment, a wash stream comprising water is continuously applied to the filter media. In another embodiment, a wash stream comprising water is periodically applied to the filter media.

In another embodiment, the primary solid liquid separation zone 500 comprises a belt filter device comprising a gravity drainage zone and a pressure dewatering zone as illustrated in FIG. 7. Opened microfiber slurry 401 is routed to a tapering gap between a pair of moving filter cloths traveling in the same direction which first pass through a gravity drainage zone and then pass through a pressure dewatering zone or press zone comprising a convoluted arrangement of rollers as illustrated in FIG. 6b. As the belts are fed through the rollers, water is squeezed out of the solids. When the belts pass through the final pair of rollers in the process, the filter cloths are separated and the solids exit the belt filter device.

In another embodiment of the invention, at least a portion of the water contained in the first mother liquor stream 501 comprising water and water dispersible sulfopolyester polymer is recovered and recycled. The first mother liquor stream 501 can be recycled to the primary solid liquid separation zone 500. Depending on the efficiency of the primary liquid separation zone in the removal of the water non-dispersible microfiber, the first mother liquid stream 501 can be recycled to the fiber slurry zone 200, the mix zone 300, the fiber opening zone 400, or the heat exchanger zone 800 prior to being routed to Zones 200, 300 and/or 400. The first mother liquor stream 501 can contain a small amount of solids comprising water non-dispersible polymer microfiber due to breakthrough and cloth wash. In one embodiment, the grams of water non-dispersible polymer microfiber mass breaking though filter media in the primary solid liquid separation zone with openings up to 2000 microns ranges from about 1 to about 2 grams/cm² of filter area. It is desirable to minimize the water non-dispersible polymer microfiber solids in the first mother liquor stream 501 prior to routing stream 501 to the primary concentration zone 700 and heat exchange zone 800 where water non-dispersible polymer microfiber solids can collect and accumulate in the zones having a negative impact on their function.

A secondary solid liquid separation zone 600 can serve to remove at least a portion of water non-dispersible polymer microfiber solids present in the first mother liquor stream 501 to generate a secondary wet cake stream 602 comprising water non-dispersible microfiber and a second mother liquor stream 601 comprising water and water dispersible sulfopolyester.

In one embodiment, the second mother liquor stream 601 can be routed to a primary concentration zone 700 and or heat exchanger zone 800 wherein the weight % of the second mother liquor stream 601 routed to the primary concentration zone 700 can range from 0% to 100% with the balance of the stream being routed to heat exchanger zone 800. The second mother liquor stream 601 can be recycled to the fiber slurry zone 200, the mix zone 300, the fiber opening zone 400, or the heat exchanger zone 800 prior to being routed to Zones 200, 300 and/or 400. The amount of the water dispersible sulfopolyester in the second mother liquor stream routed to the fiber opening zone 400 can range from about 0.01 weight % to about 7 weight %, based on the weight % of the second mother liquor stream, or from about 0.1 weight % to about 7 weight %, from about 0.2 weight % to about 5 weight %, or from about 0.3 weight % to about 3 weight %.

Any portion of the second mother liquor 601 routed to primary concentration zone is subjected to a separation process to generate a primary recovered water stream 703 and a primary polymer concentrate stream 702 enriched in water dispersible sulfopolyester wherein the weight % of water dispersible sulfopolyester in the primary polymer concentrate stream 702 can range from about 5 weight % to about 85%, from about 10 weight % to about 65 weight %, or from about 15 weight % to about 45 weight %. The primary recovered water stream 703 can be recycled to the fiber slurry zone 200, the mix zone 300, the fiber opening zone 400, or the heat exchanger zone 800 prior to being routed to Zones 200, 300 and/or 400. The amount of the water dispersible sulfopolyester in the second mother liquor stream routed to the fiber opening zone 400 can range from about 0.01 weight % to about 7 weight %, based on the weight % of the second mother liquor stream, or from about 0.1 weight % to about 7 weight %, from about 0.2 weight % to about 5 weight %, or from about 0.3 weight % to about 3 weight %.

Water can be removed from the second mother liquor stream 601 by any method know in the art in the primary concentration zone 700 to produce the primary polymer concentrate stream 702. In one embodiment, removal of water involves an evaporative process by boiling water away in batch or continuous evaporative equipment. For example, at least one thin film evaporator can be used for this application. In another embodiment, membrane technology comprising nanofiltration media can be used to generate the primary polymer concentrate stream 702. In another embodiment, a process comprising extraction equipment may be used to extract water dispersible polymer from the second mother liquor stream 601 and generate the primary polymer concentrate stream 702. It is understood than any combination of evaporation, membrane, and extraction steps may be used to separate the water dispersible sulfopolyester from the second mother liquor stream 601 and generate the primary polymer concentrate stream 702. The primary polymer concentration stream 702 may then exit the process.

In one embodiment, the primary polymer concentrate stream 702 can be routed to a secondary concentration zone 900 to generate a melted polymer stream 903 comprising water dispersible sulfopolyester wherein the weight % of polymer ranges from about 95% to about 100% and a vapor stream 902 comprising water. In one embodiment, the 903 comprises water dispersible sulfopolyester. Equipment suitable for the secondary concentration zone 900 includes any equipment known in the art capable of being fed an aqueous dispersion of water dispersible polymer and generating a 95% to 100% water dispersible polymer stream 903. This embodiment comprises feeding an aqueous dispersion of water dispersible sulfopolyester polymer to a secondary concentration zone 902. The temperature of feed stream is typically below 100° C.

In one embodiment, the secondary concentration zone 900 comprises at least one device characterized by a jacketed tubular shell containing a rotating convey screw wherein the convey screw is heated with a heat transfer fluid or steam and comprises both convey and high shear mixing elements. The jacket or shell is vented to allow for vapor to escape. The shell jacket may be zoned to allow for different temperature set points along the length of the device. During continuous operation, the primary polymer concentrate stream 702 comprises water and water dispersible sulfopolyester and is continuously fed to the secondary concentration zone 900. Within the device, during steady state, mass exists in at least three distinct and different forms. Mass first exists in the device as an aqueous dispersion of water dispersible sulfopolyester polymer. As the aqueous dispersion of sulfopolyester polymer moves through the device, water is evaporated due to the heat of the jacket and internal screw. When sufficient water is evaporated, the mass becomes a second form comprising a viscous plug at a temperature less than the melt temperature of the sulfopolyester polymer. The aqueous dispersion cannot flow past this viscous plug and is confined to the first aqueous dispersion zone of the device. Due to the heat of the jacket, heat of the internally heated screw, and the heat due to mixing shear forces of this high viscosity plug mass, substantially all the water present at this location evaporates, and the temperature rises until the melt temperature of the sulfopolyester is reached resulting in the third and final physical form of mass in the device comprising melted sulfopolyester polymer. The melted sulfopolyester polymer then exits the device through an extrusion dye and is typically cooled and cut into pellets by any fashion know in the art. It is understood that the device for secondary concentration zone 900 described above may also be operated in batch fashion wherein the three physical forms of mass described above occur throughout the length of the device but at different times in sequential order beginning with the aqueous dispersion, the viscous plug mass, and finally the sulfopolyester melt.

In one embodiment, vapor generated in the secondary concentration zone 900 may be condensed and routed to heat exchanger zone 800, discarded, and/or routed to wash stream 103. In another embodiment, condensed vapor stream 902 comprising water vapor can be routed to heat exchanger zone 800 to provide at least part of the energy required for generating the required temperature for stream 801. The melted polymer stream 903 comprising water dispersible polymer comprising sulfopolyester in the melt phase can be cooled and chopped into pellets by any method known in the art.

Impurities can enter the process and concentrated in water recovered and recycled. One or more purge streams (603 and 701) can be utilized to control the concentration of impurities in the second mother liquor 601 and primary recovered water stream 701 to acceptable levels. In one embodiment, a portion of the second mother liquor stream 601 can be isolated and purged from the process. In one embodiment, a portion of the primary recovered water stream 701 can be isolated and purged from the process.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 hydrocarbons”, is intended to specifically include and disclose C1 and C5 hydrocarbons as well as C2, C3, and C4 hydrocarbons.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The invention is further illustrated by the following examples.

### EXAMPLES

### Method for Determining Sulfopolyester Carboxylate and Acid Ends Content

The titration was conducted on a titrator (904 Titrando, Metrohm AG, US) equipped with Tiamo software and a pH electrode (DG116-solvent, Mettler Toledo, US) as sensing probe. The acid of the sample was titrated with tetrabutylammonium hydroxide solution (TBAOH, 0.1N) in methanol. The base of the sample was titration with hydrochloric acid (HCI, 0.1N) in IPA. The total acid was titrated by TBAOH from the sample that has been protonated (titrated) by excess of HCI.

About 2.0 grams sample was weighted to a titration cell and stirred to dissolve in 30 ml N-Methyl-2-Pyrrolidone (NMP) at room temperature. 15 ml of dichloroethane (DCE) was added prior to titration. The sample solution was then titrated by TBAOH or HCI to the endpoint, which was determined by Tiamo software or manually. A blank of solvent was also titrated for both analyses.

The acid result was reported as mmol acid/g sample, which was calculated from the volume of TBAOH used at the titration endpoint, its normality, and weight of sample. The base result was reported as mmol base/g sample, which was calculated from the volume of HCI used at the titration endpoint, its normality, and weight of sample. The total acid was reported as mmol acid/g sample, which was calculated from the volume of TBAOH at the endpoint and volume of HCI added to the sample, their normality, and weight of sample.

### Method for Determining Dispersion Viscosity

Dispersion viscosity was measured at 400 rpm on a cone and plate rheometer using a #1 spindle at 30° C.

### Example 1: Preparation of Sulfopolyester With a Carboxylate/Acid Number > 0.6

A 500-ml round bottom flask fitted with a SS stirrer, glass polymer head to allow with a nitrogen/vacuum inlet, glass sidearm to allow removal of volatile by-products, and a receiver flask was charged with terephthalic acid (57.2 g, 0.35 moles), isophthalic acid (16.6 g, 0.10 moles), 5-sodiosulfoisophthalic acid (12.5 g, 0.05 moles), ethylene glycol (53.7 grams, 0.87 moles), diethylene glycol (22.3 g, 0.21 moles), and sodium acetate (0.17 g, 0.002 moles). Titanium tetraisopropoxide solution (1.7% in butanol, 64 µL) was added to provide a catalytic level of 50 ppm elemental titanium based on theoretical polymer yield. The flask was purged 2X with nitrogen before immersion in a metal bath that was pre-heated to 170° C. After the contents were at temperature, the agitator was started and maintained at 200 rpm under a gentle nitrogen sweep. Esterification was allowed to proceed with the collection of water condensate for 1 hour at 170° C., 90 minutes at 180° C., 90 minutes at 200° C., 1 hour at 215° C., and 3.5 hours at 240° C. At the end of the esterification a hazy, colorless, translucent melt was obtained. The temperature was increased to 270° C. and held for 30 minutes before the nitrogen flow was terminated and replaced with a vacuum that was gradually ramped down to 0.5 torr over the course of 48 minutes. After 45 minutes a clear, light amber melt of high viscosity was obtained and the reaction was terminated. After cooling to room temperature, analysis of the polymer yielded an IhV of 0.48 and a composition containing 71.5 mole% terephthalate, 20 mole% isophthalate, 8.5 mole% 5-sodiosulfoisophthalate, 62 mole% EG, 35 mole% DEG, and 3 mole% TEG. The polyester was determined by titration to have an carboxylate/acid of 0.9.

### Comparative Example 2: Preparation of Sulfopolyester With Carboxylate/Acid < 0.6

Example shows that both low acid number and low carboxylate/acid may be obtained. The same apparatus as used in Example 1 was charged with dimethyl terephthalate (70.4 g, 0.36 moles), dimethyl isophthalate (19.3 g, 0.10 moles), dimethyl-5-sodiosulfoisophthalate (14.5 g, 0.05 moles), ethylene glycol (54.7 grams, 0.88 moles), diethylene glycol (22.4 grams, 0.21 moles) and sodium acetate (0.4 g, 0.005 moles). Titanium tetraisopropoxide solution (1.7% in butanol, 318 µL) was added to provide a catalytic level of 50 ppm elemental titanium based on theoretical polymer yield. The flask was purged 2X with nitrogen before immersion in a metal bath that was pre-heated to 200° C. After the contents were at temperature, the agitator was started and maintained at 200 rpm under a gentle nitrogen sweep. Transesterification was allowed to proceed with the collection of methanol condensate for 1 hour at 200° C. and 90 minutes at 220° C. At the end of the transesterification a colorless, low viscosity melt was obtained. The temperature was increased to 275° C. and the nitrogen flow terminated and replaced with a vacuum that was gradually ramped down to 0.5 torr over the course of 48 minutes in stages. After 60 minutes a clear, amber melt of high viscosity was obtained and the reaction was terminated. After cooling to room temperature, analysis of the polymer yielded an IhV of 0.52 and a composition containing 71.5 mole% terephthalate, 20 mole% isophthalate, 8.5 mole% 5-sodiosulfoisophthalate, 67 mole% EG, 32 mole% DEG, and 1 mole% TEG. The polyester was determined to have an acid number of 0.8 and a carboxylate/acid number of < 0.5

### Example 3: Preparation of Sulfopolyester With Carboxylate/Acid < 0.6 (Comparative)

Example shows that higher acid number and low carboxylate/acid may be obtained. The same apparatus as used in Example 1 was charged with terephthalic acid (57.2 g, 0.35 moles), isophthalic acid (16.6 g, 0.10 moles), 5-sodiosulfoisophthalic acid (12.5 g, 0.05 moles), ethylene glycol (53.7 grams, 0.87 moles), diethylene glycol (22.3 g, 0.21 moles), and sodium sulfate (0.31 g, 0.002 moles). Titanium tetraisopropoxide solution (1.7% in butanol, 64 µL) was added to provide a catalytic level of 50 ppm elemental titanium based on theoretical polymer yield. The flask was purged 2X with nitrogen before immersion in a metal bath that was pre-heated to 170° C. After the contents were at temperature, the agitator was started and maintained at 200 rpm under a gentle nitrogen sweep. Esterification was allowed to proceed with the collection of water condensate for 1 hour at 170° C., 90 minutes at 180° C., 90 minutes at 200° C., 1 hour at 215° C., and 3.5 hours at 240° C. At the end of the esterification a hazy, colorless, translucent melt was obtained. The temperature was increased to 270° C. and held for 30 minutes before the nitrogen flow was terminated and replaced with a vacuum that was gradually ramped down to 0.5 torr over the course of 48 minutes. After 45 minutes a clear, light amber melt of high viscosity was obtained and the reaction was terminated. After cooling to room temperature, analysis of the polymer yielded an IhV of 0.76 and a composition containing 71.5 mole% terephthalate, 20 mole% isophthalate, 8.5 mole% 5-sodiosulfoisophthalate, 62 mole% EG, 35 mole% DEG, and 3 mole% TEG. The polyester was determined by titration to have an carboxylate/acid of 0.01.

### Example 4 - Neutralization of Acid Ends

A 500-ml round bottom flask fitted with a stainless steel stirrer, glass polymer head to allow a nitrogen/vacuum inlet, glass sidearm to allow removal of volatile by-products, and a receiver flask was charged with terephthalic acid (57.2 g, 0.35 moles), isophthalic acid (16.6 g, 0.10 moles), 5-sodiosulfoisophthalic acid (12.5 g, 0.05 moles), ethylene glycol (53.7 grams, 0.87 moles), diethylene glycol (22.3 g, 0.21 moles), and sodium acetate (0.17 g, 0.002 moles). Titanium tetraisopropoxide solution (1.7% in butanol, 64 µL) was added to provide a catalytic level of 50 ppm elemental titanium based on theoretical polymer yield. The flask was purged two times with nitrogen before immersion in a metal bath that was pre-heated to 170° C. After the contents were at temperature, the agitator was started and maintained at 200 rpm under a gentle nitrogen sweep. Esterification was allowed to proceed with the collection of water condensate for 1 hour at 170° C., 90 minutes at 180° C., 90 minutes at 200° C., 1 hour at 215° C., and 3.5 hours at 240° C. At the end of the esterification, a hazy, colorless, translucent melt was obtained. The temperature was increased to 270° C. and held for 30 minutes before the nitrogen flow was terminated and replaced with a vacuum that was gradually ramped down to 0.5 torr over the course of 48 minutes. After 45 minutes a clear, light amber melt of high viscosity was obtained, and the reaction was terminated. Based on 100 mole% of total diacid and 100 mole% of total glycol, the sulfopolyester had residues of 71.5 mol % of terephthalic acid, 20 mol% of isophthalic acid, 8.5 mol% of 5-sodiosulfoisophthalic acid, 65 mol% of ethylene glycol, and 35 mol% of diethylene glycol.

TABLE 1

Acid/Base Ratio Chart

| Example | Base | Amount of Base added | Acid Ends | Base (Carboxylate) Ends | Base/ ends acid ends |
|---|---|---|---|---|---|
| | | (moles Base /mole SIP) | (µeq/g) | (µeq/g) | |
| Inventive 4A | NaOAc | 0.05 | 17.2 | 15.9 | 0.92 |
| Inventive 4B | NaOAc | 0.16 | 15.4 | 59.9 | 3.89 |
| Inventive 4C | KOAc | 0.05 | 17.9 | 15 | 0.84 |
| Inventive 4D | KOAc | 0.16 | 15 | 52.6 | 3.51 |
| Comparative 4E | Na2SO4 | 0.05 | 30.1 | 0.4 | 0.01 |
| Comparative 4F | Na2SO4 | 0.16 | 28.7 | 0.8 | 0.03 |
| Inventive 4G | NaHCO3 | 0.05 | 19.9 | 16.8 | 0.84 |
| Inventive 4H | NaHCO3 | 0.16 | 20.3 | 57.1 | 2.81 |
| Inventive 4I | NaOH | 0.05 | 19 | 20.4 | 1.07 |
| Inventive 4J | NaOH | 0.16 | 18.8 | 63.7 | 3.39 |
| Inventive 4 K | Na3PO4 | 0.05 | 25.3 | 48 | 1.90 |
| Inventive 4L | Na3PO4 | 0.16 | 18 | 101.5 | 5.64 |
| Comparative 4 M | KOH | 0.05 | 19.8 | 11.3 | 0.57 |
| Inventive 4N | KOH | 0.16 | 16.7 | 48.3 | 2.89 |
| Inventive 4O | KOH | 0.2 | 16.1 | 75.2 | 4.67 |

### EXAMPLES OF DISPERSIONS

### Example 5: Lower SIP, Carboxylate/acid > 0.6 Sulfopolyester at High Solids and Low Viscosity

The sulfopolyester from Example 1 was dispersed into water. A 500 ml, 2-neck round bottom flask equipped a magnetic stir-bar and water-cooled condenser was charged with 70.1 grams of DI water and heated to 90° C. Twenty-seven (27) grams of the polymer in a coarse granular form were charged in 5 approximately equal additions over the course of 95 minutes to allow for dispersion to be made without clumping. After the last addition, the dispersion was held at 90° C. for an additional 40 minutes to yield slightly hazy, low viscosity dispersion of 27 wt% sulfopolyester in water. After cooling to room temperature, a dispersion viscosity of 64 cp was measured at 400 rpm on a cone and plate rheometer using a #1 spindle at 30° C.

### Comparative Example 6: Lower SIP, Carboxylate/acid < 0.6 Sulfopolyester at Lower Solids and Higher Viscosity

The same apparatus as described in Example 3 was used to disperse the sulfopolyester from Example 2 into water. 69 grams of DI water and heated to 90° C. Twenty-four (24) grams of the polymer in a coarse granular form were charged in 4 approximately equal additions and held for a total dispersion time of 180 minutes to allow for dispersion to be made without clumping. An opaque white, viscous dispersion of 24 wt% sulfopolyester in water was obtained. After cooling to room temperature, a dispersion viscosity of 187 cp was measured at 400 rpm on a cone and plate rheometer at 30° C.

That which is claimed is:

1. A water dispersible sulfopolyester, said sulfopolyester comprising:
(a) residues of one or more dicarboxylic acids;
(b) at least 4 mole percent and less than 8.5 mole percent of residues of at least one sulfomonomer; and
(c) residues of one or more diols,
wherein said sulfopolyester comprises a carboxylate ends to acid ends ratio of at least 0.6,
wherein said sulfopolyester contains substantially equimolar proportions of acid moiety repeating units (100 mole percent) to hydroxy moiety repeating units (100 mole percent), and
wherein all stated mole percentages are based on the total of all acid and hydroxy moiety repeating units being equal to 200 mole percent.

2. A water dispersible sulfopolyester, said sulfopolyester comprising:
(a) residues of one or more dicarboxylic acids;
(b) greater than 8.5 mole percent of residues of at least one sulfomonomer; and
(c) residues of one or more diols,
wherein said sulfopolyester comprises a carboxylate ends to acid ends ratio of at least 0.35,
wherein said sulfopolyester contains substantially equimolar proportions of acid moiety repeating units (100 mole percent) to hydroxy moiety repeating units (100 mole percent), and
wherein all stated mole percentages are based on the total of all acid and hydroxy moiety repeating units being equal to 200 mole percent.

3. A water dispersible sulfopolyester, said sulfopolyester comprising:
(a) residues of one or more dicarboxylic acids;
(b) greater than 8.5 mole percent of residues of at least one sulfomonomer; and
(c) residues of one or more diols,
wherein said sulfopolyester comprises a carboxylate ends content of at least 12 µeq/g,
wherein an aqueous dispersion comprising 25 weight percent of said sulfopolyester exhibits a dispersion viscosity of at least 30 cP and less than 100 cP at 22° C.,
wherein said sulfopolyester contains substantially equimolar proportions of acid moiety repeating units (100 mole percent) to hydroxy moiety repeating units (100 mole percent), and
wherein all stated mole percentages are based on the total of all acid and hydroxy moiety repeating units being equal to 200 mole percent.

4. The water dispersible sulfopolyester of claim 1 wherein said sulfopolyester comprises a carboxylate ends to acid ends ratio of at least 0.7 and/or less than 10.

5. The water dispersible sulfopolyester of claim 2 wherein said sulfopolyester comprises a carboxylate ends to acid ends ratio of at least 0.4 and/or less than 10.

6. The water dispersible sulfopolyester of claims 1 wherein said sulfopolyester comprises a carboxylate ends content of at least 12 and/or less than 200 µeq/g.

7. The water dispersible sulfopolyester of claims 1 wherein said sulfopolyester comprises an acid ends content of at least 1 and/or less than 50 µeq/g.

8. The water dispersible sulfopolyester of claims 1 wherein an aqueous dispersion comprising 20 weight percent of said sulfopolyester exhibits a dispersion viscosity of at least 10 cP and less than 1,000 cP at 22° C.

9. The water dispersible sulfopolyester of claims 1 wherein said sulfopolyester comprises an inherent viscosity of at least 0.1 and/or less than 0.8 dL/g.

10. The water dispersible sulfopolyester of claims 1 wherein said sulfomonomer comprises a sulfoisophthalic acid.

11. The water dispersible sulfopolyester of claim 1 wherein sulfopolyester comprises at least 5 mole percent of said sulfomonomer.

12. The water dispersible sulfopolyester of claim 2 wherein sulfopolyester comprises at least 9 mole percent and/or less than 25 mole percent of said sulfomonomer.

13. The water dispersible sulfopolyester of claims 1 wherein said residues of one or more dicarboxylic acids are derived from terephthalic acid, isophthalic acid, or combinations thereof.

14. The water dispersible sulfopolyester of claims 1 wherein said residues of one or more diols are derived from ethylene glycol, 1,4-cyclohexanedimethanol, diethylene glycol, or combinations thereof.

15. A woven article comprising said sulfopolyester of claims 1.

16. A nonwoven article comprising said sulfopolyester of claims 1.

17. An article comprising said sulfopolyester of claims 1.

18. A process for producing a water dispersible sulfopolyester, said process comprising:
(a) providing one or more dicarboxylic acids, one or more diols, at least one sulfomonomer, and at least one base to thereby form an esterification mixture; and
(b) esterifying said esterification mixture to thereby form said sulfopolyester, wherein said sulfopolyester comprises -
(i) residues of said dicarboxylic acids,
(ii) at least 4 mole percent and less than 8.5 mole percent of residues of said sulfomonomer, and
(iii) residues of said diols,
wherein said sulfopolyester comprises a carboxylate ends to acid ends ratio of at least 0.6,
wherein said sulfopolyester contains substantially equimolar proportions of acid moiety repeating units (100 mole percent) to hydroxy moiety repeating units (100 mole percent), and
wherein all stated mole percentages are based on the total of all acid and hydroxy moiety repeating units being equal to 200 mole percent.

19. A process for producing a water dispersible sulfopolyester, said process comprising:
(a) providing one or more dicarboxylic acids, one or more diols, at least one sulfomonomer, and at least one base to thereby form an esterification mixture; and
(b) esterifying said esterification mixture to thereby form said sulfopolyester, wherein said sulfopolyester comprises -
(i) residues of said dicarboxylic acids,
(ii) greater than 8.5 mole percent of residues of said sulfomonomer, and
(iii) residues of said diols,
wherein said sulfopolyester comprises a carboxylate ends to acid ends ratio of at least 0.35,
wherein said sulfopolyester contains substantially equimolar proportions of acid moiety repeating units (100 mole percent) to hydroxy moiety repeating units (100 mole percent), and
wherein all stated mole percentages are based on the total of all acid and hydroxy moiety repeating units being equal to 200 mole percent.

20. A process for producing a water dispersible sulfopolyester, said process comprising:
(a) providing one or more dicarboxylic acids, one or more diols, at least one sulfomonomer, and at least one base to thereby form an esterification mixture; and
(b) esterifying said esterification mixture to thereby form said sulfopolyester, wherein said sulfopolyester comprises -
(i) residues of said dicarboxylic acids,
(ii) greater than 8.5 mole percent of residues of said sulfomonomer, and
(iii) residues of said diols,
wherein said sulfopolyester comprises a carboxylate ends content of at least 12 µeq/g,
wherein an aqueous dispersion comprising 25 weight percent of said sulfopolyester exhibits a dispersion viscosity of at least 30 cP and less than 100 cP at 22° C.,
wherein said sulfopolyester contains substantially equimolar proportions of acid moiety repeating units (100 mole percent) to hydroxy moiety
repeating units (100 mole percent), and
wherein all stated mole percentages are based on the total of all acid and hydroxy moiety repeating units being equal to 200 mole percent.
